(19) United States
(12) Patent Application Publication
(10) Pub. No.: US 2004/0143403 A1
(43) Pub. Date: Jul. 22, 2004

(54) Status determination

(76) Inventors: Richard Bruce Brandon, Queensland (AU); Mervyn Rees Thomas, Queensland (AU)

Correspondence Address: HELLER EHRMAN WHITE & MCAULIFFE LLP, 1666 K STREET,NW, SUITE 300, WASHINGTON, DC, 20006, US

(21) Appl. No.: 10/712,266

(22) Filed: Nov. 14, 2003

Related U.S. Application Data
(60) Provisional application No. 60/485,448, filed on Jul. 9, 2003.

(30) Foreign Application Priority Data
Nov. 14, 2002 (AU) 2002952696

(51) Int. Cl. G06F 19/00

(52) U.S. Cl. 702/19

(57) ABSTRACT

The present invention provides a method of determining the status of a subject. In particular, this is achieved by obtaining subject data including respective values for each of a number of parameters, the parameter values being indicative of the current biological status of the subject. The subject data is compared to predetermined data which includes values for at least some of the parameters and an indication of the condition. The status of the subject, and in particular, the presence and/or absence of the one or more conditions, can then be determined in accordance with the results of the comparison.

### BACKGROUND OF THE INVENTION

The present invention relates to determining the status of a subject, and in particular for determining the ability or eligibility of a subject such as a human, horse or camel to compete in a sporting and/or racing event by evaluating, for example, molecules obtained from blood of the subject.

### BACKGROUND

A condition of a performance animal, for example, a racehorse, may typically be determined by conventional means such as a blood profile test (determining conventional haematological and serum biochemical parameters) and clinical appraisal. Such tests, however, may be of limited value because a correlation between results of a blood profile test or clinical appraisal and a condition or state of a performance animal is minimal.

Note, as used herein, the term “animal” and “subject” are intended to cover both humans and non-humans.

A blood profile test may be suitable for providing some information in relation to an animal that is clinically diseased or ill, but is rarely suitable for determining fitness of an animal to perform, particularly if the animal is healthy according to use of current clinical appraisal methods, and particularly if the animal cannot communicate information about its condition. Although blood profile tests are relatively inexpensive and easy to perform, they do not provide assessment of a wide range of conditions, correlations between test results and conditions of performance animals are poor, are limited to assessment of a few diseases, and are sometimes only useful in assessment of advanced stages of disease where clinical intervention is too late to prevent significant loss of performance.

In addition, previously it has been difficult to generate secure data bases of clinical and pathology information, tools to meaningly mine these data have not been available, and the means to communicate meaningful information have been cumbersome. Furthermore, the information content of these parameters is too meagre to allow clear and meaningful status determination for management of the performance animal.

Alternative diagnosis or assessment procedures are often complex, invasive, inconvenient, expensive, time consuming, may expose an animal to risk of injury from the procedure, and often require transport of the animal to a diagnostic centre.

A final report of the results of a blood test to an end user, for example, a trainer, often requires involvement of multiple parties each providing separate input to the report. For example, a veterinarian may collect a blood sample, the sample is transported or sent to a laboratory for analysis, personnel in the laboratory perform an analysis using machinery on the blood sample, automated results from the analysis, with or without a veterinary pathologist interpretation, are returned to the veterinarian who then interprets the results and provides a separate report to the trainer. The process is laborious, time consuming, subject to error and interpretation bias and may or may not contain information relevant to the end user.

Bioinformatics may be used with genetic based diagnosis of an animal's health.

Currently, it is known to use genetic information in determining information regarding an individual. This can be achieved in a number of ways depending on the information that is desired.

Thus, for example, WO 01/25473 describes a method of characterising a biological condition or agent using calibrated gene expression profiles. In this case, when a subject is suspected of having a condition, a test is performed to obtain a specific profile, which is then analysed. In particular, the collected profile is compared to a predetermined profile to determine if the condition has been correctly identified. However, this suffers from drawbacks in that a preliminary diagnosis is required to allow the correct test to be performed.

U.S. Pat. No. 6,287,254 describes a system that allows users to perform DNA genetic profiling to determine the susceptibility of a subject to a condition. In particular, in this example, the subject is profiled to determine the presence of predetermined genes, which in turn indicate the susceptibility of a subject to a respective condition. Again, this requires specific tests for specific conditions, and only allows the susceptibility of a subject to be determined.

Moreover, the convention in the art is to assay the molecules present in a particular tissue of a subject to evaluate conditions that are specific to that tissue. This convention in the art fails to contemplate the advantage of using blood to evaluate profiles, such as biological markers, for conditions that exist in all the tissues of the body, such that blood molecules act as surrogate reporters for conditions affecting any part of the body.

### SUMMARY OF THE PRESENT INVENTION

In a first broad form the present invention provides a method comprising:

for each of a plurality of animals having a known status, measuring a number of biological factors potentially indicative of said status;

analysing said biological factors to obtain at least one model providing a statistical correlation between said biological factors and said status;

storing at least one said model; and

responsive to a request for status determination of a particular animal, the request including, for the particular animal, measures of at least some of the number of biological factors potentially indicative of said status, applying at least one stored model to the information in the request in order to attempt to determine the status of the particular animal

In a second broad form the invention provides a method comprises:

for each of a plurality of animals having a known condition, measuring a number of biological factors potentially indicative of said condition;

determining at least one model that provides a statistical correlation between said biological factors and said condition;

storing said at least one model; and

responsive to a request for status determination of a particular animal, the request including, for the particular animal, measures of at least some of the number of biological factors potentially indicative of said status, applying at least one stored model to the information in the request in order to attempt to determine the status of the particular animal.

In a third broad form the present invention provides a method comprising:

providing a system including a database of (a) statistical models that correlate biological factors to known conditions, and (b) statistical models that correlate known conditions or biological factors to known statuses;

responsive to a user request for a status determination for a particular animal, said request including measures of at least some biological factors, applying at least one statistical model from the database to at least some of the biological factors in the request in order to determine whether the animal has a known condition or a known status; and

providing the user with the status determination.

The user is preferably at a remote location from the database and is only provided with the status determination if the user is authorised to access the system.

Typically a request includes a unique identity for the animal and the system stores information relating to the animal based on its identity.

The method preferably further comprises determining the status of the animal based at least in part on previously stored information about the animal.

The method can further comprise providing the user with a list of additional information that might be useful in making a status determination.

In a fourth broad form the present invention provides a method comprising:

providing a system including a database of (a) statistical models that correlate biological factors of horses to known conditions in horses, and (b) statistical models that correlate known conditions in horses or biological factors of horses to known statuses of horses;

responsive to a user request for a status determination for a particular horse, said request including measures of at least some biological factors of the particular horse, applying at least one statistical model from the database to at least some of the biological factors in the request in order to determine whether the horse has a known condition or a known status; and

providing the user with the status determination of the horse.

When the user is at a remote location from the database the user is typically only provided with the status determination if the user is authorised to access the system.

Suitably the request includes a unique identity for the horse and the system stores information relating to the horse based on its identity.

The method can further comprise determining the status of the horse based at least in part on previously stored information about the horse.

The method may further comprise providing the user with a list of additional information about the horse that was not provided with the request and that might be useful in making a status determination about the horse.

In a fifth broad form the present invention provides a method of determining the status of a subject, the method including:

Obtaining subject data, the subject data including respective values for each of a number of parameters, the parameter values being indicative of the current biological status of the subject;

Comparing the subject data to predetermined data, the predetermined data including for each of a number of conditions:

A range of values for at least some of the parameters; and,

An indication of the condition; and,

Determining the status of the subject in accordance with the results of the comparison, the status indicating at least one of the presence, absence and degree of at least one of the conditions.

It will be appreciated that in this regard the parameter values may include complex relevant summaries of the parameters (for example regularised linear discriminant function coefficients or support vectors from a support vector machine model).

Thus, the indication of the condition can include at least one of:

An indication of the stage of a condition;

An indication of the degree of a condition; and

An indication of the degree of health of a subject.

The number of parameters is typically greater than about 100, 200, 300, 400, 500 and preferably between about 1000 and about 6000. As used herein, the term “about” refers to values (e.g., amounts, concentrations, time etc) that vary by as much as 30%, 20%, 10%, 5%, or even by as much as 4%, 3%, 2%, 1% to a specified or reference value.

The method typically includes generating a report representing the status of the subject.

The method can also include determining the ability of the subject to perform in a sporting and/or racing event in accordance with at least one of the presence, absence and degree of any conditions.

Suitably, individual parameters are representative of the level, abundance or functional activity of an agent in the subject or in a biological sample obtained from the subject. Typically, the agent is a biological molecule, which includes any compound that is found intracellularly or extracellularly in an organism, including biological fluids, or in cells as a result of anabolic or catabolic processes within a cell, or as a result of cell uptake from the extracellular environment, by whatever means. The term “biological molecule” is used herein in its broadest sense and includes a molecule having activity in a biological sense. For example, the biological may be selected from one or more of:

A nucleic acid molecule;

A proteinaceous molecule;

An amino acid

A carbohydrate;

A lipid;

A steroid;

An inorganic molecule;

An ion;

A drug;

A chemical;

A metabolite;

A toxin;

A nutrient;

A gas;

A cell;

A pathogenic organism; and,

A non pathogenic organism.

In some embodiments, parameters are representative of at least a subset of a biomolecular system defining a class of biomolecular component types. For example, gene transcripts are one example of a biomolecular component type that are generally associated with a biomolecular system generally referred to as the “transcriptome”. Proteins are another example of a biomolecular component type and generally associated with a biomolecular system referred to as the proteome. Further, another example of a biomolecular component type are metabolites, which are generally associated with a biomolecular system referred to as the “metabolome”.

In specific embodiments, at least some of the parameters profile a subset of at least one biomolecular system selected from a transcriptome and a proteome of one or more specific cell types,. In specific embodiments, at least some of the parameters profile a subset of at least one biomolecular system selected from a transcriptome and a proteome of one or more specific cell types.

Other parameters can be measured however, such as the near IR spectrum or mass spectroscopy spectrum of the subject's blood or of the isolated components of the subjects blood (e.g., serum, white blood cells, or white blood cell membranes), general measurements, such as temperature, or other biological indicators.

The method usually includes:

Receiving confirmation of the determined status; and,

Updating the predetermined data in accordance with the confirmed status and the subject data.

The predetermined data can include phenotypic information of the individuals, and the subject data can include phenotypic information regarding the subject, the phenotypic information including details of one or more phenotypic traits.

In this case, the method can include comparing the subject data to predetermined data for individuals having one or more phenotypic traits in common with the subject.

The predetermined data is preferably diagnostic signatures, the method including determining a diagnostic signature for a respective condition by data mining subject data relating to a number of individuals having known conditions, or degrees of conditions; each diagnostic signature including a range of values for at least some of the parameters.

The subject data can be determined by at least one of:

Clinical trials; and,

Diagnosis of conditions within subjects.

The predetermined data can be diagnostic signatures, the method including determining a diagnostic signature for a respective condition by:

Obtaining data relating to a number of individuals, the data including:

An indication of the status of the individual;

Respective values for each of the number of parameters;

Selecting one or more groups of individuals in accordance with the status of the individuals and the condition; and,

Determining a range of parameter values for each group in accordance with the parameter values of the individuals, the range of parameter values representing a diagnostic signature for the respective group.

The method typically includes:

Comparing the data for each of the individuals to predetermined criteria; and,

Selectively excluding one or more individuals from a respective group in accordance with the results of the comparison.

The method can include:

Receiving confirmation of the determined status;

Comparing the data for each of the individuals to predetermined criteria; and,

Updating the predetermined data in accordance with the confirmed status and the subject data in response to a successful comparison.

The predetermined criteria generally represent quality control criteria.

The method therefore typically further includes:

Comparing the data for each of the individuals to each other; and,

Selectively excluding one or more individuals from a respective group in accordance with the results of the comparison.

The method can include, for each selected group:

Determining parameters that allow the group to be distinguished from each other group; and,

Determining a range of parameter values for the selected parameters in accordance with the parameter values of the individuals in the respective group.

Typically the method includes for each condition:

Determining parameters that allow the degree of the condition to be determined; and,

Determining a range of parameter values for the selected parameters taking account of the relationship between these parameter values and the degree of the condition.

The method may include for each diagnostic signatures:

Obtaining data for an individual having the respective condition;

Comparing the parameter values for the individual to the respective diagnostic signature; and,

Revising the diagnostic signature in accordance with an unsuccessful comparison.

The method typically further includes generating a report representing the status of the subject.

The method can be performed using a system including at least one end station coupled to a base station via a communications network, the method including causing the base station to:

Receive the subject data from the end station via the communications network;

Determine the status of the subject;

Transfer an indication of the subject status to the end station via the communications network.

The subjects and individuals can include:

Horses;

Camels;

Greyhounds;

Human Athletes; and,

Other Performance animals.

In a sixth broad form the present invention provides apparatus for determining the status of a subject, the apparatus including a processing system adapted to:

Obtain subject data, the subject data including respective values for each of a number of parameters, the parameter values being indicative of the current biological status of the subject;

Compare the subject data to predetermined data, the predetermined data including for each of a number of conditions:

A range of values for at least some of the parameters; and,

An indication of the condition; and,

Determine the status of the subject in accordance with the results of the comparison, the status indicating at least one of the presence, absence or degree of one or more of the conditions.

In a seventh broad form the present invention provides a computer program product for determining the status of a subject, the computer program product including computer executable code which when executed on a suitable processing system causes the processing system to perform the method of the fifth broad form of the invention.

In an eighth broad form the present invention provides a method of determining diagnostic signatures for use in the status determination of a subject, the method including:

Obtaining data relating to a number of individuals, the data including:

An indication of the status of the individual, including an indication of at least one definitively diagnosed condition;

Respective values for each of the number of parameters;

Selecting one or more groups of individuals in accordance with the status of the individuals and the condition; and,

Determining a range of parameter values for each group in accordance with the parameter values of the individuals, the range of parameter values representing a diagnostic signature for a respective group.

The method preferably includes, for each selected group:

Determining parameters that allow the group to be distinguished from each other group; and,

Determining a range of parameter values for the selected parameters in accordance with the parameter values of the individuals in the respective group.

The method typically includes for each diagnostic signature:

Obtaining data for an individual having the respective condition;

Comparing the parameter values for the individual to the respective diagnostic signature; and,

Revising the diagnostic signature in accordance with an unsuccessful comparison.

The data for each of the individuals can be determined by at least one of:

Clinical trials; and,

Diagnosis of conditions within subjects.

The diagnosis can be confirmed by a medical practitioner or veterinarian.

The diagnosis of conditions can be performed by:

Determining the status of the individual in accordance with the method of the sixth broad form of the invention; and,

Having the status subsequently confirmed by a medical practitioner or veterinarian.

The method may include:

Receiving confirmation of the determined status;

Comparing the data for each of the individuals to predetermined criteria; and,

Updating the predetermined data in accordance with the confirmed status and the subject data in response to a successful comparison.

The method can include:

Comparing the data for each of the individuals to predetermined criteria; and,

Selectively excluding one or more individuals from a respective group in accordance with the results of the comparison.

The predetermined criteria may represent quality control criteria.

The method can include:

Comparing the data for each of the individuals to each other; and,

Selectively excluding one or more individuals from a respective group in accordance with the results of the comparison.

The conditions can include at least one of:

A disease; and,

An assessment that the individual is healthy.

In a ninth broad form the present invention provides apparatus for determining diagnostic signatures for use in the status determination of a subject, the apparatus being adapted to perform the method of the eighth broad form of the invention.

In a tenth broad form the present invention provides a computer program product for determining diagnostic signatures for use in the status determination of a subject, the computer program product including computer executable code which when executed on a suitable processing system causes the processing system to perform the method of the eighth broad form of the invention.

In an eleventh broad form the present invention provides a method of allowing a user to determine the status of a subject, the method including:

Receiving subject data from the user via a communications network, the subject data including respective values for each of a number of parameters, the parameter values being indicative of the current biological status of the subject;

Comparing the subject data to predetermined data, the predetermined data including for each of a number of conditions:

Values for at least some of the parameters; and,

An indication of the condition; and,

Determining the status of the subject in accordance with the results of the comparison, the status indicating the presence and/or absence of the one or more conditions; and,

Transferring an indication of the status of the subject to the user via the communications network.

The method generally further includes:

Having the user determine the subject data using a remote end station; and,

Transferring the subject data from the end station to the base station via the communications network.

The base station can include first and second processing systems, in which case the method can include:

Transferring the subject data to the first processing system;

Transferring the subject data to the second processing system; and,

Causing the second processing system to perform the comparison.

The method may also include:

Transferring the results of the comparison to the first processing system; and,

Causing the first processing system to determine the status of the subject.

In this case, the method preferably includes at least one of:

Transferring the subject data between the communications network and the first processing system through a first firewall; and,

Transferring the subject data between the first and the second processing systems through a second firewall.

The second processing system may be coupled to a database adapted to store the predetermined data, the method including:

Querying the database to obtain at least selected predetermined data from the database; and,

Comparing the selected predetermined data to the subject data.

The second processing system can be coupled to a subject database, the method including storing the subject data in the subject database.

It is also possible to implement any one of the features of the fifth broad form of the invention. Thus, for example, the status may include details of any conditions of the individuals, in which case the method can include determining any conditions displayed by the user. The method may also include determining the ability of the subject to perform in a sporting and/or racing event in accordance with any determined conditions.

The method can include having the user determine the subject data using a secure array, the secure array of elements capable of determining the quantity of a biological molecule and having a number of features each located at respective position(s) on the array, and a respective code. In this case, the method typically includes causing the base station to:

Determine the code from the subject data;

Determine a layout indicating the position of each feature on the array; and,

Determine the parameter values in accordance with the determined layout, and the subject data.

In another embodiment, the secure array may consist of a set of randomly located features, each feature being tagged to identify the molecular marker with which it is associated, for example the features may micro beads tagged with an oligonucleotide bead type identifier and a probe oligonucleotide, self assembled onto an etched fibre optic bundle.

Accordingly, the method may include having the user determine the subject data using a secure array of elements capable of determining the quantity of a biological molecule, the secure array having a number of features each tagged with an identifier determining the type of biological molecule to which they bind, and a respective code, the method including causing the base station to:

Determine the code from the subject data;

Determine a layout indicating the position of each feature on the array;

Determining the parameter values in accordance with the determined layout, and the subject data.

The method may also include:

Receiving confirmation of the determined status from the user; and,

Updating the predetermined data in accordance with the confirmed status and the subject data.

In this case, the features can include at least one of:

An oligonucleotide;

A nucleotide

A peptide;

An amino acid;

An antibody;

A carbohydrate;

A lipid;

A cell; and,

An organism.

The method can also include causing the base station to:

Determine payment information, the payment information representing the provision of payment by the user; and,

Perform the comparison in response to the determination of the payment information.

In a twelfth broad form the present invention provides a base station for determining the status of a subject, the base station including:

A store method for storing predetermined data, the predetermined data including for each of a number of conditions:

Values for at least some of the parameters; and,

An indication of the condition; and,

A processing system, the processing system being adapted to:

Receive subject data from the user via a communications network, the subject data including respective values for each of a number of parameters, the parameter values being indicative of the current biological status of the subject;

Compare the subject data to the predetermined data;

Determine the status of the subject in accordance with the results of the comparison; and,

Output an indication of the status of the subject to the user via the communications network

The processing system can be adapted to receive subject data from a remote end station adapted to determine the subject data.

The processing system may include:

A first processing system adapted to:

Receive the subject data; and

Determine the status of the subject in accordance with the results of the comparison; and,

A second processing system adapted to:

Receive the subject data from the processing system; and,

Perform the comparison; and,

Transfer the results to the first processing system.

The base station typically includes:

A first firewall for coupling the first processing system to the communications network; and,

A second firewall for coupling the first and the second processing systems.

The processing system can be coupled to a subject database, the processing system being adapted to store the subject data in the subject database.

The method of performing the comparison can include causing the second processing system to:

Obtain the predetermined data in the form of a set of signatures; and,

Use the signatures to classify the subject data into a respective one of the groups.

The method may further include determining one or more conditions displayed by the subject in accordance with the determined group.

The subject data may be determined using a secure array, the secure array having a number of features each located at respective position on the array, and a respective code, the processing system being adapted to:

Determine the code from the subject data;

Determine a layout indicating the position of each feature on the array;

Determining the parameter values in accordance with the determined layout, and the subject data.

The processing system can be adapted to:

Receive confirmation of the determined ability; and,

Update the predetermined data in accordance with the determined ability and the subject data.

In a thirteenth broad form the present invention provides a computer program product for implementing a base station for determining the status of a subject, the computer program product including computer executable code which when executed on a suitable processing system causes the processing system to perform the method of the eleventh broad form of the invention.

In a fourteenth broad form the present invention provides an end station adapted to determine the status of a subject, the end station including a processor adapted to:

Determine subject data from the user, the subject data including the subject data including respective values for each of a number of parameters, the parameter values being indicative of the current biological status of the subject;

Transfer the subject data to a base station via a communications network, the base station being adapted to:

Compare the subject data to predetermined data for one or more individuals, the predetermined data including:

One or more parameter values for the respective individual; and,

An indication of the status of each individual; and,

Determine the status of the subject in accordance with the results of the comparison; and,

Receive an indication of the status of the subject via the communications network.

In a fifteenth broad form the present invention provides a computer program product for determining the status of a subject, the computer program product including computer executable code which when executed on a suitable processing system causes the processing system to operate as an end station according to the eleventh broad form of the invention.

In a sixteenth broad form the present invention provides a method of determining the ability of a subject to perform in a sporting and/or racing event, the method including:

Obtaining subject data, the subject data including one or more parameter values, at least one of the parameter being indicative of the current biological status of the subject;

Comparing the subject data to predetermined data, the predetermined data including for each of a number of individuals:

One or more parameter values for the respective individual; and,

An indication of the status of each individual;

Determining the status of the subject in accordance with the results of the comparison; and,

Providing an indication of the ability in accordance with the results of the comparison.

The status of each individual typically indicates any conditions displayed by the user, in which case the method typically includes:

Determining any conditions displayed by the user in accordance with the results of the comparison; and,

Determining the ability in accordance with the determined conditions.

In a seventeenth broad form the present invention provides apparatus for determining the ability of a subject to perform in a sporting and/or racing event, the apparatus including a processing system adapted to:

Obtain subject data, the subject data including one or more parameter values, at least one of the parameter being indicative of the current biological status of the subject;

Compare the subject data to predetermined data, the predetermined data including for each of a number of individuals:

One or more parameter values for the respective individual; and,

An indication of the status of each individual;

Determine the status of the subject in accordance with the results of the comparison; and,

Provide an indication of the ability in accordance with the results of the comparison.

In an eighteenth broad form the present invention provides a computer program product for determining the ability of a subject to perform in a sporting and/or racing event, the computer program product including computer executable code which when executed on a suitable processing system causes the processing system to perform the method of the thirteenth broad form of the invention.

In a nineteenth broad form the present invention provides a method of providing secure arrays, each array including a number of predetermined features, the method including:

Determining a number of respective feature layouts, each layout representing the positioning of each feature on a respective array;

Determining a number of codes, each code corresponding to a respective layout;

Generating a number of arrays, each array being generated in accordance with at least one of:

a respective layout, and including the corresponding code thereon, the code being used in processing the array; and,

as a self assembled random array of tagged features, each feature coded with information describing the molecular identity of the probe which it contains, and including the corresponding code thereon, the code being used in processing the array.

The method can be performed to provide the arrays on behalf of an entity, the method including providing an indication of the layouts and corresponding codes to the entity, to thereby allow the entity to process the arrays.

The method of determining the layouts typically includes:

Determining a preferred layout; and,

Moving the position of one or more of the features from the position in the preferred layout to alternative position.

The method can include:

Determining the type of each feature; and,

Exchanging the position of one or more features having different feature types.

### BRIEF DESCRIPTION OF THE DRAWINGS

Illustrative examples of the present invention will now be described with reference to the accompanying drawings, in which:

FIG. 1 is a schematic diagram of an example of a processing system for implementing embodiments of the invention;

FIG. 2 is a flow chart outlining a process implemented by the system of FIG. 1 according to some embodiments of the invention;

FIG. 3 is a schematic diagram of an example of a distributed architecture for implementing embodiments of the invention;

FIG. 4 is a schematic diagram of an example of one of the end stations of FIG. 3;

FIG. 5 depicts a flow chart of the process implemented by the system of FIG. 3;

FIG. 6A is a flow chart of an example of the process for generating diagnostic signatures;

FIG. 6B is an example of the data flow for the process for generating diagnostic signatures;

FIGS. 7A and 7B are a flow chart of the process of comparing the subject data to diagnostic signatures according to embodiments of the invention;

FIG. 8 is a schematic diagram of a second example of a distributed architecture for implementing embodiments of the invention;

FIG. 9 is a flow chart of the process for generating secure arrays according to embodiments of the invention; and,

FIG. 10 is a flow chart of the process for generating subject data using secure arrays according to embodiments of the invention.

FIG. 11 is a flow chart of the process of data mining according to embodiments of the invention;

FIG. 12 is a flow diagram illustrating dataflow steps in a specific example as part of a computer system capable of delivery of remote diagnostic services according to embodiments of the invention;

FIG. 13 is a flow diagram showing an example of the processing associated with diagnosing a condition of an animal;

FIG. 14 is a diagram illustrating an environment according to embodiments of the invention for working the example shown in FIG. 13;

FIG. 15 is a flow diagram illustrating an example of the processing according to embodiments of the invention for preparing an array;

FIG. 16 is a flow diagram showing the processing according to embodiments of the invention for determining a nucleic acid expression level in a biological sample;

FIG. 17 is a flow diagram illustrating the processing according to embodiments of the invention for building a database in accordance with a specific example;

FIG. 18 is a trace output from the Agilent Lab-on-a-Chip system, representing high quality RNA, as determined by GeneChip® analysis of the RNA. The first peak from the left is a marker of known quantity. The second and third peaks represent the 18S and 28S RNA. The 28S peak should be larger than the 18S peak in exactly the proportions shown here. The rest of the trace is relatively flat representing high quality RNA.

FIG. 19 is a trace output from the Agilent Lab-on-a-Chip system, representing low quality RNA, as determined by GeneChip® analysis of the RNA. The RNA yield is low (the 18S and 28S peaks are small compared to the first control peak) and the sloping trace represents degraded RNA.

FIG. 20 is a photographic representation of a screen capture from MAS 5 of a .DAT file for a single GeneChip®. The actual chip is contained within the outer blue borders. Genetrax is spelled out in the top left-hand corner through the binding of the B2 oligo during the hybridisation process. The bottom sixth of the chip is black because it contains no oligonucleotides.

FIG. 21 is a photographic representation of a close-up of the top left-hand corner of the screen capture shown in FIG. 20. MAS 5 has laid down a grid on top of the oligonucleotide squares as part of the orientation process. It is important that the software recognises each square accurately, given that the outer pixels are discarded. The outer-most border, a grid in the top left-hand corner and the G of Genetrax can be seen. These squares consist of oligonucleotides that bind to the spiked-in B2 oligo. Detail of some of the oligonucleotides for horse genes can be seen with some squares lighting up and some squares remaining dark.

FIG. 22 shows a scatter plot of the four conditions (i.e., osteoarthritis (A), EHV (E), gastric ulcer syndrome (G) and normal (N)) with respect to the first two linear discriminant functions in the demonstration study.

### DETAILED DESCRIPTION OF THE PRESENTLY PREFERRED EMBODIMENTS

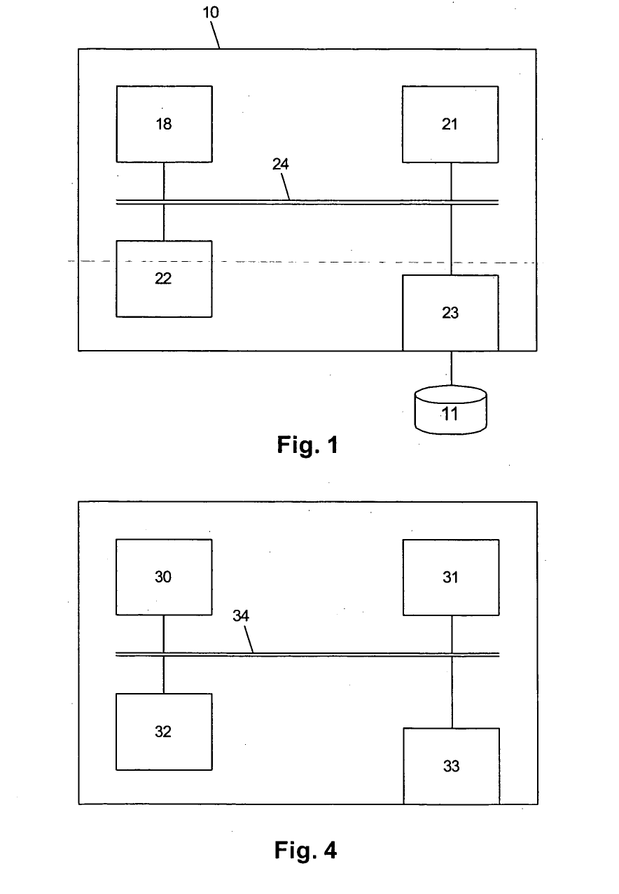

The present invention will now be described with reference to FIG. 1, which shows a processing system suitable for implementing the present invention.

In particular, FIG. 1 shows a processing system 10 including a processor 20, a memory 21, an optional input/output (I/O) device 22 and an interface 23 coupled together via a bus 24. In use, the interface 23 is adapted to couple the processing system 10 to one or more databases shown generally at 11.

In use, the processing system 10 is constructed and adapted to receive subject data, which is data representative of the current biological status of a subject. The subject data is typically in the form of raw data and therefore requires interpretation to allow the status of the subject to be determined. This is achieved by having the processing system 10 compare the subject data to predetermined data stored in the database 11. The predetermined data includes data representative of the biological status of a number of individuals, together with an indication of the actual status of the individuals when the predetermined data was collected.

Accordingly, comparison of the subject data with the predetermined data, allows the subject data to be interpreted and aspects of the current biological status of the subject to be determined.

Accordingly, it will be appreciated that the processing system may be any form of processing system suitably programmed to perform the analysis, as will be described in more detail below. The processing system may therefore be a suitably programmed computer, laptop, palm computer, or the like. Alternatively, specialised hardware or the like may be used. This allows the hardware system to be implemented as a portable device, such as a PDA which may be coupled to the database 11 via a suitable communications network, such as the Internet, as will be appreciated by persons skilled in the art.

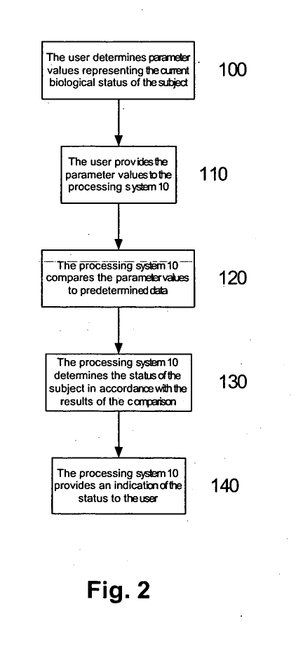

The manner in which this may be achieved according to embodiments of this invention will now be described in outline with respect to FIGS. 1 and 2.

In particular, at 100 a user determines subject data in the form of parameter values representing the current biological status of the subject. In particular, the parameter values represent specific measurements of selected parameters that represent the current biological status of the subject. It will be appreciated that a number of different forms of parameters may be used, as will be described in more detail below.

At 110 the user provides the parameter values to the processing system 10, which then operates to compare the subject data to the predetermined data (at 120). In particular, the predetermined data includes parameter values for a number of individuals having a range of different biological states.

Comparing the subject and predetermined data allows the processing system 10 to determine the status of the subject in accordance with the results of the comparison at 130. Thus, the processing system 10 attempts to identify individuals having similar parameter values to the subject. The status of the subject is then determined to be similar to that of the identified individuals.

Once the status has been determined the processing system 10 provides an indication of the status to the user (at 140).

This procedure can therefore be used to identify a wide range of conditions that may be displayed by the subject. In particular, the system can be adapted to determine the presence or absence of one or more of a number of conditions in the subject. In the case of the subject being an athletic performance subject, such as a human, race horse, camel, llama, greyhound, or the like, this allows an assessment to be made of the impact of the presence or absence of the conditions on the ability of the performance animal to compete in events, such as races.

In order to achieve this, each of the number of conditions must have been previously identified in the individuals, and accordingly, it is therefore necessary to have predetermined data for a large number of individuals, with at least some of the individuals having one or more of the conditions, and at various stages of the conditions. Furthermore, it is also necessary to utilise a sufficiently large number of parameters to allow each of the respective conditions to be distinguished on a statistical basis, and a sufficiently large number of individuals in the sample from which predetermined data are obtained.

The parameters used and typical numbers will be described in more detail below. However, it will be appreciated that the number of parameters required will generally increase depending on the number of conditions being identified.

Accordingly, it is typical for the predetermined data to ultimately include values for a large number of parameters and individuals.

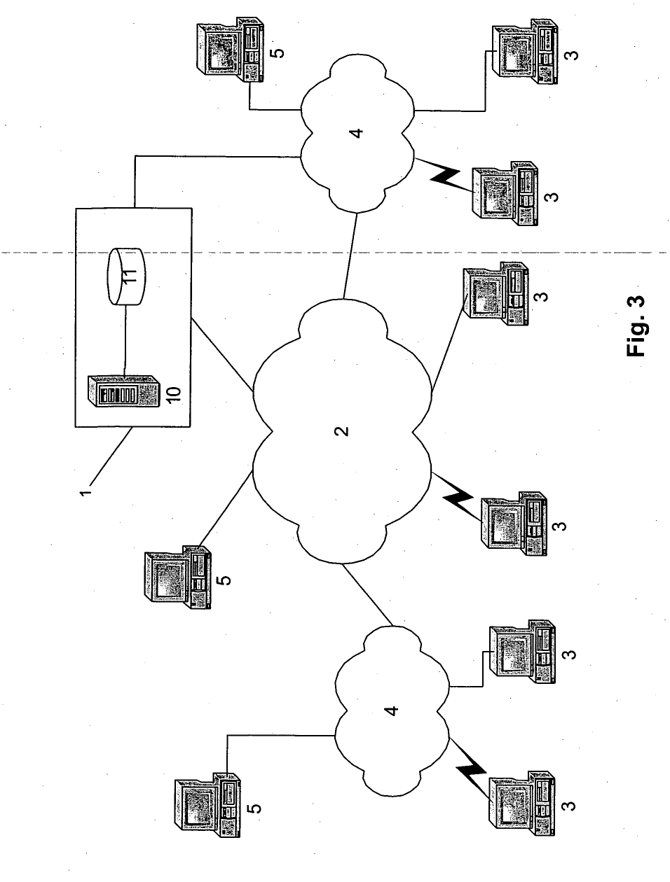

As a result the determination of the predetermined data is typically a time consuming and expensive procedure. This has an impact on the manner in which the system is implemented, primarily as it is not feasible for individual users wanting to implement the method to collect their own predetermined data. Accordingly, in one example, the techniques may be implemented using a distributed processing system an example of which is shown in FIG. 3.

As shown, in FIG. 3 the system of embodiments of the present invention is formed from a base station 1 coupled to a number of end stations 3 via a communications network 2, and/or via a number of LANs (Local Area Networks) 4. The base station 1 is generally formed from one or more of the processing systems 10 (shown in FIG. 1) coupled to a data store, such as the database 11, as shown.

In use, the processing system 10 operates substantially as described above to process data. received, for example, via the communications networks 2, 4. The processing system 10 can then supply an indication of the determined subject status back to the respective end station 3 via the communications network 2, 4, as will be understood by a person skilled in the art.

In use, this allows the base station to be administered by an operator, that provides services allowing users of the end stations 3 to determine the status of a subject. This in turn overcomes the need for each user to obtain their own predetermined data. Furthermore, by having the base station 1 perform the comparison of the subject and predetermined data, and determine the status, this allows the operator of the base station 1 to restrict access to the predetermined data, thereby preventing the data being accessed and used by unauthorised third parties. This, in turn allows the operator to charge a fee for the provision of an indication of the status of the subject, as will be described in more detail below. In any event, it will therefore be appreciated that the system may be implemented using a number of different architectures. However, in this example the communications network 2 is preferably the Internet , with the LANs 4 representing private LANs, such as LANs within a company or the like.

Whilst this technique describes transferring the data electronically via the communications networks, it will also be possible to transfer data via alternative techniques such as transferring data in a hard, or printed format, as well as transferring the data electronically in a portable physical medium such as a floppy disk, CD-ROM or the like. Wireless transfer or the like is also possible, as will be appreciated by the person skilled in the art.

In preferred embodiments of the present invention, the data are protected, for example, by known encryption techniques, before being sent from the end stations 3 to the base station 10. Likewise, the results produced by the base station 10 a preferably encrypted before being sent back to the end stations 3. In this manner, the privacy and security of queries and results are maintained.

In any event, it will be appreciated that in this example, the services provided by the base station 1 are generally accessible via the Internet 2. The processing system 10 is therefore generally capable of generating web pages, or the like, that can be viewed by users of the end stations 3. Accordingly, the processing system 10 may be any suitable form of processing system that executes appropriate application software stored in the memory 21 to allow the desired functionality to be achieved. Typically however the base station 1 includes a processing system, such as a network server, web server or the like.

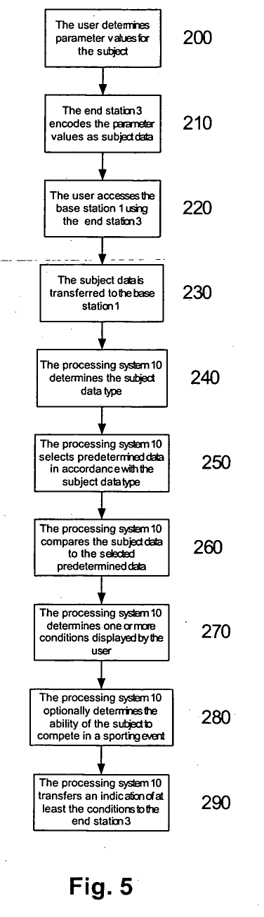

Similarly, the end stations 3 must be capable of communicating with the base station 1 to allow browsing of web pages, or the transfer of data in other manners. Accordingly, as shown in the example of FIG. 4, the end stations 3 are formed from a processing system including a processor 30, a memory 31, an input/output (I/O) device 32 and an interface 33 coupled together via a bus 34. The interface 33, which may be a network interface card or the like, is used to couple the end station to the Internet 2 or one of the respective LANs 4.

It will therefore be appreciated that the end station 3 may be formed from any suitable processing system such as a suitably programmed PC, Internet Terminal, Lap-top, hand held PC, PDA, telephone or the like which is typically operating application software to enable web browsing or the like. Alternatively, the end station 3 may be formed from specialised hardware, such as an electronic touch sensitive screen coupled to suitable processor and memory. In addition to this, the end stations 3 may be connected to the Internet 2 or the LANs 4 via wired or wireless connections, as will be appreciated by a person skilled in the art. This allows the end stations 3 to be implemented as hand held devices wireless devices, as will be described in more detail below.

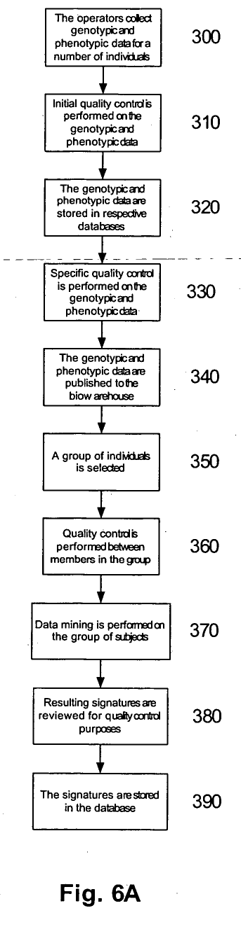

Operation of the system to determine the status of the subject will now be described in more detail with reference to the exemplary flowchart in FIG. 5.

In particular, as set forth in FIG. 5, the process begins (at 200) with the user determining the parameter values for the subject. The parameter values are then encoded as subject data by the end station 3 (at 210). This is typically achieved in accordance with a predetermined algorithm such that the subject data has a predetermined format that can be interpreted by the base station 1. As noted above, the subject data may be protected by encryption at this time.

At 220, the user accesses the base station 1 using the end station 3.

Preferably only authorised users may access the system in the base station 1. Accordingly, at this stage, the user of the end station 3 will typically be required to either register with the base station I or supply a previously obtained user name and password. In particular, this user login/verification is performed to allow the base station 1 to determine the identity of the user and therefore confirm that the user has authorisation to utilise the services provided by the base station 1 and/or to ensure that payment can be obtained for the provision of the services.

It will be appreciated that the user name and password will typically be provided when the user registers with the base station 1 on a first occasion. At this point the user has to make provisions for payments, such as the provision of account details, thereby allowing the operator of the base station 1 to charge the user for the services provided.

The user name and password will then be generated or selected and subsequently verified in the normal way, as is well known in the art. Alternatively, identification of the user can be achieved in accordance with cookies stored at the end station 3, or an identifier associated with the end station 3, which may for example, be the MAC (Media Access Control) address of the end station interface 33, or the like.

In any event, it will be appreciated that in preferred embodiments of the present invention, access to the services provided by the base station 1 is generally limited to authorised users.

In any event, when the user accesses the base station 1, this is typically achieved by accessing respective web pages generated by the base station 1. This allows the user to select the respective services required, which in this example is an indication of the status of a subject.

Once the user has been authorised, the user will be transferred to a secure environment to allow the subject data to be transferred to the base station 1 for processing. This is typically achieved, for example, by implementing an SSL (Secure Socket Layer) connection between the base station 1 and the end station 3. This provides additional security and in particular, to ensure that the subject data transferred between the base station 1 and end station 3 is retained confidential. Any mechanism for secure communication may be used between the base station 1 and the end station 3.

Confidentiality of the subject data and the determined status are important as the results are often used in determining the ability and/or eligibility of the subject to compete in sporting and/or racing events, this information can be extremely valuable, especially to the gambling industry. It is therefore necessary to ensure the information is retained confidential at all times. It is generally also preferred to keep confidential the fact that a status test is being performed on a particular subject.

After accessing the base station 1 (at 220), the subject data is transferred to the base station 1 (at 230). At this point, the base station 1 will typically operate to review the subject data to ensure that it is genuine subject data, and that for example, the data does not disguise an attempt to gain illicit or unauthorised access to the base station 1 to obtain access to the predetermined data. This is typically achieved by having the base station 1 implement a firewall between the processing system 10 and the Internet 2 or LANs 4 to ensure that unwanted data are not received.

In any event, (at 240) the processing system 10 operates to determine the nature of the subject data.

Thus, it will be appreciated that the exact subject data provided and, in particular, the parameters for which values are provided may vary depending on the respective implementation. This will be described in further detail below. However, it will be appreciated that the subject data may be collected using arrays, in which case a number of different arrays may be provided. Thus, in this case, the base station 1 will operate to determine the type of array being used, to allow the subject data to be interpreted.

At 250 the processing system 10 selects at least some of the predetermined data in accordance with the nature of the subject data. Thus, for example, the processing system 10 will operate to select parameter values from the predetermined data for parameters corresponding to those contained in the subject data.

At 260 the processing system 10 compares the parameter values of the subject data to the parameter values of the selected predetermined data. In particular, the processing system 10 operates to compare the parameter values to those obtained from a number of different individuals that between them have a range of different conditions. This allows the processing system 10 to determine one or more conditions displayed by the subject (at 270).

At 280 the processing system 10 optionally determines the ability and/or eligibility of the subject to compete in a sporting and/or racing event in accordance with the determined conditions. The processing system 10 then transfers an indication of at least the conditions to the end station 3 (at 290).

Phenotypic Information

Thus, it will be appreciated that the system may be implemented in a variety of ways. Typically however the subject data is formed from phenotypic information representative of the current biological status of the subject. In some embodiments, the phenotypic information results from the expression of the genotype of the subject and is therefore typically in the form of information such as expression data, or the like.

Biomolecular Systems Profiling

Advantageously, at least some of the phenotypic information profiles gene expression in one or more specific cell types. In some embodiments, the profiled gene expression represents at least a subset of the transcriptome. By “transcriptome” is meant the entire complement of transcripts that are expressed by the specific cell type(s), including transcripts expressed in both normal and disease states. The transcriptome thus has a qualitative element (the identity of individual gene transcripts) and a quantitative element (the proportion of each unique transcript in the total number of individual transcripts present in the cell at a particular moment). In certain embodiments, the transcriptome comprises messenger RNAs transcribed from a multiplicity of transcription units that populate a genome.

In other embodiments, the profiled gene expression represents at least a subset of the proteome. As used herein, the term “proteome” refers to the global pattern of protein expression in the specific cell type(s), including proteins expressed in both normal and disease states.

In various embodiments, the cell types are selected from primary cells, which, generally, are cells that cannot proliferate indefinitely in culture. Primary cells can be derived from adult tissue, or from embryo tissue that is differentiated in culture to an adult cell or to a precursor of an adult cell that displays specialised characteristics. Illustrative cell types include specialised cell types such as but not limited to cardiomyocytes, endothelial cells, sensory neurones, motor neurones, CNS neurones (all types), astrocytes, glial cells, schwann cells, mast cells, eosinophils, smooth muscle cells, skeletal muscle cells, pericytes, lymphocytes, tumour cells, monocytes, macrophages, foamy macrophages, granulocytes, synovial cells/synovial fibroblasts, epithelial cells (varieties from all tissues/organs). Examples of other suitable specialised cell types include vascular endothelial cells, smooth muscle cells (aortic, bronchial, coronary artery, pulmonary artery, etc), skeletal muscle cells, fibroblasts (many types, such as synovial), keratinocytes, hepatocytes, dendritic cells, astrocytes, neurone cells (including mesencephalic, hippocampal, striatal, thalamic, hypothalamic, olfactory bulb, substantia nigra, locus coeruleus, cortex, dorsal root ganglia, superior cervical ganglia, sensory, motor, cerebellar cells), neutrophils, eosinophils, basophils, mast cells, monocytes, macrophage cells, erythrocytes, megakaryocytes, hematopoletic progenitor cells, hematopoietic pluripotent stem cells, any stem cells, any progenitor cells, epithelial cells, melanocytes, osteoblasts, osteoclasts, stromal cells, purkinje cells, T-cells, B-cells, synovial cells, pancreatic islet cells (alpha and beta), leukaemia cells, lymphoma cells, tumour cells, retinal cells and adrenal chromaffin cells.

The expression data may relate to the level, abundance or functional activity of an RNA molecule or a polypeptide. The RNA molecule includes, but is not restricted to, RNA transcripts such as a primary gene transcript or pre-messenger RNA (pre-mRNA), which may contain one or more introns, as well as a messenger RNA (mRNA) in which any introns of the pre-mRNA have been excised and the exons spliced together, heterogeneous nuclear RNA (hnRNA), small nuclear RNA (snRNA), small nucleolar RNA (snoRNA), small cytoplasmic RNA (scRNA), ribosomal RNA (rRNA), translational control RNA (tcRNA), transfer RNA (tRNA), eRNA, messenger-RNA-interfering complementary RNA (micRNA) or interference RNA (iRNA) and mitochondrial RNA (mtRNA). Suitable polypeptides that are contemplated by the present invention include enzymes, receptors, immunoglobulins, hormones, cytokines, chemokines, neuropeptides, adhesins, glycoproteins and the like. Alternatively, the expression data may relate to the level or abundance of a carbohydrate including monosaccharides, oligosaccharides and polysaccharides.

When the phenotypic information relates to expression data, these are typically obtained by any suitable qualitative or quantitative technique. However, where it is necessary to determine the level or abundance of a multiplicity of different expression products, it is preferable to use multiplexed analysis techniques including arrays and distinctly detectable beads as is well known in the art.

In some embodiments, the phenotypic information includes information representing at least a subset of the transcriptome (also referred to herein as a “subtranscriptome”) of one or more cell types. Determination of gene expression, or gene expression profiling, may be accomplished by any one of many suitable procedures available in the art. Examples of such methods may employ differential display, high-throughput sequencing of cDNA libraries, gene expression profiling using solid phase platforms including microchip arrays of genes or northern blot analysis of gene transcription, and mass spectroscopy.

For example, gene expression can be analysed by Differential Display Reverse Transcriptase Polymerase Chain Reaction (DDRT-PCR). This technique involves the use of oligo-dT primers and random oligonucleotide 10-mers to carry out PCR on reverse-transcribed RNA from different cell populations. PCR is often carried out using a radiolabelled nucleotide so that the products can be visualised after gel electrophoresis and autoradiography. A review of differential display RT-PCR (also known as differential display of mRNA) is provided in Zhang et al. (1998 Mol Biotechnol. 10(2):155-65) and a recent improvement using ‘long distance’ PCR is described in Zhao et al. (1999 J Biotechnol. 73(1):35-41).

Other techniques that are suitable for the analysis of the transcriptome of a specific cell type include Serial Analysis Of Gene Expression (SAGE; Velculescu et al., 1995 Science 270:484-487), Selective Amplification via Biotin- and Restriction-mediated Enrichment (SABRE) (Lavery et al., 1997 Proc. Natl. Acad. Sci. USA 94:6831-6836), representational difference analysis (RDA) (Hubank, 1999 Methods in Enzymology 303:325-349; see Kozian and Kirschbaum, 1999 Trends in Biotech. 17:73-78 for review and references therein); differential screening of cDNA libraries (see Sagerstrom et al., 1997, Annu. Rev. Biochem. 66:751-783); “Advanced Molecular Biology,” R. M. Twyman (1998) Bios Scientific Publishers, Oxford; “Nucleic Acid Hybridisation,” M. L. M. Anderson (1999) Bios Scientific Publishers, Oxford); Northern blotting; PNAse protection assays; S1-nuclease protection assays; RT-PCR; real time RT-PCR (Taq-man); EST sequencing; massively parallel signature sequencing (MPSS); and sequencing by hybridisation (SBH) (see Drmanac R. et al., 1999, Methods in Enzymology 303:165-178). Many of these techniques are reviewed in “Comparative gene-expression analysis” Trends Biotechnol. 1999 17(2):73-8.

Alternatively, gene expression can be analysed by quantifying the number of expressed genes and their relative abundance under given conditions and at a given time (see e.g., Seilhamer et al., “Comparative Gene Transcript Analysis,” U.S. Pat. No. 5,840,484). In essence, this method utilises high-throughput cDNA sequencing to identify specific transcripts of interest. The generated cDNA and deduced amino acid sequences are then extensively compared with at least one nucleic acid sequence database (e.g., GenBank). After it is determined if the sequence is an exact match, a similar sequence or entirely dissimilar, the sequence is entered into a data base. Next, the numbers of copies of cDNA corresponding to a particular genes are tabulated, preferably with the aid of a computer program. The numbers of copies are divided by the total number of sequences in the data set, to obtain a relative abundance of transcripts for each corresponding gene. The list of represented genes can then be sorted by abundance in the cDNA population.

The advent of DNA chip technology allows comparisons to be conveniently conducted by the use of nucleic acid microarrays (see, e.g., Kozian and Kirschbaum, 1999 supra for review and references therein). Typically, arrays are generated using cDNAs (including Expressed Sequence Tags ESTs), PCR products, cloned DNA and synthetic oligonucleotides that are fixed to a substrate such as nylon filters, glass slides or silicon chips. To determine differences in gene expression, labelled cDNAs or PCR products are hybridised to the array and the hybridisation patterns compared. The use of detectably (e.g., fluorescently) labelled probes allows mRNA from one or more cell populations to be analysed simultaneously on a single microarray and the results measured at different wavelengths. A microarray-based differential expression screening technique is described in U.S. Pat. No. 5,800,992. Illustrative methods for preparation, use and analysis of microarrays are described by Brennan et aL (U.S. Pat. No. 5,474,796), Schena et al. (1996 Proc. Natl. Acad. Sci. USA 93:10614-10619), Baldeschweiler et al. (PCT application WO95/251116), Shalon et al. (PCT application WO95/35505), Heller et al. (1997, Proc. Natl. Acad. Sci. USA 94:2150-2155) and Heller et al. (U.S. Pat. No. 5,605,662). Various types of microarrays are described in DNA Microarrays: A Practical Approach, M. Schena, ed. (1999) Oxford University Press, London,

In an illustrative example employing microarray analysis of a transcriptome, mRNA (˜1 μg) is isolated from the test cells to generate first-strand cDNA by using a T7-linked oligo(dT)primer. After second-strand synthesis, in vitro transcription (Ambion) is performed with biotinylated UTP and CTP (Enzo Diagnostics), the result is a 40- to 80-fold linear amplification of RNA. Forty micrograms of biotinylated RNA is fragmented to 50- to 150-nt size before overnight hybridisation to Affymetrix (Santa Clara, Calif.) HU6000 arrays (e.g., such arrays may contain probe sets for 6,416 human genes (5,223 known genes and 1,193 ESTs)). After washing, arrays are stained with streptavidin-phycoerythrin (Molecular Probes) and scanned on a Hewlett Packard scanner. Intensity values are scaled such that overall intensity for each chip of the same type is equivalent. Intensity for each feature of the array is captured using the GeneChip® Software (Affymetrix, Santa Clara, Calif.), and a single raw expression level for each gene is derived from the 20 probe pairs representing each gene by using a trimmed mean algorithm. A threshold of 20 units is assigned to any gene with a calculated expression level below 20, because discrimination of expression below this level is not performed with confidence in this procedure.

After establishing the gene expression for the test cells, gene expression profiles are analysed using suitable statistical analyses, for example, iterative global partitioning clustering algorithms and Bayesian evidence classification, to identify and characterise clusters of genes having similar expression profiles (see, e.g., Long et al., 2001, J. Biol. Chem., 276(23):19937-19944). Typically, the steps involved in this statistical analysis are (1) determination of the fold induction (log ratio) of the genes, (2) normalisation of the gene profile to a magnitude equal to 1, (3) partition clustering of all genes measured in to determine unique clustering patterns, (4) differentiation of gene clusters in each test populations into the following sub-groups based on their expression as compared to the population-average profile: early up-regulated, late up-regulated, down-regulated and others, (5) performance of a comparative analysis to explore the common genes in the early up-regulated and down-regulated cluster sub-groups in the test populations of cells, and (6) correlation based on the Pearson correlation coefficient to determine differences and similarities among the sub-groups in the test populations of cells.

In other embodiments, the phenotypic information includes information representing at least a subset of the proteome (also referred to herein as a “subproteome”) of one or more cell types. Proteome expression patterns, or profiles, are analysed by quantifying the number of expressed proteins and their relative abundance under given conditions and at a given time. A profile of a cell's proteome may thus be generated by separating and analysing the polypeptides of a particular tissue or cell type. For example, proteins extracted from tissue or cell samples can be separated into individual proteins by gel electrophoresis (Hochstrasser et aL, 1988 Anal Biochem. 173:424-435; Huhmer et al., 1997 Anal. Chem. 69:29R-57R; Garfin 1990, Methods in Enzymology 182:425-441; ibid 459-477), capillary electrophoresis (Smith et al., “Capillary electrophoresis-mass spectrometry,” in: CRC Handbook of Capillary Electrophoresis: A Practical Approach, Chp. 8, pg. 185-206 (CRC Press, Boca Raton, Fla., 1994); Kilr “Isoelectric focusing in capillaries,” in: CRC Handbook of Capillary Electrophoresis: A Practical Approach, Chp. 4, pg. 95-109 (CRC Press, Boca Raton, Fla., 1994); McCormick, R. M., “Capillary zone electrophoresis of peptides,” in: CRC Handbook of Capillary Electrophoresis: A Practical Approach, Chp. 12, pg. 287-323 (CRC Press, Boca Raton, Fla., 1994); Palmieri, R. and Nolan, J. A., “Protein capillary electrophoresis: theoretical and experimental considerations for methods development,” in: CRC Handbook of Capillary Electrophoresis: A Practical Approach, Chp. 13, pg. 325-368 (CRC Press, Boca Raton, Fla., 1994)), or affinity techniques (Nelson, R. W., “The use of affinity-interaction mass spectrometry in proteome analysis,” paper presented at the BC Proteomics conference, Coronado, Calif. (Jun. 11-12, 1998); Bakhtiar et al., 2001 Mol Pharmacol. 60(3):405-415; Young, J., “Ciphergen Biosystems,” paper presented at the CHI Genomics Opportunities conference, San Francisco, Calif. (Feb. 14-15, 1998)), before quantification and comparison of their relative expression levels to those from comparative samples.

For example, the separation can be achieved using two-dimensional gel electrophoresis, in which proteins from a sample are separated by isoelectric focusing in the first dimension, and then according to molecular weight by sodium dodecyl sulphate slab gel electrophoresis in the second dimension (see, e.g., Anderson et al., 1996 Electrophoresis 17:443-453). The proteins are visualised in the gel as discrete and uniquely positioned spots, typically by staining the gel with an agent such as Coomassie Blue or silver or fluorescent stains. Commercial software packages are available for automated spot detection. For example, gel images are electronically retrieved by high-resolution scanners and analysed (spot-finding) using pattern recognition techniques against 2-D gel database queries (Miura, 2001 Electrophoresis 22:801-813). Proteome maps are then compared against databases for identification of up- or down-regulation in a disease state. The optical density of each protein spot is generally proportional to the level of the protein in the sample. The optical densities of equivalently positioned protein spots from different samples, for example, from biological samples obtained from different subjects, are compared to identify any changes in protein spot density between the subjects. Sophisticated software packages can be employed to enhance contrast, subtract background, align images, remove artefacts, and perform gel comparison. Spots of interest may be excised from gels and the proteins identified using, for example, standard methods employing chemical or enzymatic cleavage followed by mass spectrometry including Matrix Assisted Laser Desorption Ionisation-Time Of Flight (MALDI-TOF) mass spectrometry and electrospray mass spectrometry (see, e.g., Pandey and Mann, 2000 Nature 405:837-846). If desired, the identity of the protein in a spot may be determined by comparing its partial sequence, typically of at least 5 contiguous amino acid residues, to a protein sequence database (e.g., SwissProt, GenPept or other sequence databases). In some cases, further sequence data may be obtained for definitive protein identification.

In some instance, it may be desirable to perform some measure of prefractionation, such as centrifugation or free-flow electrophoresis to improve the identification of low abundance proteins. Special procedures have also been developed for basic proteins, membrane proteins and other poorly soluble proteins (Rabilloud et al., 1997 Electrophoresis 18:307-316).

Alternatively, proteomes can be analysed using activity-based probes (“ABPs”) (see, e.g., U.S. Pat. App. Pub. 2002/0182651). In these methods, a protein extract is combined with ABPs to produce covalent conjugates of the active target proteins with the probes. The probes comprise a “warhead” directed to a desired protein class. The warhead is covalently linked to a ligand, which is typically detectable, e.g. by fluorescence (“fABP”), and which may be used for separation and/or detection. Following reaction of the complex protein mixture with one or more ABPs, the resulting protein conjugates are proteolytically digested to provide probe-labelled peptides. ABPs are selected such that each active target protein forms a conjugate with a single ABP at a single discrete location in the target protein, each conjugate thereby giving rise to a single ABP-labelled peptide. Enrichment separation, or identification of one or more ABP-labelled peptides is achieved using liquid chromatography and/or electrophoresis. Additionally, mass spectrometry can be employed to identify one or more ABP-labelled peptides by molecular weight and/or amino acid sequence. If desired, the sequence information derived from of the ABP-labelled peptide(s) is used to identify the protein from which the peptide originally derived.

Variations of this method can be used to compare the proteome of two more cells or cell populations, e.g., using ABPs having different ligands, or, when analysis comprises mass spectrometry, having different isotopic compositions. In the latter variation, ABPs that differ isotopically are used to enhance the information obtained from MS procedures to quantitatively compare individual proteins or classes of proteins between two or more cells or populations of cells. For example, using automated multistage MS, the mass spectrometer may be operated in a dual mode in which it alternates in successive scans between measuring the relative quantities of peptides obtained from prior fractionation and recording the sequence information of the peptides. Peptides can be quantified by measuring in the MS mode the relative signal intensities for pairs of peptide ions of identical sequence that are tagged with the isotopically light or heavy forms of the reagent, respectively, and which therefore differ in mass by the mass differential encoded with the ABP. Peptide sequence information can be automatically generated by selecting peptide ions of a particular mass to charge (m/z) ratio for collision induced dissociation (CID) in the mass spectrometer operating in the MSⁿ mode. (Link et al., 1997 Electrophoresis 18:1314-1334; Gygi et al., 1999 ibid 20:310-319; and Gygi et al., 1999 Mol. Cell. Biol. 19:1720-1730). The resulting CID spectra can be then automatically correlated with sequence databases to identify the protein from which the sequenced peptide originated. Combination of the results generated by MS and MSⁿ analyses of affinity tagged and differentially labelled peptide samples allows the determination of the relative quantities as well as the sequence identities of the components of protein mixtures.

Protein identification by MSⁿ can be accomplished by correlating the sequence contained in the CID mass spectrum with one or more sequence databases, e.g., using computer searching algorithms (Eng et al., 1994 J. Am. Soc. Mass Spectrom. 5:976-989; Mann et al., 1994 Anal. Chem. 66:4390-9439; Qin et al., 1997 ibid 69:3995-4001; Clauser, et al., 1995 Proc. Natl. Acad. Sci. USA 92:5072-5076). Pairs of identical peptides tagged with the light and heavy affinity tagged reagents, respectively (or in analysis of more than two samples, sets of identical tagged peptides in which each set member is differentially isotopically labelled) are chemically identical and therefore serve as mutual internal standards for accurate quantification. The MS measurement readily differentiates between peptides originating from different samples, representing different cell states or other parameters, because of the difference between isotopically distinct reagents attached to the peptides. The ratios between the intensities of the differing weight components of these pairs or sets of peaks provide an accurate measure of the relative abundance of the peptides and the correlative proteins because the MS intensity response to a given peptide is independent of the isotopic composition of the reagents. The use of isotopically labelled internal standards is standard practice in quantitative mass spectrometry (De Leenheer et al., 1992 Mass Spectrom. Rev. 11:249-307).

Alteratively, differences in concentration of proteins and other biomolecular component types (e.g., lipids, nucleic acids, polysaccharides and the like) can be detected using a post synthetic isotope labelling method (see, e.g., U.S. Pat. App. Pub. 2003/0129769). In one example of this method a first chemical moiety is attached to a protein, peptide, or the cleavage products of a protein in a first sample and a second chemical moiety is attached to a protein, peptide, or the cleavage products of a protein in a second sample to yield first and second isotopically labelled proteins, peptides or protein cleavage products, respectively, that are chemically equivalent, yet isotopically distinct. The chemical moiety can be a single atom (e.g., oxygen) or a group of atoms (e.g., an acetyl group). The labelled proteins, peptides or peptide cleavage products are isotopically distinct because they contain different isotopic variants of the same chemical entity (e.g., a peptide in the first sample contains ¹H where the peptide in the second sample contains ²H; or a peptide in the first sample contains ¹²C where the peptide in the second sample contains ¹³C). At least a portion of each sample is typically mixed together to yield a combined sample, which is subjected to mass spectrometric analysis. Control and experimental samples are mixed after labelling, fractions containing the desired components are selected from the mixture, and concentration ratio is determined to identify analytes that have changed in concentration between the two samples. This isotope labelling method permits identification of up- and down-regulated proteins using affinity selection methods, 2-D gel electrophoresis, 1-D, 2-D or multi-dimensional chromatography, or any combination thereof, and employs either autoradiography or mass spectrometry. In particular, mass spectrometric analysis can be used to determine peak intensities and quantify isotope ratios in the combined sample to determine whether there has been a change in the concentration of a protein between two samples, and to facilitate identification of a protein from which a peptide fragment is derived. Desirably, the protein is identified by detection of a signature peptide that is unique to a single protein or protein class of a proteome or subproteome of interest (see, e.g., U.S. Pat. App. Pubs. 2003/0186326 and 2003/0129769).

Additionally, recent developments in the field of protein capture arrays permit the simultaneous detection and/or quantification of a large number of proteins. For example, low density protein arrays on filter membranes, such as the universal protein array system (Ge, 2000 Nucleic Acids Res. 28(2):e3) allow imaging of arrayed antigens using standard ELISA techniques and a scanning charge-coupled device (CCD) detector. Immuno-sensor arrays have also been developed that enable the simultaneous detection of clinical analytes. It is now possible using protein arrays, to profile protein expression in bodily fluids, such as in sera of healthy or diseased subjects, as well as in subjects pre- and post-drug treatment.

Protein capture arrays typically comprise a plurality of protein-capture agents each of which defines a spatially distinct feature of the array. The protein-capture agent can be any molecule or complex of molecules which has the ability to bind a protein and immobilise it to the site of the protein-capture agent on the array. The protein-capture agent may be a protein whose natural function in a cell is to specifically bind another protein, such as an antibody or a receptor. Alternatively, the protein-capture agent may instead be a partially or wholly synthetic or recombinant protein which specifically binds a protein. Alternatively, the protein-capture agent may be a protein which has been selected in vitro from a mutagenised, randomised, or completely random and synthetic library by its binding affinity to a specific protein or peptide target. The selection method used may optionally have been a display method such as ribosome display or phage display, as known in the art. Alternatively, the protein-capture agent obtained via in vitro selection may be a DNA or RNA aptamer which specifically binds a protein target (see, e.g., Potyrailo et al., 1998 Anal. Chem. 70:3419-3425; Cohen et al., 1998, Proc. Natl. Acad. Sci. USA 95:14272-14277; Fukuda, et al., 1997 Nucleic Acids Symp. Ser. 37:237-238; available from SomaLogic). For example, aptamers are selected from libraries of oligonucleotides by the Selex™ process and their interaction with protein can be enhanced by covalent attachment, through incorporation of brominated deoxyuridine and UV-activated crosslinking (photoaptamers). Aptamers have the advantages of ease of production by automated oligonucleotide synthesis and the stability and robustness of DNA; universal fluorescent protein stains can be used to detect binding. Alternatively, the in vitro selected protein-capture agent may be a polypeptide (e.g., an antigen) (see, e.g., Roberts and Szostak, 1997 Proc. Natl. Acad. Sci. USA, 94:12297-12302).

An alternative to an array of capture molecules is one made through ‘molecular imprinting’ technology, in which peptides (e.g., from the C-terminal regions of proteins) are used as templates to generate structurally complementary, sequence-specific cavities in a polymerisable matrix; the cavities can then specifically capture (denatured) proteins which have the appropriate primary amino acid sequence (e.g., available from ProteinPrint™ and Aspira Biosystems).

Exemplary protein capture arrays include antibody arrays, which can facilitate extensive parallel analysis of numerous proteins defining a proteome or subproteome. Antibody arrays have been shown to have the required properties of specificity and acceptable background, and some are available commercially (e.g., BD Biosciences, Clontech, BioRad and Sigma). Various methods for the preparation of antibody arrays have been reported (see, e.g., Lopez et al., 2003 J. Chromatogr. B 787:19-27; Cahill, 2000 Trends in Biotechnology 7:47-51; U.S. Pat. App. Pub. 2002/0055186; U.S. Pat. App. Pub. 2003/0003599; PCT publication WO 03/062444; PCT publication WO 03/077851; PCT publication WO 02/59601; PCT publication WO 02/39120; PCT publication WO 01/79849; PCT publication WO 99/39210). The antibodies of such arrays recognise at least a subset of proteins expressed by a cell or population of cells, illustrative examples of which include growth factor receptors, hormone receptors, neurotransmitter receptors, catecholamine receptors, amino acid derivative receptors, cytokine receptors, extracellular matrix receptors, antibodies, lectins, cytokines, serpins, proteases, kinases, phosphatases, ras-like GTPases, hydrolases, steroid hormone receptors, transcription factors, heat-shock transcription factors, DNA-binding proteins, zinc-finger proteins, leucine-zipper proteins, homeodomain proteins, intracellular signal transduction modulators and effectors, apoptosis-related factors, DNA synthesis factors, DNA repair factors, DNA recombination factors, cell-surface antigens, hepatitis C virus (HCV) proteases and HIV proteases.

Antibodies for protein arrays are made either by conventional immunisation (e.g., polyclonal sera and hybridomas), or as recombinant fragments, usually expressed in E. coli, after selection from phage display or ribosome display libraries (e.g., available from Cambridge Antibody Technology, BioInvent, Affitech and Biosite). Alternatively, ‘combibodies’ comprising non-covalent associations of VH and VL domains, can be produced in a matrix format created from combinations of diabody-producing bacterial clones (e.g., available from Domantis). Exemplary antibodies for use as protein-capture agents include monoclonal antibodies, polyclonal antibodies, Fv, Fab, Fab′ and F(ab′)₂ immunoglobulin fragments, synthetic stabilised Fv fragments, e.g., single chain Fv fragments (scFv), disulphide stabilised Fv fragments (dsFv), single variable region domains (dAbs) minibodies, combibodies and multivalent antibodies such as diabodies and multiscFv, single domains from camelids or engineered human equivalents.

Automated screening of antibody or scaffold libraries against arrays of target proteins is a rapid way of developing the thousands of reagents required for profiling proteomes or subproteomes. The term ‘scaffold’ refers to ligand-binding domains of proteins, which are engineered into multiple variants capable of binding diverse target molecules with antibody-like properties of specificity and affinity. The variants can be produced in a genetic library format and selected against individual targets by phage, bacterial or ribosome display. Such ligand-binding scaffolds or frameworks include ‘Affibodies’ based on Staphylococcus aureus protein A (e.g., available from Affibody), ‘Trinectins’ based on fibronectins (e.g., available from Phylos) and ‘Anticalins’ based on the lipocalin structure (e.g., available from Pieris). These can be used on capture arrays in a similar fashion to antibodies and may have advantages of robustness and ease of production.

Individual spatially distinct protein-capture agents are typically attached to a support surface, which is generally planar or contoured. Common physical supports include glass slides, silicon, microwells, nitrocellulose or PVDF membranes, and magnetic and other microbeads.

While microdrops of protein delivered onto planar surfaces are widely used, related alternative architectures include CD centrifugation devices based on developments in microfluidics (e.g., available from Gyros) and specialised chip designs, such as engineered microchannels in a plate (e.g., The Living Chip™, available from Biotrove) and tiny 3D posts on a silicon surface (e.g., available from Zyomyx).

Particles in suspension can also be used as the basis of arrays, providing they are coded for identification; systems include colour coding for microbeads (e.g., available from Luminex, Bio-Rad and Nanomics Biosystems) and semiconductor nanocrystals (e.g., QDots™, available from Quantum Dots), and barcoding for beads (UltraPlex™, available from Smartbeads) and multimetal microrods (Nanobarcodes™ particles, available from Surromed). Beads can also be assembled into planar arrays on semiconductor chips (e.g., available from LEAPS technology and BioArray Solutions). Where particles are used, individual protein-capture agents are typically attached to an individual particle to provide the spatial definition or separation of the array. The particles may then be assayed separately, but in parallel, in a compartmentalised way, for example in the wells of a microtitre plate or in separate test tubes.

In operation, a protein sample, which is optionally fragmented to form peptide fragments (see, e.g., U.S. Pat. App. Pub. 2002/0055186), is delivered to a protein-capture array under conditions suitable for protein or peptide binding, and the array is washed to remove unbound or nonspecifically bound components of the sample from the array. Next, the presence or amount of protein or peptide bound to each feature of the array is detected using a suitable detection system. The amount of protein bound to a feature of the array may be determined relative to the amount of a second protein bound to a second feature of the array. In certain embodiments, the amount of the second protein in the sample is already known or known to be invariant.

For analysing differential expression of proteins between two cells or cell populations, a protein sample of a first cell or population of cells is delivered to the array under conditions suitable for protein binding. In an analogous manner, a protein sample of a second cell or population of cells to a second array, is delivered to a second array which is identical to the first array. Both arrays are then washed to remove unbound or nonspecifically bound components of the sample from the arrays. In a final step, the amounts of protein remaining bound to the features of the first array are compared to the amounts of protein remaining bound to the corresponding features of the second array. To determine the differential protein expression pattern of the two cells or populations of cells, the amount of protein bound to individual features of the first array is subtracted from the amount of protein bound to the corresponding features of the second array.

In an illustrative example, fluorescence labelling can be used for detecting protein bound to the array. The same instrumentation as used for reading DNA microarrays is applicable to protein-capture arrays. For differential display, capture arrays (e.g. antibody arrays) can be probed with fluorescently labelled proteins from two different cell states, in which cell lysates are labelled with different fluorophores (e.g., Cy-3 and Cy-5) and mixed, such that the colour acts as a readout for changes in target abundance. Fluorescent readout sensitivity can be amplified 10-100 fold by tyramide signal amplification (TSA) (e.g., available from PerkinElmer Lifesciences). Planar waveguide technology (e.g., available from Zeptosens) enables ultrasensitive fluorescence detection, with the additional advantage of no washing procedures. High sensitivity can also be achieved with suspension beads and particles, using phycoerythrin as label (e.g., available from Luminex) or the properties of semiconductor nanocrystals (e.g., available from Quantum Dot). Fluorescence resonance energy transfer has been adapted to detect binding of unlabelled ligands, which may be useful on arrays (e.g., available from Affibody). Several alternative readouts have been developed, including adaptations of surface plasmon resonance (e.g., available from HTS Biosystems and Intrinsic Bioprobes), rolling circle DNA amplification (e.g., available from Molecular Staging), mass spectrometry (e.g., available from Sense Proteomic, Ciphergen, Intrinsic and Bioprobes), resonance light scattering (e.g., available from Genicon Sciences) and atomic force microscopy (e.g., available from BioForce Laboratories). A microfluidics system for automated sample incubation with arrays on glass slides and washing has been codeveloped by NextGen and Perkin Elmer Lifesciences.

Data analysis for functional protein expression is then conducted in a manner analogous to that discussed for gene expression analysis above. For each protein species, signal intensity measurements are first normalised to magnitude of 1 across the time profile. Data can also be normalised across protein species to a magnitude of 1 at each time point. Partitioning k-means clustering may be applied to the normalised data. Average profiles are calculated for the protein species within each cluster. The similarity of the proteomic clusters to the genomic expression clusters is then determined through association analysis based on a similarity measure, as for example the Pearson's correlation coefficient or Euclidean distance of the two profiles. Coordination of such data, as understood by a skilled artisan, would encompass any and all types of suitable comparisons or analyses to determine the differences, similarities, and/or relationships between gene expression and protein modification, resulting in a more complete understanding of the activities occurring within a cell or population of cells, or between two or more cells or populations of cells.

In certain embodiments, the techniques used for profiling a biomolecular system will include internal or external standards to permit quantitative or semi-quantitative determination of the corresponding molecular component types defining the biomolecular system or subset thereof in a subject, to thereby enable a valid comparison of subject data with predetermined data. Such standards can be determined by the skilled practitioner using standard protocols. In specific examples, the subject data includes absolute values for the abundance or functional activity of individual profiled molecular component types.

The subject data may optionally contain genotypic information including genetic information carried in the chromosomes and extrachromosomally. Such data may be obtained from genetic mapping, genetic screening, pedigree, family history and heritable physical and psychological characteristics.

In other embodiments, the phenotypic information includes the level or abundance of biomolecules such as but not limited to carbohydrates, lipids, steroids, co-factors, mimetics, prosthetic groups (such as haem), inorganic molecules, ions (such as Ca²⁺), inositides, hormones, growth factors, cytokines, chemokines, inflammatory agents, toxins, metabolites, pharmaceutical agents, plasma-borne nutrients (including glucose, amino acids, co-factors, mineral salts, proteins and lipids), amino acids, nucleic acids, foreign or pathological extracellular components, intracellular and extracellular pathogens (including bacteria, viruses, fungi and mycoplasma). Where appropriate, precursors, monomeric, oligomeric and polymeric forms, and breakdown products of the above are also included.

Conditions

It will be appreciated that the subject data collected may be relevant to a respective condition that is already diagnosed in the subject. However, advantageously the present invention can be utilised to detect previously undiagnosed conditions. In particular, this can be achieved by collecting sufficient parameter values and then comparing these to the predetermined data which is being collected for individuals having a range of conditions. This then allows conditions to be identified before symptoms are necessarily visible.

This can therefore be used in situations such as diagnosing conditions in animals. This is particularly advantageous as the animals are unable to provide information regarding any conditions from which they may be suffering. Thus, in the case of race horses for example, these animals can suffer from a number of conditions, such as overtraining, respiratory illness, or the like, which can be difficult to detect. In contrast to a human athlete, who can usually communicate any symptoms to a trained medical practitioner, horses are unable to communicate to vets and therefore can only be examined passively. Accordingly, the present invention allows a vet or other medical practitioner to perform an analysis of the subject and in particular their current biological condition and determine whether the subject is suffering from any conditions.

However, it will be appreciated that this invention is also useful for detecting and diagnosing conditions in humans, where the human may not be aware of the condition. This is particularly the case with high performance athletes where a minor condition may not be noticeable to the athlete directly, or where the athlete is unable to describe symptoms in sufficient clarity to a trainer or physician, but may have an impact on the athlete's performance.

The system is also useful for diagnosing conditions in situations where the athlete is trying to keep the condition secret, for example, in the case of drug testing to detect banned substances used by the athlete.

In order to be able to identify a significant number of conditions successfully, it is necessary to have a statistically adequate quantity of predetermined data. In particular, it is necessary to have predetermined data obtained from one or more individuals known to be suffering from a respective condition to allow the condition to be identified, and the sample size will therefore have to be sufficiently large to ensure this occurs. For example, if the chance of an individual from a general population having a specific condition is 1 in 100, it will be necessary to sample at least 100 individuals to ensure at least one individual having the condition is sampled. In fact, it would in this case be typical to sample at least 1000 individuals, to ensure that sufficient individuals having the condition are identified, to allow accurate condition determination

Furthermore, the more data available from individuals suffering from the condition the better, as this allows distinctions to be drawn between individuals suffering from different types of conditions.

The number of parameters required will depend on the number of conditions to be distinguished. In particular, it will depend on factors such as:

The presence and detection of unknown conditions;

The range of conditions to be identified within the population;

The levels of incidence of each condition in the population;

The ability to distinguish between the conditions.

It will be appreciated that as individuals, including performance animals such as race horses, can suffer from a wide variety of conditions, then it is preferable for a large number of parameters such as 3,000 to 5,000 to be used. However, this number can be significantly lower if only a minor number of conditions are to be identified. Thus for example, the number of parameters used may be anywhere from 10 up to 10,000, or more. Suitably, the number of parameters employed are at least about 20, preferably at least about 50, more preferably at least about 100, even more preferably at least about 150, even more preferably at least about 200, even more preferably at least about 300, even more preferably at least about 500, even more preferably at least about 1000, even more preferably at least about 1500, even more preferably at least about 2000, even more preferably at least about 4000, even more preferably at least about 6000, even more preferably at least about 8000, and still even more preferably at least about 10000.

In addition to this, the effect of a condition on an individual may also vary in accordance with additional phenotypic information relating to a particular characteristic or set of characteristics of the subject, as determined by interaction of the subject's genotype with the environment in which it exists. In this embodiment, such ‘characteristic data’ may be selected from age, sex, height, length, weight, ethnicity, race, breed of animal, feeding patterns, exercise patterns, medication supplied, nutritional or growth supplements supplied, nutritional analysis, hair colour, skin colour, eye colour, body composition, fat composition, water retention, obesity, transcriptomic profile, proteomic profile, metabolomic profile, pharmacometabolomic profile, gene allele profile, nucleotide polymorphism profile, karyotype profile, pharmacogenetic profiles, blood type, tissue type, endocrine function, immunological function including innate, cellular and humoral immune function, tolerance, allergy, transplant rejection, cancer, hyperplasia, gastrointestinal function, neurological function, kidney function, heart function, brain function, pancreatic function, bone function, joint function, sexual or reproductive function, metabolic load, toxicological profile, substance abuse including drug dependency, inborn errors of metabolism, infectious disease including viral infection, bacterial infection, mycobacterium infection, parasitic infection, prion function, prosthesis, tissue reconstruction, surgery, pain, mental function, psychiatric disorder, mood disorder and the like. The phenotypic information may also include demographic information, which can be important for monitoring the spread of a condition globally, as well as to allow analysis to take account of conditions that are limited to predetermined areas. Thus, it is generally preferable to additionally collect characteristic data together with the expression data for the individuals. Moreover, is it contemplated that blood molecules and blood cells serve as a particularly good surrogate marker for conditions existing throughout the body. Because blood, as a biological necessity, must be within a close proximity to every cell in the body, blood molecules are well suited to be used to detect conditions that may be present in one or more cells or tissues of the body. Also, blood molecules and cells continuously and rapidly interact with, monitor, and act to alleviate numerous conditions in the body and as part of this process, for example, differentially transcribe and express various mRNA molecules and undergo other phenotypic changes. Because of these properties blood cells are well suited for detecting conditions in the body as well as changes in conditions over time (from for example, year to year, month to month, day to day, hour to hour, minute to minute or second to second) and as well as detecting subtle changes in conditions, for example, changes that indicate the onset of a condition that has not yet risen to a level that is detectable by conventional diagnostic methods or subtle changes resulting from particular medication or relevant to determining the most effective medication at any particular time for a specific subject.

Moreover, the present invention is additionally well suited for veterinary purposes. For example, in animals, taking a tissue biopsy (which is a conventional diagnostic method in humans) is particularly arduous because it requires the anaesthetising of the animal and the stabilising of the animal after the procedure so that it may suitably heal. The ability of the present invention to detect conditions in a multitude of tissues without requiring a biopsy is thus advantageous.

It will be appreciated that in view of the amount of predetermined data involved, it is not generally feasible to compare subject data determined for any one subject to all the predetermined data. Accordingly, some pre-processing of the predetermined data is performed to determine signatures, or templates representing different conditions, in a process generally known as data mining. In this case, the individual data can be compared to the diagnostic signatures, allowing a determination of any conditions of the individual.

It will be appreciated that in order to determine the diagnostic signatures, it is necessary to have data regarding individuals suffering from conditions. In one example, this is performed in two stages including:

An initial discovery process; and,

Subsequent diagnostic signature re-evaluation based on collected data.

During the initial discovery process, data is collected regarding individuals having predetermined conditions allowing initial diagnostic signatures to be determined for each condition under consideration. This is generally performed under controlled conditions, such as clinical trials or the like.

Once preliminary diagnostic signatures have been determined, individual data can be compared to the diagnostic signatures to diagnose conditions suffered by a individual. This individual data can then be added to the data collected during the clinical trials, allowing the data to be re-mined, thereby allowing the diagnostic signatures to be revised to take the additional data into account.

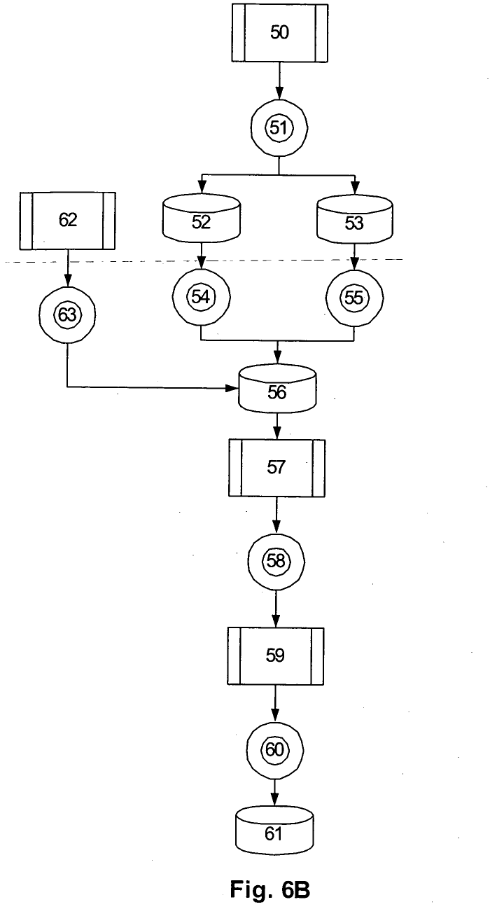

An example of the generation of diagnostic signatures in a discovery phase will now be described with reference to FIGS. 6A and 6B, which show a flow chart and data flow respectively.

In particular, at 300 the operators of the base station 1 operate to collect the predetermined data, shown at 50 including, for example, genotypic and phenotypic information, from a number of individuals.

In this example, it will be assumed that the parameter values that form the predetermined data correspond to expression data and in particular, concentration quantities, abundances, or ratios of respective expression products obtained from an array or the like. The phenotypic information will typically be provided from a study of the respective individual, and is preferably provided in a standard format to allow the information to be correctly interpreted by the base station 1.

The data is collected during clinical trials, by monitoring selected individuals, or any other suitable process, as will be appreciated by persons skilled in the art. Thus, in the case of individuals being horses or the like, it is typical to perform clinical trials to induce conditions within the horses to allow these to be monitored under control conditions. In particular, by inducing conditions within sample individuals, it is possible to monitor the effect of different stages of the condition on the gene expression data which is collected. This, allows diagnostic signatures to be derived for different stages of conditions, as will be described below. Furthermore, this also allows gene expression and other phenotypic information to be collected for sub-clinical diseases, and the like.

At 310, initial quality control 51 is performed on the collected data to ensure it is suitable for use in determining diagnostic signatures. In particular, in order for the data to be useful, it is necessary that all the data is complete, and of the required quality. This is therefore an initial high level review and typically does not involve a detailed examination of the data. For example, this could be used to ensure that required information regarding the clinical trial is not omitted.

An initial high level review of gene expression data on an array includes an assessment of the overall brightness of the array, any inconsistencies in brightness, dust, scratches or other visible artefacts. For example, an array specifically designed to genes found in white blood cells when used against white blood cell samples will produce a typical result than can be assessed using the naked eye. An inconsistencies in the way the array looks may result in the data being excluded. Initial assessment of the quality of clinical data can be performed by a person unskilled in the art of veterinary or medical science. For example, it could include checking consistency of results with previous samples, completeness and values falling within physiological possibilities.

If the phenotypic and genotypic data passes the initial quality control test outlined above, the data are stored in respective phenotypic and genotypic databases 52, 53, at 320. In order to do this, a data model will typically be established to provide structure to the relationship of each individual to its respective genotypic and phenotypic information. It will be appreciated that the nature of the model is not important for the purposes of the general techniques of the invention, although selection of a suitable model can aid with the quality control review outlined above. In particular, the model can include required fields, corresponding to essential information, and if these fields are not populated when the data is propagated into the respective database, then this indicates that the data is deficient.

After this has been performed, at 340, a separate more detailed quality control check is performed separately on the phenotypic and genotypic data at 54, 55, to ensure that the data is of a suitable integrity for performing subsequent analysis.

Thus, for example, at 54, the phenotypic information is reviewed to ensure that required information is provided in the correct form, and in particular demonstrates clinical integrity. In general the requirements for this information will be predetermined before the study is commenced, and it will therefore be necessary to check whether the resulting information is provided correctly and with a sufficient degree of integrity to allow it to be used in the derivation of a diagnostic signature.

In particular, one vital piece of information required at this stage is a definitive diagnosis of any conditions suffered by the individual. Thus, for example, if the individual is a horse having induced gastritis, then an indication of this and the elapsed time period from inducement will be required.

In general, the review of the phenotypic data will need to be performed by a skilled individual, and cannot be automated, although it is possible that heuristic based review procedures could be implemented to perform some or all of the quality control review once sufficient knowledge has been derived through review of sufficient samples by the skilled individual. In any event, in the case of horses, or other performance animals, the skilled individual is usually a qualified veterinarian or medical practitioner who is able to assess the likelihood of the phenotypic information being correct.

In addition to this, the phenotypic and/or genotypic data is reviewed separately at 55, and again this usually requires manual review by a skilled technician. In this case, the form of the quality control review will depend on the nature of the data and the manner in which this is collected. Thus, for example, if the phenotypic data is collected using an array, then the review will generally include examining the array chip to ensure that it the assay has been performed correctly. This quality control is generally performed on a chip by chip basis to ensure that each chip demonstrates absolute data integrity, and hence the resulting data do not include any faults.

This process generally uses a combination of standard checks, such as ensuring control genes have been correctly expressed, and any other developed tests, which may be specific to the respective clinical trial.

Quality criteria at this stage are more rigorous and detailed. For example, gene expression data should be checked by looking at individual components on the array, such as positive and negative control elements, gene expression values of known consistency, spike-in controls, overall distribution of expression values, and % genes present call. It will be understood by those skilled in the art that different arrays will have their own inherent quality metrics that are developed over time with use. It is these quality metrics that should be applied at this stage.

It will be appreciated that these quality control checks are important, as if not performed correctly, then inaccurate data may be used in the data mining. This will lead to the development of inaccurate signatures, which in turn may lead to misclassification of subsequently tested individuals. For this reason, human based quality control testing is used initially. However, as improved automated techniques for quality control are developed, portions of this may be automated.

If the data passes the respective quality control tests 54, 55, the data is published to a biowarehouse database 56, at 350, allowing it to be used in subsequent data mining.

When data mining is to be performed to derive a diagnostic signature, a group of individuals are selected at 360, and as shown at 57.

The individuals are selected on the basis of the purpose of the diagnostic signature. Thus, for example, if the query is to be used to determine signatures for the condition of gastritis, then it will be typical to use mine data of individuals having gastritis, and selected individuals not having gastritis. It is not possible however to use individuals for whom the presence or absence of gastritis is unknown. Similarly, it may be desirable to determine a signature for male horses with gastritis, in which case, female horses should be excluded from the query used to mine the database.

Thus, it will be appreciated that it is necessary for a skilled person to select a group of individuals that may be used to determine a diagnostic signature for a respective condition. This is generally achieved by selecting a respective clinical condition for study, and then querying the database to select individuals for which a definitive diagnosis of the presence or absence of the condition is confirmed.

It will be appreciated from this that in the early stages, group of individuals will typically correspond to groups of individuals used in respective clinical trials. However, as additional trials are held, it is also possible to select individuals from different trials, if appropriate phenotypic and genotypic information is available.

At 370, additional quality control 58 is performed to determine if the genotypic data for the individuals can be used in comparative analysis. For example, there may be differences in the relative gene expression profiles arising from the use of different arrays, or different tests in the determination of this information. Accordingly, this is usually accounted for by normalising the phenotypic data for the individuals within the group. Phenotypic data for groups to be compared can be statistically analysed to determine “outlier” data that may need to be excluded from the comparison. Such statistical analyses include Box and Whisker and Kernel Density plots. It will be appreciated that if the phenotypic data for any individual fails the quality control test, then the individual will be excluded from the subsequent determination of the diagnostic signature.

In any event, any individuals that are unsuitable for use in the respective data mining query are excluded from the subsequent analysis. It will be appreciated that in order to be useful in subsequent data mining, the group will require a minimum number of individuals, which is typically eight or more, in order to allow the data mining to be statistically significant.

Following this, a data mining procedure is performed to allow one or more diagnostic signatures to be determined at 59. The manner in which the data mining is performed will depend on the respective implementation, as well as other factors, such as the number of members in the group.

In general, the system operates by forming parameter vectors for each individual in the group. Each parameter vector is generally formed from a vector containing gene expression values for different genes at respective locations within the parameter vector. These values are referred to as parameter values. In any event, the processing system 10 can then operates to consider the relative position of the parameter vectors in an N-dimensional space, where N corresponds to the number of parameters, allowing diagnostic signatures to be derived. A number of options for performing this process are described in more detail below.

Thus, the processing system 10 operates (at 370) to produce diagnostic signatures that may be used to characterise the groups of individuals identified above. It will be appreciated that there is a multiplicity of ways of defining such diagnostic signatures for example, regularised discriminant analysis, Support Vector Machines, recursive partitioning, artificial neural networks, or the like, as will be described in more detail below with respect to data mining.

Having identified one or more signatures, a further quality control step 60 is performed at 380 to characterise the ability of the diagnostic signatures to predict group membership, by applying the signatures to suitable individuals, such as the individuals in the group, or other individuals known to have a definitive clinical diagnosis. This is performed to ensure that the signature allows correct characterisation and validation to be achieved. This may be performed for example by using k fold cross-validation, and the construction of permutation_ distributions.

Once the signatures have been generated, these are then stored in a signature database 61 at 390, together with any other summary statistics necessary to provide statistically efficient prediction using the signature.

It will be appreciated that signature may be defined for respective conditions irrespective of the phenotypic traits of the individuals. Thus, for example, if all individuals suffering from a condition tend to have similar parameter values, then all the individuals having the condition will be contained in the same group irrespective of each individual's phenotypic traits.

However, if different phenotypic types have distinct parameter values for the same condition, then a respective signature will be defined for each phenotypic group. Thus for example, a signature may be defined for male horses having a respiratory condition, with a separate signature being defined for female horses having the same respiratory condition.

In addition to this, at least one signature will be defined corresponding to healthy individuals not having any conditions. It will be appreciated that this can be used in determining if an individual has an unidentified condition, as will be described in more detail below. This can also be used to identify sub-clinical diseases, a predisposition for developing a condition or conditions that are not previously apparent through existing diagnostic techniques.

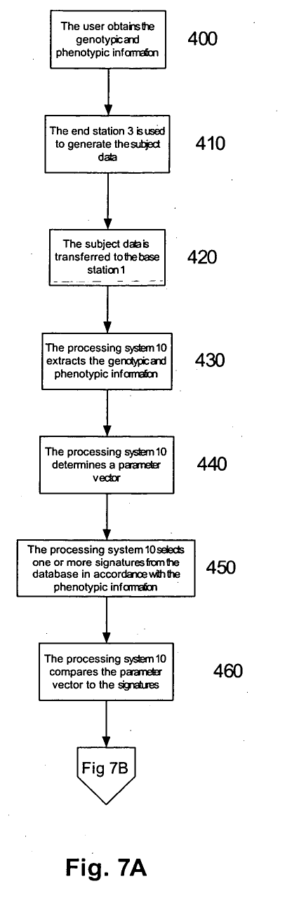

Once the signatures have been generated, it is then possible to operate to compare the subject data to the predetermined data. The manner in which the comparison is performed will now be described with reference to the flow chart shown in FIGS. 7A and 7B.

In particular, at 400, the user determines gene expression data in the form of parameter values, and other phenotypic information relating to the subject. At 410, the end station 3 is used to generate subject data in accordance with the determined parameter values and phenotypic information. At 420 the user transfers the subject data to the processing system 10 as described above.

At 430, the processing system 10 extracts the parameter values and the phenotypic data from the subject data, and in this example uses the parameter values to generate a parameter vector at 440.

The processing system obtains one or-more of the signatures from the database at 450. At this point, it will be appreciated that the signatures may be selected in accordance with the phenotypic information, such that the subject parameter vector is only compared to signatures having suitable phenotypic traits. Thus, for example, it will be appreciated that if the subject is a male horse, then it may be pointless comparing the subject parameter vector to a signature representing a group of female horses having a respiratory disease.

However, if a signature corresponds to a group of individuals having a range of phenotypic traits, then this signature will be used to predict group membership using the subject parameter vector, at 460. It will be appreciated that there is a multiplicity of ways of predicting group membership from the subject parameter vector, just as there is a multiplicity of ways of constructing group signatures, as will be appreciated by persons skilled in the art.

At 470 the processing system 10 operates to determine the uncertainties in group prediction using the subject parameter vector and signatures in the N-dimensional vector space. These uncertainties are expressed as probabilities that the test subject has a condition previously characterised by membership of one of the groups in the predetermined data.

It is apparent to those skilled in the art that there is a multiplicity of ways of constructing these uncertainties, each appropriate for a different method of signature construction and group prediction. For example, uncertainties may be based on some measure of distance between the subject parameter vector and a group signature, or by a Bayes rule applied to a set of discriminant functions.

It will be appreciated therefore that the signatures may be based on specific values such that they represent a single point in the N-dimension vector space. Alternatively however the signatures may correspond to ranges such that each signature defines a range of parameter values for which the subject would have the respective condition. Thus, this effectively defines decision boundaries in the N-dimensional space, such that if the subject parameter vector falls within the decision boundary, this indicates that the subject has the respective condition.

If the parameter vector is approximately equidistant to two or more signatures, this may indicate that there is a chance that the individual either has a previously undetermined condition, or alternatively is suffering for example, from a combination of the two conditions. It will be appreciated that signatures may be generated for common combinations of conditions, as well as single conditions.

Finally, it will be appreciated that the presence of the signature for healthy individuals allows a healthy subject to be determined. If the subject parameter vector is significantly separated from this signature, this will indicate that the subject is generally unhealthy, and this allows previously unidentified conditions to be determined, for example, if the subject parameter vector is not near any of the other signatures.

It will also be appreciated that the magnitude of the parameter values will allow the severity of conditions to be determined. Thus, for example, the greater a difference in magnitude between the parameter values for a healthy subject compared to a subject suffering from a condition will generally indicate a greater severity of the respective condition.

Similarly, it will be appreciated that groups may be defined for different severity of condition. Thus, for example, a first group may be defined for the initial stages of a condition that is treatable, whilst a second group is defined for the same condition when it has progressed beyond the initial stages and is no longer treatable.

Finally, a direct comparison of the subject parameter values can be made with the predetermined data for other individuals suffering from the same condition, can also be used to allow the severity of the conditions to be determined.

In any event, at 480, the processing system 10 interprets the separation of the parameter vector from the signatures and uses this to determine any conditions displayed by the subject. An indication of this is then transferred to the end station 3 at 490.

It will be appreciated that the received subject data represents an additional source of data which may be used in re-tuning the diagnostic signatures. In particular, a large quantity of data is received from external sources, and this allows the size of the groups used in determining the signatures to be increased, allowing a statistically more significant signature to be determined.

In order to perform this however, the received subject data represented at 62 must be reviewed for quality control purposes at 63, as set out in 500, before being published to the biowarehouse at 56, as set out in 510.

In particular, it is necessary to ensure that the subject data satisfies all the quality control requirements that were outlined above, and especially that the genotypic data is of good quality, and that a definitive diagnosis of conditions suffered by the horse have been determined. This latter requirement is important as if the diagnosis is mis-classified, then this will in turn lead to the introduction of errors in the determined diagnostic signatures.

It will be appreciated that the process outlined above with respect to FIGS. 7A and 7B will allow a diagnosis of the conditions to be determined. However, this in itself is insufficient to allow the subject data to be subsequently incorporated into the biowarehouse database, as a misclassification, which may occur for example in the case of a new condition not previously considered, will be propagated through to the revised signatures if the subject data is incorporated into the biowarehouse without first undergoing clinical confirmation.

Accordingly, it is typical for clinical confirmation of the diagnosis to be sought if the subject data is to pass the quality control stage at 500.

A number of alternatives can be implemented in the present invention.

Multiple Firewalls

In particular, in the above described example it will be appreciated that users of the end stations 3 are unable to access any of the data stored in the database 11. This is performed to ensure that the data can be retained as confidential by the operator of the base station 1.

This in turn allows the operator of the base station 1 to continue to provide indications of subject status without running the risk of users of the system obtaining the raw data stored in the database 11 and using this for their own purpose. This ensures that the operators business of providing an indication of the status for a fee is protected.

However, it will be appreciated that the security provided by the above system is in some extent limited. In particular, there is the opportunity that hacking, i.e., unauthorised access, may occur in which users of the end stations 3 attempt to infiltrate the processing system 10 and cause the processing system 10 to download data, such as the templates, from the database 11.

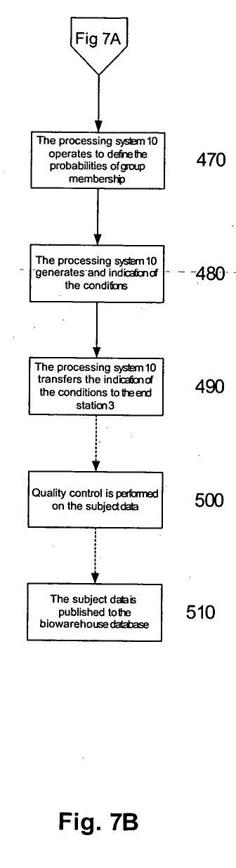

In order to overcome this, the base station 1 can implement a dual processing system set up as shown for example, in FIG. 8 In this example, the base station 1 includes a processing system 12 coupled to the LANs 4 and the Internet 2 via a first firewall 13, and a second database 14 coupled to the first processing system 12 via a second firewall 15.

In this example, the processing systems 12, 14 will be substantially similar to the processing system 10 described above, and will not therefore be described in further detail.

In use, communication with the end stations 3, including the receipt of the subject data, and provision of results, is achieved using the processing system 12. In the case of receiving of subject data, or any other requests, the received submission is analysed by the processing system 12, and any relevant information extracted. The extracted information, which is determined by the processing system 12 to be a genuine submission, can then be transferred to the processing system 14.

Thus, the processing system 12 can receive the subject data, and operate to extract the parameter values therefrom. The processing system 12 then generates the parameter vector, or the like, which is transferred to the processing system 14 for subsequent comparison with the predetermined data.

Once the comparison has been performed, the processing system 14 can determine those conditions suffered by the subject and then transfer an indication of this back to the processing system 12 through the firewall 15. The processing system 12 can then transfer an indication of this indication to the end station 3.

It will be appreciated that in this example, even assuming the user is able to infiltrate the first firewall 13, the user will only be able to access previously submitted requests and the results determined therefrom. The presence of the dual firewall system therefore makes it virtually impossible for the user to infiltrate the processing system 14 and obtain access to the data stored in the database 11.

In the remainder of the description, it will be appreciated that the processing systems 10; 12, 14 are effectively interchangeable.

Parameter Ranges

A further alternative to the present invention is for the comparison to be performed on the basis of parameter ranges defined for different conditions.

Thus for example, each condition may have associated therewith a sequence of parameter value ranges determined based on ranges of parameter values for individuals diagnosed with the respective condition. The parameter value ranges can then indicate for a respective condition the parameter values that can be expected, allowing the determined parameter values to be compared to the respective range for each condition to determine if the parameter values provided fall within a respective range.

Thus, a respective parameter range can be determined for each condition, with the parameter values determined for a subject being compared to each range, to determine those ranges within which the subject data falls.

An indication of the likelihood of the subject having a respective condition can then be determined statistically based on the number of individuals having the respective condition.

Multi-Level Analysis

In the example described above, a number of conditions have been defined for the respective type of individual. However, it will be appreciated that sometimes it is desirable to perform tests to focus on specific conditions. Thus for example, in the case in which a horse has an existing condition, it is sometimes desirable to monitor the development of the condition for the respective subject.

In this case, as the condition has been determined, it will not usually be necessary to consider all of the parameter values each time the analysis is performed. In particular, as a large number of parameters are provided to allow the different conditions to be distinguished, a large number of parameters will typically not be representative of the progress of a specific condition.

Thus, it is usually possible to identify a number of key parameters that are relevant to respective conditions. Thus for example, conditions relating to respective respiratory illnesses may be uniquely identified using a smaller number such as 50 parameters. In this instance, if the user is only interested in examining for the progress of this respective condition, the user can simply supply an indication of the values for the respective 50 parameters.

In this example, the processing system 10 would operate to compare the determined parameter values against parameter values of horses suffering from the condition and horses not suffering from the condition. In this situation, the manner in which the collection of the parameter values is performed may very.

In the examples described above it has been mentioned that the parameter values may include for example, expression data collected using an array, for example. If the arrays are to collect values corresponding to 5000 parameters it is typical for an array to be provided with 5000 features thereon with each feature corresponding to a respective parameter. Alternatively, 10,000 features may be provided with two features corresponding to each parameter. In any event, a person skilled in the art will appreciate that a number of variations on this are possible.

However, if only 50 parameters are to be measured, it is then possible to provide an array having 5,000 features with 100 features being used to determine the value for each parameter. This allows the parameter values to be determined far more accurately allowing a more accurate representation of the condition to be determined. In particular, more accurate comparison of the subject data with the predetermined data can be performed.

Thus, a typical sequence of events may be for a user to submit a general test having a large number of parameters similar to that described above which allows respective conditions to be first identified. Once a condition has been identified, the user can then purchase specifically designed array plates adapted to monitor the specific condition. Measurements of the parameter values relevant to the condition can then be made far more accurately allowing the progress of the condition to be monitored in detail. This can allow users to be provided with information concerning whether conditions are improving or not.

Longitudinal Analysis

In the methods described above, the subject data for a respective subject is compared to predetermined data for a number of different individuals. However, in addition to, or alternatively to this, longitudinal analysis can also be performed. In this instance, the subject data is compared to subject data previously collected for the same subject. Thus, this allows the progression of a condition within a subject to be monitored.

Again, it will be appreciated that if this is performed with a limited number of parameters as described in the multi-level analysis described above, then this allows an accurate assessment of the progression of a condition to be made.

By storing the results determined for a respective subject in the database 11, for a predetermined time period, this can allow the progression of the disease over a time period to be monitored and displayed to the user. Thus, the most recently obtained subject data is compared to earlier subject data for the same subject (and optionally predetermined ata), to determine disease progression.

Thus, for example, levels of respective parameter values can be used to indicate the severity of the disease. This can be achieved by comparing the subject data to predetermined data in the manner described above, or alternatively using other techniques. As the parameter values vary over time, this can be used to provide an indication of whether the condition is improving or worsening. This is turn can be used to monitor the effectiveness of any treatment given to the subject.

Thus for example, if it is determined that a horse has been overtrained then the obvious solution to this problem is to reduce training for a predetermined time period, or resting the horse. However, trainers will generally not want to reduce the training too much as the horse will become unfit. Similarly, worse problems can arise if the trainer resumes training too early.

Thus, in this case, the trainer can submit subject data on a periodic basis such as every week allowing the fitness of the horse to be determined on a weekly basis. An indication of this can then be transferred back to the user allowing the trainer to determine when training of the horse should resume, or how hard training should be.

This therefore allows the severity of the condition within the subject to be monitored.

Secure Arrays

It will be appreciated that array technology can be used with the present invention. Gene arrays (also called GeneChip® arrays) are perhaps the most common array technology in the art but the present invention also contemplates the use of protein-capture arrays and arrays capable of detecting other biological material such as carbohydrates, lipids, steroids, amino acids or a combination of the foregoing, as discussed above

In the example of collecting subject data for horses, a horse array and a blood sample are needed. The array has DNA dotted onto its surface (DNA of the genes in horse blood cells). The DNA on the array consists of one strand of the double-stranded DNA molecule—the other strand is provided by the blood sample and is labelled with a dye.

Two strands of similar DNA will only bind to each another (hybridise) if they match in sequence. An array reader can determine the amount of mRNA in a sample (gene turned “on” or “off”) by determining the amount of dyelabelled DNA that hybridises to an array.

The reader produces a value compared to a reference for every single gene on the array. The 5,000 to 10,000 values can then be compared to the inventors' database (also referred to herein as the “Genetraks database”. Genes turned “on” or “off”, individually or in patterns, can then be identified and correlated to the specific conditions of a racehorse.

Various conditions in racehorses will alter the metabolism of the white blood cells, which can then be detected using the genechip technology. For example, the gene for manganese superoxide dismutase (MnSOD) may be turned “off” in respiratory inflammation. Similarly, IFNg, IL-4 may also be turned “off”, and the genes for Grola, IL-8, TNF and MIF may be turned “on”. This pattern of “gene expression” can be correlated to a specific condition, such as respiratory inflammation caused by a virus. Patterns of gene expression change as a horse succumbs to or recovers from a viral infection. As the technology and database develops, predictions on the stage of infection or influence of treatments can be made.

As described above, it is preferable to ensure that the predetermined data is retained as confidential.

However, if arrays are used in the collection of data, it will be appreciated that it would be possible to purchase a quantity of arrays and perform data mining of data obtained from used arrays to determine new predetermined data. Thus, there is a danger that competing companies will use the arrays provided on behalf of the operator for their own purposes.

In order to be able to do this, it will be necessary for the competing entities to be able to interpret the data provided by the arrays. However, this can be overcome by utilising secure arrays. In particular, secure arrays utilise a randomisation of the layout of the array to avoid the problems of reverse engineering or the like.

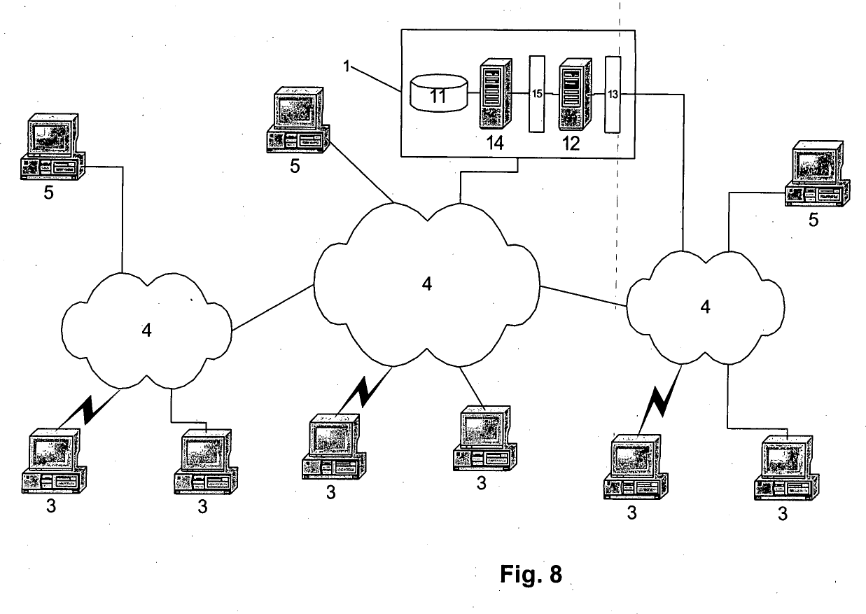

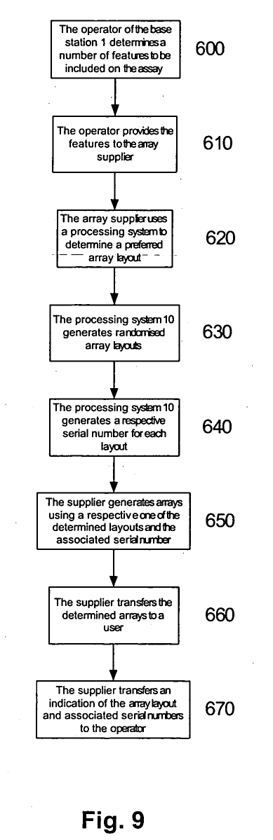

The manner in which this may be achieved according to embodiments of this invention will now be described with reference to FIGS. 9 and 10.

In particular, at 600, the operators of the base station 1 will determine a number of features to be included on the array, and provide an indication of these features to the array supplier (at 610).

At 620, the array supplier will operate to generate a preferred array layout using a processing system. This is performed in accordance with normal operating procedures. In particular, the array suppliers will generally utilise applications software to determine a preferred array layout which optimises the array build process. The layout is generally organised so that creation of the array is simplified.

At 630, the array supplier will operate to generate a number of randomised array layouts. The randomised array layouts have one or more of the features positioned in an alternative location when compared to the preferred array layout. In particular, the array supplier will generally operate to move or swap the locations of one or more of the features on the array. In order to swap features, it must be ensured that the features are of different types.

At step 640 the array supplier will also operate to generate a corresponding number of codes. For example, the code can be defined by one or more detectable and/or quantifiable attributes such as alphanumeric characters, the shape, or surface deformation(s) of the array, bar codes or an electromagnetic radiation-related attribute including atomic or molecular fluorescence emission, luminescence, phosphorescence, infra-red radiation, electromagnetic scattering including light and X-ray scattering, light transmittance, light absorbance and electrical impedance. In this example, serial numbers are used and in particular, a respective serial number is provided for each randomised array layout that is generated.

At 650 the array supplier will operate to generate arrays in accordance with the randomised array layouts and the serial numbers. In particular, each generated array will have features positioned thereon in accordance with a respective one of the randomised layouts, together with an indication of the corresponding serial number.

It is typical for the array supplier to produce the arrays in batches with up to 1,000 arrays in each batch, with each batch being created in accordance with a difference randomised layout.

At 660 the randomised arrays are transferred to the users for subsequent use in generating the subject data, whilst at 570 the serial numbers, together with corresponding layouts are transferred to the base station 1.

The use of randomised arrays will slightly complicate the production process but will vastly increase the security of the arrays. In particular, third parties will be unable to utilise the arrays, as the location of features alter, which will cause the third parties to obtain varying results on different arrays, for the same sample.

Operation of the system to use the randomised arrays will now be described with reference to FIG. 10. In particular, at 700 the user will obtain a biological sample from the subject and then perform an assay process using the array (at 710).

Illustrative examples of biological samples include tissue cultured cells, e.g., primary cultures, explants, and transformed cells; cellular extracts, e.g., from cultured cells or tissue, whole cell extracts, cytoplasmic extracts, nuclear extracts; blood, etc. Biological samples also include sections of tissues such as biopsy and autopsy samples, and frozen sections taken for histological purposes. In some embodiments, the biological sample is selected from tissue samples (e.g., organ biopsy), cellular samples (e.g., cardiac cells, muscle cells, epithelial cells, endothelial cells, kidney cells, prostate cells, blood cells, lung cells, brain cells, adipose cells, tumour cells, pancreatic cells, ocular cells, mammary cells etc) and fluid samples (e.g., urine, sweat, saliva, mucus secretion, respiratory fluid, synovial fluid, plueral fluid, pericardial fluid, faeces, nasal fluid, ocular fluid, intracellular fluid, intercellular fluid or a circulatory fluid such as whole blood, serum, plasma, lymph, cerebrospinal fluid, or combinations of any of these, or fractions thereof) obtained from the subject. In advantageous embodiments described herein, the biological sample comprises blood or fraction thereof (e.g., blood cells such as mature, immature and developing leukocytes, lymphocytes, polymorphonuclear leukocytes, neutrophils, monocytes, reticulocytes, basophils, coelomocytes, haemocytes, eosinophils, megakaryocytes, macrophages, dendritic cells natural killer cells, especially white blood cells including peripheral blood mononuclear cells).

By “obtainedfrom” is meant that a sample such as, for example, a nucleic acid extract or protein extract is isolated from, or derived from, a particular source. For example, the extract may be isolated directly from a tissue or a biological fluid acquired from a subject.

At 720 the user uses the end station 3 to encode the values obtained from the array as subject data, together with a serial number indication. The subject data is then transferred to the base station 1, in the manner described above, at 730.

The processing system 10 operates to determine the serial number from the subject data at 740. The serial number is then used to access the respective array layout stored in the database 11 at 750.

The array layout will then be used by the processing system to interpret the subject data, and in particular, to determine the respective feature to which each value corresponds. This allows the processing system 10 to hence determine the parameter values for the respective subject data.

Operation of the invention will then be substantially as previously described above.

It will be appreciated that the serial number may also be used to check the user is an authorised user. In particular, if each user is provided with arrays having a respective serial number (a range of serial numbers), then having the array supplier provide an indication of the user and the serial number(s) to the operator, this allows the operator to verify the identity of the user. This provides an audit trail for the arrays.

Feedback

A further way in which the present invention may be utilised is to provide feedback on the accuracy of provided results.

In particular, if the base station 1 is used to provide an indication of one or suspected conditions in a subject, the user can be requested to provide an indication whether the diagnosis provided by the base station 1 is correct. This may form a requirement, such that a user will only be provided with services by the base station if they agree to this term.

In any event, the correctness of the assessment by the base station 1 can usually be determined by either treating the subject and determining if the treatment is successful, or by monitoring the development of the condition over a predetermined time period. Once it has been determined that the diagnosis is correct or incorrect, an indication of this can be transferred to the base station 1.

At this point, the respective subject data collected for the respective subject can be saved as predetermined data in the database 11, with the confirmation of the condition being used as the indication of the condition in the predetermined data.

In order to achieve this, the processing system 10 is typically coupled to a sample database that is used to store the subject data obtained from each subject. Once confirmation of the conditions is received the subject data and the condition indication is transferred to the predetermined data stored in the database 11.

It will be appreciated that this checking of the conditions is not essential to the present invention as typically the data alone will be useful. However, checking of the condition will be useful in determining the accuracy of the signatures.

It will be appreciated that as further data is collected over through the feedback technique or through the use of alternative data collection methods the signatures or other data can be updated allowing more accurate condition analysis to be performed.

Users

It will be appreciated that any individual may use the system. Initially at least however, it is necessary for the user to be able to generate the subject data. In the case in which arrays are used, for example, this requires the user to first collect biological material, such as blood, and then analyse the material using the array. This is generally difficult and requires skilled operators using existing technology. Accordingly, the user may have to be a skilled technician. However, it is envisaged that collection techniques will become simpler, allowing the process to be implemented by any user.

In the case of sporting or racing events, for example, the users could include, without limitation:

Athletes;

Trainers;

Drug testing committees (such as Olympic Officials);

Medical practitioners (such as veterinarians or doctors);

Event organisers;

Pathology labs (that would typically perform the work on behalf of an individual, such as a horse owner).

Reports

In general, the indication of any conditions suffered by the user, together with information concerning the ability of the subject to compete in events, or the like, is provided in the form of a report.

It will be appreciated by those skilled in the art, that the content of the report may need to be tailored depending on the type of user. Thus, for example, a trainer will not be interested in knowing about parameter values for their horse, but will rather want to know what conditions the horse has, and the severity. In contrast, if the user is a skilled medical practitioner, then there may be some benefit in having more detailed information provided thereon.

Accordingly, the processing system 10 can be adapted to generate tailored reports in accordance with report templates stored in the database 11, or the memory 21. In this case, the processing system 10 will determine the type of user, and then access a respective report template. The report template will specify the type of information to be provided to the user, allowing the processing system 10 to populate the report in accordance with the results of the above described analysis.

Thus, for example, in the case of the user being a trainer, the processing system 10 can access a user report template, which will include a number of fields. The processing system will determine from the field the information required, and populate the fields accordingly. This may require some additional processing to place the information in the required form. The information will also be directed to a level the user can understand, and will therefore typically avoid the use of technical terms (such as medical terms) for nontechnical users.

Thus, the processing system may be adapted to determine the condition and severity. This is then used to access a look-up table, which indicates how serious the condition is to the subject. Thus, the LUT may indicate that the condition is serious and medical condition should be obtained. In this case, the report may therefore indicate merely that the subject has a condition and medical attention should be obtained. It will be realised that the advice may depend on phenotypic data. Thus, a young horse may be more or less likely to require medical treatment for a given condition that an older horse.

For skilled medical practitioners however, more detail may be required, in which case, the processing system may be adapted to indicate not only the condition and severity, but also provide an indication of various important parameter values (such as red or white blood cell counts), to allow the medical practitioner to determine what action to take.

It will be appreciated that the information displayed may depend not only on the user, but also the respective condition. Furthermore, the information could be displayed graphically or as numerical or textual information.

In general the rules for the determination of the level of severity of the condition or the like must be established to allow the LUT to be produced. This is generally achieved through a heuristic rules based approach, which is achieved by having the report generation initially performed by an expert, such as a veterinarian, or the like. As the reports are completed, the knowledge gained during this procedure is captured and stored in the LUT, thereby allowing the subsequent reporting to be performed in an automated manner.

As the completion of the report template is automated, it will be appreciated that users may be allowed to submit their own report templates, in accordance with predetermined criteria, allowing the user to have reports generated in their desired format.

Finally, the processing system 10 can be adapted to provide other advice. This can include for example, recommendations for changes in feeding habits, or the like. In general medical advice would not be given due to the issue of liability. However, it will be appreciated that the operator of the base station 1 could provide a medically trained individual to provide medical advice if required.

The reports may also be generated utilising other systems. An example of an alternative system is the Pacific Knowledge Systems “Labwizard” LIS Interpretive Report Toolkit, which utilises RippleDown technology to provide knowledge capture and subsequent automated report generation.

Architecture

A range of different architectures may be implemented in addition to those described above. Whilst these will not be described in detail, it will be appreciated that any form of architecture suitable for implementing the invention may be used. However, one beneficial technique is the use of distributed architectures. In particular, a number of base stations I may be provided at respective geographical locations. This can increase the efficiency of the system by reducing data bandwidth costs and requirements, as well as ensuring that if one base station becomes congested or a fault occurs, other base stations 1 could take over. This also allows load sharing or the like, to ensure access to the system is available at all times.

In this case, it would be necessary to ensure that each database 11 contains the same information and signatures such that the use of different ones of the base stations 1 would be transparent to the user.

It will also be appreciated that in one example, the end stations 3 can be hand-held devices, such as PDAs, mobile phones, or the like, which are capable of transferring the subject data to the base station via a network such as the Internet 4, and receiving the reports.

In the event that the end station 3 is used in conjunction with, or includes, a device for determining the genotypic data from a blood, or other appropriate sample, this allows users of the system to take a sample from a subject in situ, determine the subject data and transfer this directly to the base station. It will be appreciated that as the processes at the base station can be substantially automated, this could be used to allow at least a preliminary diagnosis to be returned to the user via the end station 3 in a matter of minutes.

Furthermore, as this is in the form of a report outlining any conditions suffered by the subject, together with appropriate treatments, this can be used by subject owners that may have no medical experience to immediately obtain the required assistance, or to begin immediate treatment, as recommended.

Subject Data

The subject data may be selected from any expression product of the genome or characteristic or set of characteristics of the subject whose levels or abundance may vary within the subject or between two or more different subjects depending on their status. The data include, but are not restricted to, biological, physiological and pathological data of the subject. Examples of biological data include, transcriptomic profiles, proteomic profiles, metabolomic profiles, pharmacometabolomic profiles, gene allele profiles, nucleotide polymorphism profiles, karyotype profiles, pharmacogenetic profiles, enzyme function, receptor function, and the like. Physiological data may be selected from age, sex, height, length, weight, ethnicity, race, breed of animal, feeding patterns, exercise patterns, medication supplied, nutritional or growth supplements supplied, hair, skin and eye colour, fat composition, obesity, blood type, tissue type, endocrine function, immunological function, gastrointestinal function, neurological function, kidney function, heart function, brain function, pancreatic function, bone function, joint function, prosthesis, tissue reconstruction, surgery, pain, mental function, psychiatric disorder, mood disorder and the like. Examples of pathological data include infectious disease including viral infection, bacterial infection, mycobacterium infection, parasitic infection, prion function, cancer, transplant rejection, inflammatory diseases such arthritis and fibrosis, toxicological profiles, substance abuse including drug dependency and the like.

Data Mining

The system uses a self learning classification system, in which diagnosis is made using a historical database of test results (the predetermined data), which is updated as each test sample (subject data) is recorded. The historical database is typically maintained on a server.

In another example, where data mining is based on Bayesian stochastic variable selection, classification is based on the parameters estimated for discrimination or regression, using the genes remaining after the algorithm has discarded un-informative genes.

Clinical application of the system can be used to diagnose a subject such as an animal with an unknown clinical or performance state. That is, the animal may or may not have some disease, or may or may not be race-ready. A metabolic profile is measured for the animal subject.

In a preferred example, the metabolic profile is comprised of expression signatures measured on an oligonucleotide chip. In a preferred example the metabolic profile is compared with a set of pre-computed diagnostic signatures (templates), and together these are used to predict the health status of the subject. In a preferred example, prediction will include probabilistic estimates of uncertainty, and be accompanied by a list of possible differential diagnoses.

Diagnostic signatures are computed by data mining a historical database, which contains metabolic profile data on subject animals (predetermined data), and associated clinical information on subject health and performance status. These historical data use the same metabolic profile measurement technique as is used in clinical application. In a preferred example, these metabolic profiles are comprised of expression signatures measured on an oligonucleotide chip.

Data mining may be performed using a number of techniques including:

Regularised discriminant analysis for high dimensional data, as described by Kiiveri (1992) Canonical variate analysis of high dimensional spectral data. Technometrics 34 pp. 321-331.

Diagonal discriminant analysis as described by S. Dudoit, J. Fridlyand, and T. P. Speed (2002). Comparison of discrimination methods for the classification of tumors using gene expression data. Journal of the American Statistical Association, 97 (457), pp. 77-87.

Support Vector Machines as described by M P. S. Brown, W Noble Grandy, D Lin, N Cristianini, C Sugnet, T S. Furey, M Ares, Jr., D Haussler (2000) Knowledge-based analysis of microarray gene expression data by using support vector machines. Proceedings of the National Academy of Science. 97(l):262-267. and Y. Lee, Y. Lin, and G. Wahba (2002) Multicategory Support Vector Machines, Theory, and Application to the Classification of Microarray Data and Satellite Radiance Data. Technical Report 1064. Department of Statistics, University of Wisconsin-Madison.

Bayesian stochastic variable selection using a Jeffreys' prior (M.A.T. Figueiredo and R. Nowak (2001) Wavelet-based image estimation: an empirical Bayes approach using Jeffreys' non informative prior. IEEE Transactions on Image Processing.)

Tree based recursive partitioning Breiman, L., Friedman, J., Olshen, R., and Stone, C. (1984) Classication, augmented by Bagging Breiman, L. (1996) Bagging predictions, Machine Learning 26(2) pp. 123-140 and Boosting Breiman, L.(1998) Arcing classifiers. Annals of Statistics 26(3) pp. 801-849

It will be apparent, to practitioners skilled in the art, that other data mining procedures may be used to replace those identified above, without materially changing the nature of the invention.

It will be apparent that the signature structure for status determination depends on the details of the data mining algorithm used to derive the signature. In one example, the signature is derived using regularised discriminant analysis. Here the signature it used to allocate a new sample to one of a set of predetermined groups. The signature takes the form of a coefficient for each gene, and for each group. For example, with 3000 genes and 3 groups the signature would involve 9,000 numbers—one coefficient for each gene and each group. The signature is used to calculate a score for each group, and the sample is allocated to the group for which it has the highest score.

If the signature has been developed using Bayesian stochastic variable elimination, it will have a similar structure—but will have coefficients for a small subset of the genes (implicitly other genes have zero coefficients). Different genes may have non zero coefficients in different groups.

In another example, the signature has been developed using recursive partitioning. Here the signature is represented as a decision tree, in which each node is defined by a gene, a threshold and a relation. For example, a node might be represented by Gene: 3171 threshold 3.612 Relation “Greater Than”. Each node points either to a child node, or to a predicted status class or status value.

Diagnostic signatures are typically applied to a much more heterogeneous source of samples, than the sample base from which they were developed. This inevitably raises issues of robustness—a diagnostic applied to samples with different demographic characteristics from the training set may break down. This issue is controlled in two ways. Firstly, before any diagnostic signature is used in application, it must first be validated with a new source of samples. These samples must be more heterogeneous than the training set, and will be typically be stratified by known sources of variation (sex, age, drug treatment etc). Secondly, all diagnostic signatures must include robustness statistics, which measure the likely applicability of the signature to the given sample.

The precise form of the robustness statistic depends on the nature of the data mining procedure used, aid the form of the diagnostic signature. For any diagnostic signature involving status classes it will usually consist of information about the distribution of multivariate distances to the nearest class. The status determined for a sample which is extreme on the distribution of distances to all classes will be considered suspect.

Diagnostic signatures are combined with test subject metabolic profiles to produce a diagnosis. In one example, (where data mining was based on regularised or diagonal discriminant analysis), prediction is based on a Bayes classification rule, and estimates of uncertainty are based on posterior probabilities of class membership. In another example, (where data mining is based on Support Vector machines), classification is based on the support vectors, and uncertainties are estimated from distance of the test profile to the decision boundary. In another example (where data mining is based on recursive partitioning) classification is based on the estimated decision tree, or averaged over multiple decision trees.

It will usually be the case that even for an animal with an unknown clinical condition or performance status, some clinical or performance conditions are known. For example, it may not be known whether or not the animal has disease A, but it is known that the animal has disease B and does not have disease C. When test samples are recorded, the historical database is updated to include the test sample, and any known concomitant clinical or performance information.

It will usually be the case that an animal is tested more than once during a period of investigation. Re-testing may occur at a time when an earlier unknown clinical condition has become known. For the example given above, it may be the case that at a time of re-testing for race-readiness it is known that during the initial test the animal did have disease A. Provision is made to allow updates to and modification of the clinical data obtained for each test subject, as diagnosis is confirmed or modified.

In one example, data mining is repeated at regular intervals as the historic database grows. Test records added to the historic database will frequently contain only partial clinical or performance data. For any given clinical or performance factor, data will be filtered to remove subjects for which the particular characteristic is unrecorded. The data mining algorithm will then be used to construct new diagnostic signatures for the given clinical or performance characteristic. The procedure of filtering and mining is repeated for each characteristic of interest. In this way, the sample sizes used to obtain diagnostic signatures are constantly increasing, and predictive performance improves. The system becomes self-learning.

It is apparent that the Historical database must be initialised, and preliminary data mining conducted before clinical application of the diagnostic system. The database will be initialised using a training set comprising data from animals with known metabolic conditions. Appropriate experimental design is vital to the construction of the initial training data set. Empirical predictors derived using data mining are susceptible to artefactual relationships, involving nuisance factors—such as regional differences in diet and husbandry. For this reason the training data set must be obtained from a multicentre trial, and stratified appropriately.

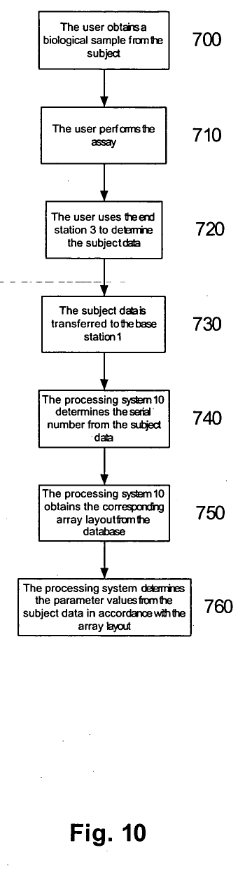

The overall process is illustrated by FIG. 11: which shows the flow of information and processing in the self-learning diagnostic system. In particular, FIG. 11 shows the elements of FIG. 6B in a development domain 70, highlighting that these portions of processing only need to be performed during initial set-up and re-tuning of the diagnostic signatures. An end user domain is shown at 71, highlighting that the user must obtain the genotypic and phenotypic data at 62, with reports being returned to the user at 64. In this case, the processing to determine a diagnosis by comparison of the diagnostic signatures stored in the signature database 61, to the received phenotypic data, is performed by the base station as shown.

Specific Examples

Specific examples are set out in more detail here. These are for the purpose of demonstration only and are not considered to be limiting.

### EXAMPLES

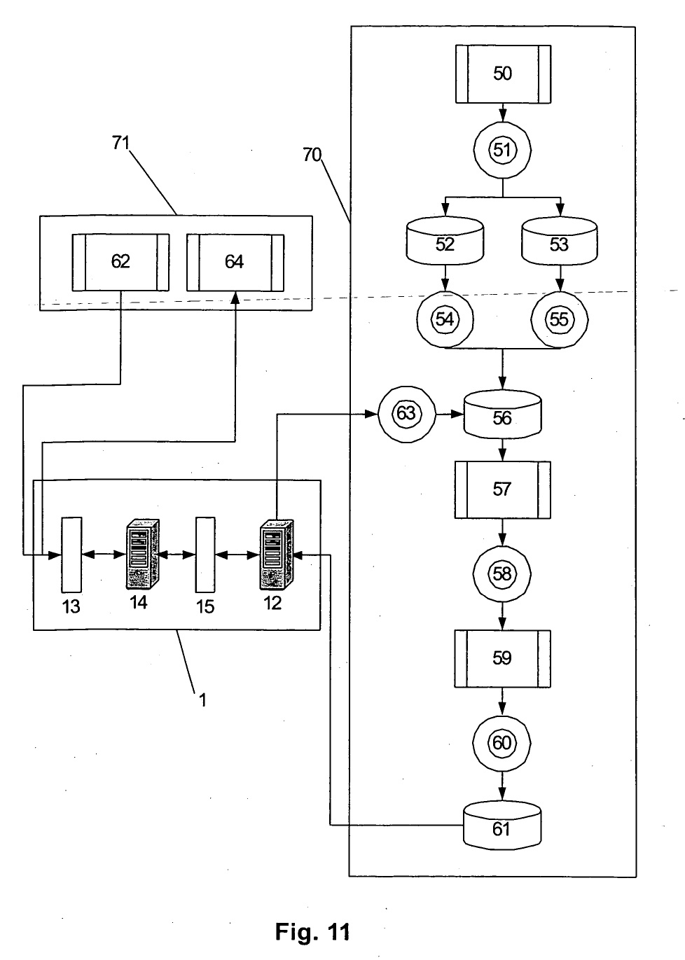

FIG. 12 is a flow diagram illustrating one specific example of an information technology architecture and data flow as part of a remote delivery service process. External users are shown as Class One 505, Class Two 510, and Class Three 515 that are interested in obtaining information regarding their respective gene expression results when using the proprietary gene expression analysis service. These users may include, for example, pathology laboratories, drug laboratories, pharmaceutical companies, collaborators, medical and/or veterinary practitioners or similar, owners of performance animals, athletes and/or athletic trainers. Each of these users 505, 510, 515 will be interested in different aspects of the gene expression results and will therefore interact in a different fashion, but all will interact remotely via an user interface module 520.

Interface 520 may, for example, be a browser-based interface as found on most computers and delivered via web pages on the world-wide-web (the Internet). The initial interaction to the user interface module 520 will be via a controlled firewall and web server. The firewall will be the first line of defence against unwanted and unauthorised intrusion. Port blocking techniques and protocol restrictions will be imposed at the firewall. The firewall and web server environment will be fully maintained with the latest security patches to ensure currency of protection against hackers and intrusion. Each user will establish a secure connection 525 (user authentication and establish secure web connection) to ensure confidential identification in both directions for the user and service delivery provider. The security is managed by a customer access management system 565 that controls access of users 505, 510, 515. Such security measures are commonly used in the art and one embodiment would be use of SSL (secure socket layer) technology and digital signatures. Further security layers can be added at this interface if required and might include challenge/response component such as continuously changing numerical keys in possession of the user and available in plastic card format and trusted networks.

Class One and Two Users 505, 510 are shown sending information as a query 530 and 531, that includes a question regarding health or condition status of an animal (interpretation request), sample details, gene expression results, clinical information, pathology laboratory results, gene identities, gene sequences, collaborative requests, etc. Class Three Users 515 are shown sending information 535 as a query including interrogation requests regarding a health status of individual animals/athletes or groups of individual animals/athletes.

Queries 530 and 531 may contain formatted gene expression and clinical information as a request, one such embodiment would employ the use of digitally signed XML documents to ensure authenticity and content of the request. Other authentication, authorisation and encryption and key management standards will be applied as they become available.

As a further security measure to protect central databases 590, from outside unauthorised access, queries are temporarily stored in a transaction staging module 540 and queries 532 and 533 will be drawn into respective pathology service module 550 and collaborative services modules 555 only on request from the service module. This process may employ a second firewall and may be configured to further restrict network traffic. This firewall will only permit internal requests from 550, 555, 560 to pass through the firewall. All other network traffic will be blocked as will unnecessary ports and protocols. Respective pathology services module 550 and collaborative services module 555 include special software capable of servicing requirements of the different types of users 505, 510. Pathology services module 550 and collaborative services module 555 are shown in communication with each other. Core central databases 590 store genetic information (genetic database) 591, sample and gene expression information (sample database) 593, and correlative data (correlative database & heuristics) 595. The genetic information stored in genetic database 591 is used to create gene expression devices Design details 592 are also stored in the sample database which contains gene location information on the device and are used to interpret results from such a device.

The genetic database 591 is also used to provide gene identification and gene sequence information to collaborative services module 555 and collaborative services 575 (for example, interpretations, gene lists and gene sequences) to Class Two users 510. Information in the sample database 593 can be clustered together based on similarity using computer algorithms such as K-means, principal component analysis (PCA) and self-organising maps, commonly available in packages provided by companies such as Spotfire, Silicon Genetics, and at higher levels of interpretation, Omniviz. These clusters amount to identified correlations 594 between gene expression and sample information and are stored in various formats, in the correlative database 595. An heuristic or neural network or rule-based computer software system pre-programmed with rules or training sets takes queries 534 (for example, expression details and sample details), stores these details in the sample database 593 and then compares the query pattern to those already stored in the correlative database 595 and produces standardized reports and correlation details 570 (according to the rules of the heuristic program). Correlation details are converted to useful information such as gene expression correlation results, for example, a fully formatted report to include interpretations 571 and interpretations 575 (and optionally genes lists and gene sequences) and are securely delivered back to the requestor via the internet to Class One and Two users 505, 510.

Financials database 597 keeps track of details including for example, accounting, purchasing and payroll details. Sales and marketing database 596 keeps track of items such as sales and marketing details, client details, customer relations management and stock management. Internal data warehouse 560 receives information from databases 590, 596 and 597. This internal data warehouse 560 will only be accessed by authorised internal users conducting legitimate business activities. A secure (internal) data warehouse 545 services the needs of Class Three users 515. Specific (and confidential) information 580 is extracted from internal data warehouse 560 that is then stored in secure customer data warehouse 545 where authorised users 515 can query 535 (for example, as interrogation requests), specific and confidential information such as clinical history information, pathology results and interpretations. This information is presented in a secure user-friendly and/or visual format 585 in relation to individuals or groups of athletes or performance animals, and/or time series of results.

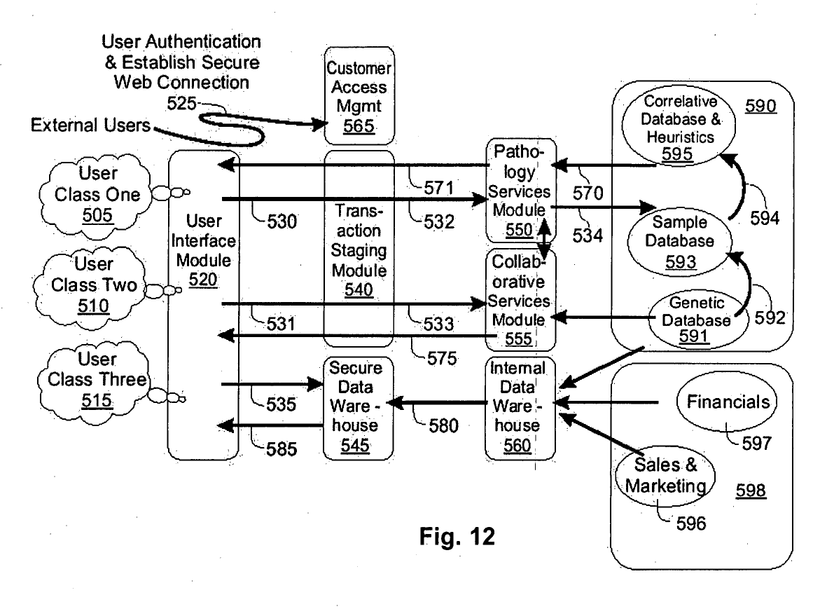

FIG. 13 is a flow diagram of one specific example showing steps for assessing a biological sample for diagnosing or assessing a condition of an animal. A user collects a biological sample 1010, for example, a blood sample from a horse. At the same time, biological parameters including biochemical and haematological parameters, clinical data (including blood profile tests) and appraisal information are collected and recorded in a standard format 1015, for example, by filling in a standard form. The biological sample 1010 is processed so that nucleic acids contained therein are detectable when hybridised with a complementary (or mismatch-complementary) nucleic acid located on an array 1020. The nucleic acid may be detectable by a label incorporated therein, for example, a target nucleic acid. Preferably, the array 1020 is a device such as a microarray which is read 1030 by standard methods and equipment common to the art to identify and measure relative abundance or absolute abundance of those nucleic acids from the biological sample which have bound to probe nucleic acids immobilised as part of array 1020 (inclusion of a reference sample run in parallel allows for the calculation of the relative abundance of target nucleic acids, whereas a method developed by the company Affymetrix, Inc (the “Affymetrix system”) as described at their website “affymetrix.com” relies on internal references.

Array 1020 may comprise a large number of probe nucleic acids, for example, 1000's of nucleic acids. A large number of probe nucleic acids may be particularly useful if an animal is not presenting with any visible signs of poor condition, for example, overt disease. Accordingly, in one embodiment, labelled target nucleic acids of a sample are first applied to an array comprising a “full-screen” of target nucleic acids (for example, 1,000's of nucleic acid probes that represent most or many of the nucleic acids expressed in a sample). Based on results from the full-screening, the labelled nucleic acid targets may be applied to a sub-set of the full-screen, for example, a selected panel of nucleic acid targets that may be associated with a particular condition, for example, respiratory diseases, drug consumption, etc.

Data from the read microarray 1030 and clinical data and appraisal information 1015 is formatted 1040 and transmitted via a communications network 1050, for example, the Internet, to a remote diagnostic server 1060. It will be appreciated that transmission of the formatted data to the remote diagnostic server 1060 requires less bandwidth than transmitting database information to the user and less skill and time on behalf of the user. The transmitted data is analysed 1070, for example, by comparison to a database of previously collected information in relation to clinical information and expression levels (relative abundance) of the nucleic acids applied to the microarray 1020. Also, experts, for example, bioinformaticists, biologists, doctors, pathologists, and the like may analyse the data to provide additional useful information. The analysis enables correlation to a condition 80. In this manner, the expression levels (relative or absolute abundance) of the nucleic acid probes applied to the microarray 1020 are correlated with previously collected data relating to known conditions stored in a database 1080 and compiled 1090. The database may also store information in relation to an identity of known nucleic acids, nucleotide sequence on the array and/or location of nucleic acids on the array, its biological function and links to other databases.

Results in relation to health and performance condition are transmitted via a communications network 1050 and may also be provided to the user as a report 1095, for example, a hardcopy printout or visually on a computer monitor.

The described system has advantages of requiring low bandwidth for transmitting sample data and final report between user and remote database/processor, data processing is centralised and more efficient, expert analysis of the sample data is centralised, the computer software may incorporate heuristic methods thereby minimising human interaction, the possibility of user and interpretation bias is avoided, and information stored in the commercially valuable database is under strict control and does not require direct access by an outside user. The steps are described in more detail hereinafter.

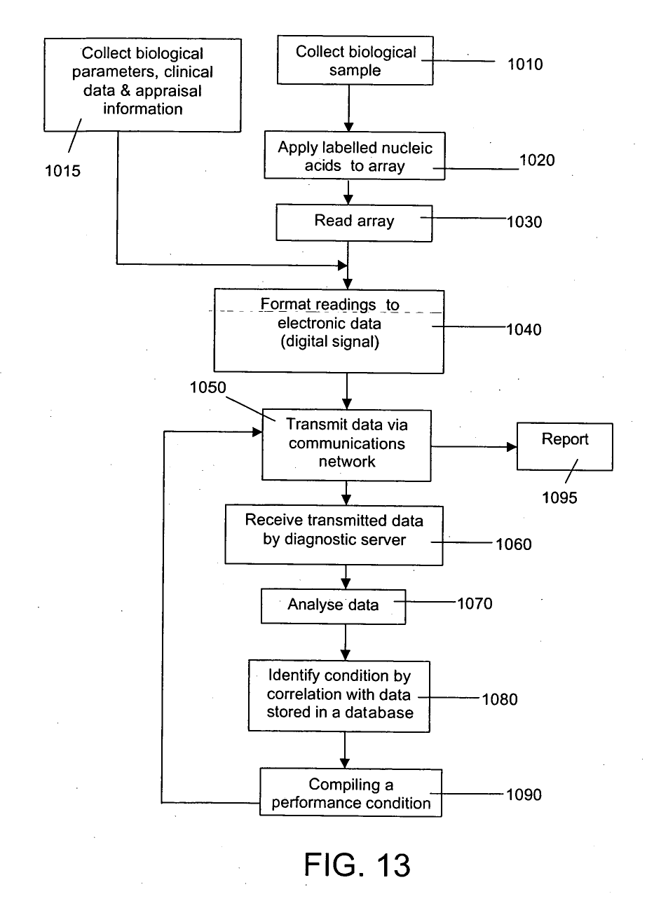

FIG. 14 shows an environment for working the method described in FIG. 13. A user 1100, which may be a veterinarian or practitioner, collects a sample 1120 from an animal 1101, for example, a blood sample from a horse or athlete. Concurrently, information in relation to a condition of the animal is collected in a standard format 1102. The sample is collected, nucleic acids isolated therefrom, prepared and applied to an array 1120 and the array is read by an array reader 1130. Data from the array reader 1130 and clinical appraisal and condition information 1102 is entered into a computer and formatted by a processor 1140, which may be for example, a laptop computer with a modem. The formatted data is transmitted via a communications network 1150, for example, the Internet. A remote diagnostic server 1160 receives the transmitted data and the data is compared with a database(s) 1161 which stores data, for example, data in relation to nucleic acid location on an array, expression level (relative abundance or absolute abundance) of a nucleic acid hybridised with a corresponding nucleic acid on an array, and data correlating nucleic acid expression level and performance, health, or condition of an animal.

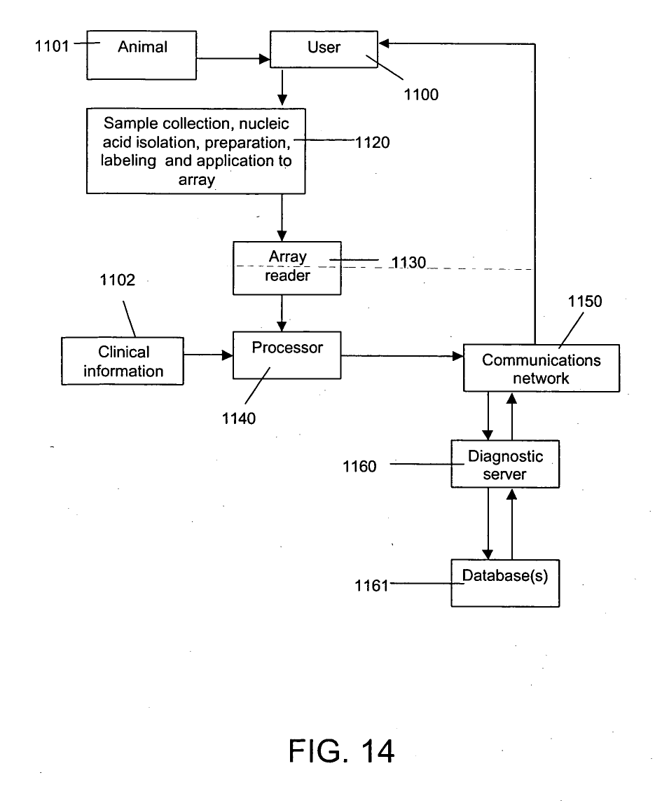

FIG. 15 is a flow diagram illustrating steps for preparing an array. A biological sample 1210 is collected from an animal. Biological sample 1210 may comprise for example, a blood sample (preferably white blood cells isolated therefrom), urine sample or tissue sample (including fetal tissues and tissues in various stages of development). A specific aim of collecting the biological sample is to isolate and sequence as many relevant genes from the sample for use on an array. Thousands of nucleic acids may be isolated that may form a large number of probes for a broad screening of an animal's genetic make-up or gene expression pattern.

Nucleic acids are isolated from the-biological sample. In one instance the sample may be used to prepare genomic DNA or tissue specific mRNA 1223. In another instance RNA is isolated from the biological sample 1210 and a cDNA library 1220 is prepared from the isolated RNA. Plasmids 1221 comprising cDNA inserts from library 1220 may be sequenced 1222 from either or both 5′ and/or 3′ end of the nucleic acid. Preferably, sequencing is from the 3′ end. Sequences may comprise Expressed Sequence Tags (EST). If an isolated nucleic acid does not encode a full-length gene (for example, an EST), a partial nucleic acid may be used as a probe to isolate a full-length nucleic acid. Alternatively, or in addition, EST sequence information may be compared directly with a sequence database 1230, for example, GenBank, and a search for related or identical sequences performed. Putative gene identification and function 1231 may be determined from a search, for example, a BLAST search performed at 1230. By determining the number of times each gene is represented in the library, a computer may be programmed to enable the normalisation and standardisation of the relative abundance data of mRNAs in a sample.

Gene-specific oligonucleotides 1232 may be synthesised using information from EST or full-nucleotide sequence 1222 data. Gene-specific oligonucleotides 1232 may be used as amplification primers to amplify (at 1224) a region of a corresponding nucleic acid. The nucleic acid used as template to amplify a region of corresponding nucleic acid may be, for example, isolated plasmid DNA 1221 and/or genomic DNA, cDNA or mRNA (for example, used with RT-PCR) 1223. The nucleic acid thus prepared can be used directly as the nucleic acids for attaching to an array 1240. Amplification products 1225 may also be generated using non-gene-specific primers (for example, oligo-dT, plasmid sequence flanking a nucleic acid of interest). Oligonucleotides corresponding to a gene 1232 may also be used on array 1240, alternatively the oligonucleotide corresponding to known sequence can be built successively nucleotide by nucleotide on a support using Affymetrix methodology such as that in U.S. Pat. No. 5,831,070, incorporated herein by reference.

In one embodiment, the step relating to constructing cDNA 1220 and isolating plasmids 1221 comprising the cDNA may be omitted. In this embodiment, isolated genomic DNA or tissue specific mRNA 1223 is used as a template to make amplification product 1225 by amplification using gene-specific primers 1232. Amplification product 1225 may be attached to array 1240.

Nucleic acids attached to or built onto array 1240 preferably represent most, more preferably all, expressed genes in a given tissue from an animal of interest. For example, for a complete diagnostic test for racehorse blood, the array should contain genes expressed in the cells of blood under various conditions and at various stages of cell differentiation.

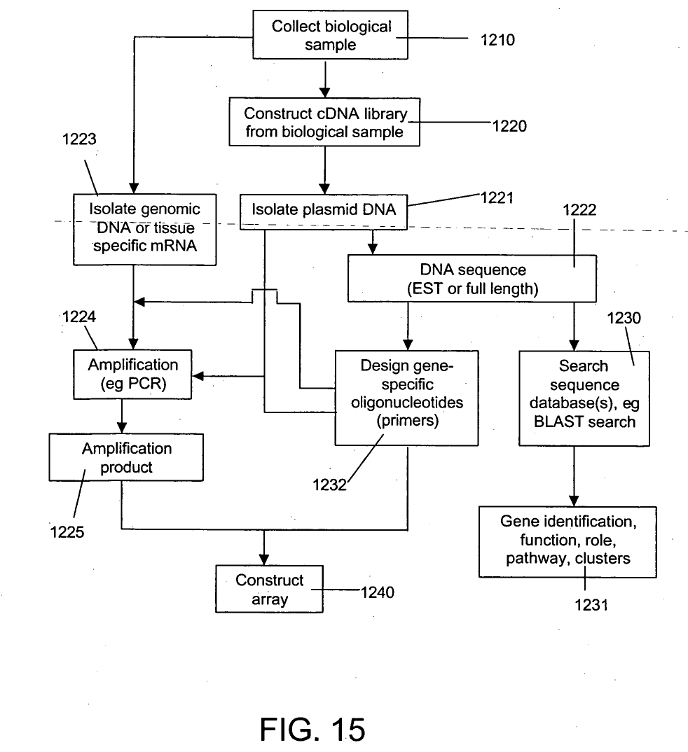

FIG. 16 shows a flow diagram comprising steps for determining gene expression in biological samples comprising both reference target 1305 and sample target 1310. Nucleic acids, in particular RNA (total RNA or mRNA), are isolated from biological samples 1305 and 1310, which may be the same sample. cDNA is prepared from the RNA and the cDNA is labelled resulting in labelled targets 1320 and 1325. Alternatively, or in addition, cDNA may be used as a template to synthesise labelled antisense RNA for use as targets 1320 and 1325. Reference target 1325 may be provided as a previously prepared labelled target of known concentration. Accordingly, reference target 1325 need not be synthesised in parallel with each sample target. Internal controls for reference target 1325 and sample target 1320 provide a means for normalising and scaling relative probe concentrations.

Sample target 1320 and reference target 1325 are hybridised with array 1330 (at 1340). Array 1330 may, for example, have been prepared by the processing shown in FIG. 15.

The hybridised array is washed 1345 to remove non-specific hybridisation of targets 1320 and 1325. It will be appreciated that one skilled in the art could select different stringency conditions of wash 1345 as required. Array 1330 is read in an array reader 1350 to determine relative abundance of RNA in the original sample, which correlates with expression of the corresponding gene in the biological sample.

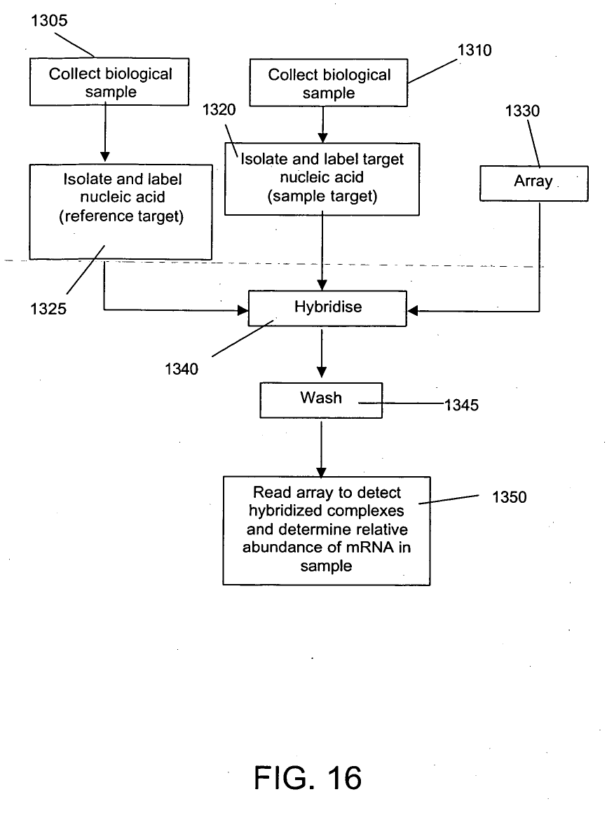

FIG. 17 is a flow diagram illustrating the processing for building a database. Biological samples 1410 are collected from animals having specific known condition(s). Preferably, a statistically relevant number of biological samples 1410 are collected from a variety of normal animals to establish a normal reference range of nucleic acid abundance levels. This should account for natural variation, including that associated with state of fitness, sex, age, season, breed and diurnal changes. Nucleic acids are isolated and labelled 1415 from sample 1410, thereby forming respective target nucleic acids. The labelled target nucleic acids 1415 are applied to array 1420, which may be prepared as described in FIG. 15. The array is read 1430 and data formatted 1440 into an electronic form, for example, a digital signal, suitable for transmission via a communications network 1450. Clinical information from clinical appraisal, in relation to conditions of animals of interest is measured, documented and compiled 1460. The clinical information is preferably collected in a standard format, and for example, variable states such as the level of fitness or body score (fatness) may be assigned given a value or number (for example, between 1-10). Specific clinical conditions may be graded (for example, between 1-10) and assigned a unique and standard identifier. An example of such a system is currently used in clinical medicine and veterinary science and termed SNOMED or SNOVET (Standardised Nomenclature of Medicine or Veterinary Science), where a clinical condition can be described using a numerical system. This system has not been used for describing the normal condition or the ability of a performance animal to perform to its best. A numerical grading system could also be used to standardise the collection of such data, for example, time spent on a treadmill is a strong indicator of exercise tolerance, as is blood concentration of oxygen and ability to transport oxygen. Conditions may include disease, response to drugs, training, nutrition and environment. The clinical information 1460 is formatted into electronic form 1440, for example, a digital signal, suitable for transmission via a communications network 1450.

The process is repeated such that a collection of several array readouts for particular conditions are made. A standard range (for example, a population median of 95%) of values for each of the represented genes and its relative abundance can be calculated. This reference range can then be used as a comparison to test sample results.

Nucleic acid expression information from a read array 1430 for a target sample is correlated with previously measured conditions 1460 to provide information on nucleic acid expression level (abundance or relative abundance) with any previously measured condition. This information is compiled at server 1470 and good data is stored and bad data rejected 1480. The compilation process includes collection of a large enough set of array readout information for a particular condition so that inferences can be drawn on gene expression profiles and conditions. The compilation 1470 may also include use of sophisticated pattern recognition and organisational software and algorithms (examples common to the art include algorithms such as K means, Anova and Mann Whitney, Self Organising Maps, principal component analysis, hierarchical clustering—any one of which is available as part of proprietary software packages) such that expression patterns that differ to normal or expected condition can be identified. The compilation 1470 will preferably include sophisticated methods of supervised classification such as regularised discriminant analysis, diagonal discriminant analysis, support vector machines, or recursive partitioning—any one of which is readily conducted using proprietary software packages. Concurrently, comprehensive clinical information 1460 for animals may be collected and biological samples 1410 tested on arrays so that correlations can be made between any clinical observation and array data. In this manner a database is created comprising data on nucleic acid expression which may include data correlating any desired condition, for example, normal and specific abnormal condition(s), with nucleic acid expression. The stored data 1480 may be accessed using specific programs and algorithms 1490.

Throughout this specification, unless the context requires otherwise, the words comprise, comprises and comprising will be understood to imply the inclusion of a stated integer or group of integers but not the exclusion of any other integer or group of integers._

In order that the techniques outlined above may be readily understood and put into practical effect, particular preferred embodiments will now be described by way of the following non limiting examples.

### Step 1

Biological Sample Collection

A biological sample comprising nucleic acids, for example, total RNA and mRNA, is collected. The biological sample may include cells of the immune system at various stages of development, differentiation and activity. The biological sample in most instances would be whole blood collected from a vein of a performance animal. However, the biological sample may include a fluid and/or tissue, for example, sputum, urine, tissue biopsies, bronchial or nasal lavages, joint fluid, peritoneal fluid or thoracic fluid which, in part, comprises cells of the immune system that have infiltrated such tissues or fluids. Cells present in blood which comprise mRNA may include mature, immature and developing neutrophils, lymphocytes, monocytes, reticulocytes, basophils, eosinophils, macrophages. All of these cell types also appear in tissues of nonblood origin at various times in various conditions.

Methods described herein may include use of the abovementioned cell types. The biological sample is collected and prepared using various methods. For example, an easy method of collecting cells of the blood is by venipuncture. The biological sample may be collected from a performance animal, for example, a horse with suspected laminitis, a human athlete or camel with osteochondrosis, or a greyhound with subclinical cystitis.

Blood sample

Ten ml of blood is drawn slowly (to prevent hemolysis) from the vein of an animal (jugular vein in a horse and camel, veins on the forearm/limb of humans and dogs) into a 1: 16 volume of 4% sodium citrate to prevent clotting and the sample is mixed and then placed on ice. The sample is centrifuged at 3000 RPM at 4° C. for 15 minutes and white blood cells (WBC) (commonly called the “buffy coat”) are removed from the interface between plasma and red blood cells (RBC) into a separate tube using a pipette. The WBCs are then treated with at least 20 volumes of 0.8% ammonium chloride solution to lyse any contaminating RBC and re-centrifuged at 3000 RPM at 4° C. for 5 minutes. The pelletted WBCs are then washed in 0.9% sodium chloride, re-centrifuged, and kept on ice. The cell pellet is then used directly in RNA extraction.

Non-blood biological fluid sample

fluid sample, for example, sputum, urine, bronchial or nasal lavages, joint fluid, peritoneal fluid or thoracic fluid, is centrifuged at 3000 RPM at 4° C. for 20 minutes to collect cells. Samples comprising large amounts of mucous are treated with a mucolytic agent such as dithiothretol prior to centrifugation. A cell pellet is then washed in 0.9% sodium chloride, re-centrifuged and the cell pellet is used directly in RNA extraction.

Tissue biopsy

A tissue biopsy is frozen in dry ice or liquid nitrogen and crushed to powder using a mortar and pestle. The frozen tissue is then used directly in RNA extraction.

### Step 2

RNA Isolation

Total RNA and/or mRNA is isolated from a biological sample. Use of isolated mRNA rather than total RNA may provide results with less background and improved signal.

RNA is commonly isolated by skilled persons in the art, and examples of some methods for isolating mRNA are described below.

Commercially available kits, for example, Qiagen RNA and Direct RNA extraction kits, and RNA extraction kits produced by Invitrogen (formerly Life Technologies) and Amersham Pharmacia Biotech herein incorporated by reference, may be used by following the manufacturer's instructions. Key elements of these mRNA extraction protocols include use of an appropriate amount of sample, protection of the sample from RNAse contamination, elution of the sample from a column at 70° C. and quantitation and quality checking in an agarose 0.7% gel and using an OD 260/280 ratio. About 0.2 gm (wet weight) of pelleted white blood cells or tissue is required for each mRNA extraction which will yield about 1-2 μg of mRNA. Disposable gloves should be worn throughout the procedure, with frequent changes. Both the column and solution used for elution should be at 70° C.

Alternatively, the following protocol is followed for RNA isolation:

1.1. Dispense 2.5 ml aliquots of blood isolated according to step 1 into each of six PAXgene® tubes. (Qiagen) and incubate at room temperature for 4-8 hours.

1.2. Centrifuge samples at 4300 rpm (3827×g) for 10 minutes at room temperature.

1.3. Process each sample individually in the following manner:

1.3.1. Pour supernatant into blood waste bottle; gently tap rim of tube on paper towel to remove excess supernatant.

1.3.2. Add 5 μl RNase-free water from PAXgene™ kit to the pellet. Resuspend pellet by vortexing. Visually inspect the tubes to ensure complete resuspension of sample.

1.4. Centrifuge samples for 10 minutes at 4300 rpm (3827×g) at room temperature.

1.5. Process each sample individually in the following manner:

1.5.1. Pour off supernatant into blood waste bottle. Remove any excess supernatant with a pipet Tap on paper towel until tube is dry.

1.5.2. Add 360 μl Buffer BRI from PAXgene™ kit and resuspend pellet by vortexing. Visually inspect the tubes to insure complete resuspension of sample.

1.5.3. Using a pipettor, transfer the sample into a 1.5 ml microcentrifuge tube.

1.5.4. Add 300 μl Buffer BR2 from PAXgene™ kit and 40 μl Proteinase K. (Do not mix BR2 buffer and Proteinase K before adding to the sample). Mix by vortexing.

1.6. Incubate for 10 minute at 55° C. in an incubator, shaking at high speed.

1.7. Centrifuge for 3 minutes at 14,000 rpm (20,800×g) in microcentrifuge. Sample can be centrifuged longer if too much unpelleted debris is seen. This additional centrifugation is sample dependent.

1.8. Process each sample individually in the following manner:

1.8.1. Transfer supernatant to a new 1.5 ml microcentrifuge tube making sure not to disturb the pellet.

1.8.2. Add 350 μl 100% ethanol to each sample.

1.9. Mix by vortexing and spin down for only 1 to 2 seconds. It is important not to spin too long as it could precipitate the RNA.

1.10. Add 700 μl of sample to column from PAXgene™ kit. Place column in a collection tube and centrifuge for 1 minute at 10,000 rpm (10,600×g) in microcentrifuge.

1.11. Move column to new collection tube. Add rest of sample onto column. Centrifuge for 1 minute at 10,000 rpm (10,600×g) in microcentrifuge.

1.12. Move column to new collection tube. Wash columns with 350 μl Buffer BR3 from PAXgene™ kit and centrifuge for 1 minute at 10,000 rpm (10,600×g) in microcentrifuge.

1.13. Move column to new collection tube.

1.14. Prepare DNase I stock solution.

1.14.1. Dissolve solid DNase I in 550 μl RNase-free water. Take care that no DNAse I is lost when opening the vial.

1.14.2. Mix gently by inverting the tube. Do not vortex.

1.14.3. Aliquots of prepared DNase I stock solution should be stored at −20° C. for up to 9 months.

1.15. Remove sufficient amount of DNase I stock solution from freezer and thaw. Make a mastermix of DNase I stock solution and Buffer RDD. Per sample, use 10 μl DNase stock solution and 70 μl Buffer RDD from DNase kit. Gently mix by inverting the tube and centrifuge briefly.

1.16. Add 80 μl of DNase I/Buffer RDD mastermix directly onto column. Incubate for 15 minutes at room temperature.

1.17. Wash columns with 350 μl Buffer BR3 from PAXgene™ kit. Centrifuge for 1 minute at 10,000 rpm (10,600×g) in microcentrifuge. Move column to new collection tube.

1.18. Wash columns with 500 μl Buffer BR4 from PAXgene™ kit. Centrifuge for 1 minute at 10,000 rpm (10,600×g) in microcentrifuge. Move column to new collection tube.

1.19. Wash columns with 500 μl Buffer BR4 from PAXgene™ kit. Centrifuge for 3 minutes at 14,000 rpm (20,800×g) in microcentrifuge. Move column to new 1.5 ml snap cap microcentrifuge tube.

1.20. Using individual pipet tips, pipette 40 μl of Buffer BR5 from PAXgene™ kit directly onto the membrane of the column. Incubate at room temperature for 5 minutes.

1.21. Centrifuge for 1 minute at 10,000 rpm (10,600×g) in microcentrifuge.

1.22. Reapply the flow through to column and incubate at room temperature for 5 minutes.

1.23. Centrifuge for 1 minute at 10,000 rpm (10,600×g) in microcentrifuge.

1.24. Discard column, and incubate eluted samples at 65° C. for 5 minutes. After incubation, place samples immediately on ice.

RNA quantification and assessment of RNA size and quality include standard gel electrophoresis methods of running a small quantity of an RNA sample on an agarose gel with known standards, staining the gel with for example, ethidium bromide to detect the sample and standards and comparing relative intensities and size of standard RNA and sample RNAs, comparison of the intensities of the ribosomal RNA bands. Alternatively, or in addition, RNA concentration in a solution may be determined by measuring absorbance at 260/280 nm in a spectrophotometer relative to known standards and calculated using known formulas.

cDNA Synthesis and Labelling

RNA prepared as described above may be synthesised to cDNA and labelled resulting in a labelled probe using kits provided by suppliers such as Amersham Pharmacia Biotech, Invitrogen, Stratagene or NEN, herein incorporated by reference. For example, a typical reaction may comprise: template RNA, an oligo-dT primer and/or gene-specific primers, reverse transcriptase enzyme, deoxyribonucleic triphosphates (dNTP), a suitable buffer, and a label incorporated into at least one of the dNTPs. Such a reaction when combined with a method of amplifying the resultant cDNA is referred to as RT-PCR (reverse transcriptase-polymerase chain reaction). A specific example is provided below, but it should be noted that other methods of incorporation of label into DNA can be used and that such methods are under constant review and improvement, for example, some methods include the incorporation of amino-allyl dUTP and subsequent coupling of N-hydroxysuccinate activated dye to increase the specific labelling of the DNA.

To anneal primer(s) to template RNA, mix 2 μg of mRNA or 50-100 μg total RNA from respective test sample (Cy3) and reference sample (Cy5) in separate tubes with 4 μg of a regular or anchored oligo-dT primer or gene-specific primers in a total volume of 15 μl (using purified water to make up the volume). (Regular oligo dT is 5′-TTT TTT TTT TTT TTT TTT TTT, anchored oligo dT is 5′-TTT TTT TTT TTT TTT TTT TTV N-3′), (where V=A, C or G; and N=A, C, G or T). Heat mixture to 65° C. for 10 min and cool on ice. Add 15.0 μl of reaction mixture to respective Cy3 and Cy5 reactions.

The reaction mixture comprises of the following: 6.0 μl of 5X first-strand buffer, 3.0 μl of 0.1M DTT, 0.6 μl of unlabeled dNTPs, 3.0 μl of Cy3 or Cy5 dUTP (1 mM, Amersham), 2.0 μl of Superscript II (Reverse transcriptase 200 U/μL, Life Technologies) made to 15 μl with pure water. Unlabelled dNTPs are sourced from a stock solution consisting of 25 mM dATP, 25 mM dCTP, 25 mM dGTP, 10 mM dTTP. 5X first-strand buffer consists of 250 mM Tris-HCL (pH 8.3), 375 mM KCl, 15 mM MgC12). The mixture is incubated at 42° C. for 1 hr. Add an additional 1 μl of reverse transcriptase to each sample. Incubate for an additional 0.5-1 hrs. Degrade the RNA and stop the reaction by adding 15 μl of 0.1N NaOH, 2 mM EDTA and incubate at 65-70° C. for 10 min. If starting with total RNA, degrade the RNA for 30 min instead of 10 min. Neutralize the reaction by adding 15 μl of 0.1N HCl. Add 380 μl of TE (10 mM Tris, 1 mM EDTA) to a Microcon YM-30 column (Millipore).

Next add 60 μl of Cy5 probe and 60 μl of Cy3 probe to the same microcon. Centrifuge the column for 7-8 min. at 14,000×g. Remove flow-through and add 450 μl TE and centrifuge for 7-8 min. at 14,000×g (washing step). Remove flow-through and add 450 μl 1X TE, 20 μg of species-specific Cot1 DNA (20 μg/μl, Life Technologies for human—Cot1 DNA is genomic DNA that has been denatured and re-annealed such that the concentration of the DNA and the time of re-annealing multiplied equals 1. Methods for making Cot1 DNA are common in the art), 20 μg polyA RNA (10 μg/μl, Sigma, #P9403) and 20 μg tRNA (10 μg/μl, Life Technologies, #15401-011). Centrifuge 7-10 min. at 14,000×g. The probe needs to be concentrated such that with the addition of other solutions required for hybridisation the volume is not excessive, or is suitable for use with a desired slide and cover slip size. Invert the microcon into a clean tube and centrifuge briefly at 14,000 RPM to recover the probe.

A nucleic acid may be labelled with one or more labelling moieties for detection of hybridised labelled nucleic acid (i.e., probe) and target nucleic acid complexes. Labelling moieties may include compositions that can be detected by spectroscopic, photochemical, biochemical, immunochemical, optical or chemical means. Labelling moieties may include radioisotopes, such as 32P, 33P or 35S, chemiluminescent compounds, labelled binding proteins, heavy metal atoms, spectroscopic markers, such as fluorescent markers and dyes, magnetic labels, linked enzymes, and the like. Preferred fluorescent markers include Cy3 and Cy5, for example, available from Amersham Pharmacia Biotech (as described above).

cRNA Synthesis and Labelling

The Affymetrix system uses RNA as substrate and generates biotin labelled cRNA through a series of reactions using a BioArray HighYeild RNA transcript labelling kit (available from Enzo)and the following protocol:

cRNA Synthesis

2.1. Add 10 μl of thawed cDNA sample into properly labelled strip tube.

2.2. Pipette 10 μl of the control samples into properly labelled strip tube.

2.3. Prepare master mix using reagents from the BioArray Kit and DEPC treated H₂O.

| | Per Sample (μl) |
|---|---|
| 10X HY Reaction Buffer | 4 |
| 10X Biotin Labeled Ribonucleotides | 4 |
| 10X DTT | 4 |
| 10X RNase Inhibitor Mix | 4 |
| 20X T7 RNA Polymerase | 2 |
| DEPC treated water | 12 |
| Subtotal | 30 |

2.4. Store master mix on ice if not used immediately.

2.5. Pipette 30 μl master mix into each sample tube.

2.6. Using a pipette, mix each sample.

2.7. Cap tubes and quick spin in a microfuge.

2.8. Place tubes in thermal cycler and run program specified above (37° C. for 6 hours, 4° C. hold).

2.9. Proceed to cleanup or leave at 4° C. overnight.

cRNA Cleanup

3.1. Add 60 μl of DEPC treated water to each sample, bringing total volume to approximately 100 μL

3.2. Add each sample to the corresponding, labelled, 1.5 ml microcentrifuge tubes.

3.3. Add 350 μl of RLT (with BME) to each sample.

3.4. Add 250 μl of absolute ethanol to each sample.

3.5. Mix sample by pipetting.

3.6. Pipette each sample onto properly labeled RNeasy column. The total sample volume at this point should be approximately 700 μl.

3.7. Cap columns and centrifuge at 10,000 rpm at room temperature for 15 seconds. The 15 seconds begins after centrifuge speed has reached 10,000 rpm.

3.8. Remove samples from centrifuge.

3.9. Carefully remove column from collection tube and reapply flow-through solution back onto the column.

3.10. Replace column in collection tube and repeat step 3.7.

3.11. Remove samples from centrifuge.

3.12. Place column into a fresh 2 ml collection tube and discard tube containing flow-through solution.

3.13. Add 500 μl of RPE (with ethanol) to each column.

3.14. Cap columns and centrifuge at 10,000 rpm at room temperature for 15 seconds. The 15 seconds begins after centrifuge speed has reached 10,000 rpm.

3.16. Remove column from tube and place in a fresh collection tube. Discard used tube.

3.17. Add 500 μl of RPE (with ethanol) to each column.

3.18. Cap columns and centrifuge at 14,000 rpm at room temperature for 10 minutes to completely dry the column.

3.19. Remove tube from centrifuge.

3.20. Carefully remove column from tube and place it into a fresh 1.5 ml microcentrifuge tube.

3.21. Add 50 μl of DEPC treated water directly onto the column, being careful not to touch the membrane with the pipettor tip.

3.22. Incubate at room temperature for 5 minutes.

3.23. Centrifuge at 10,000 rpm for 1 minute (save eluate).

3.24. Repeat steps 3.21 through 3.23.

Samples may be stored in −20° C. freezer until the next day.

Quantification of cRNA, Fragmentation and Preparation of Hybridisation Mix

4.1. Determine concentration of cRNA sample by spectrophotometry.

4.1.1. Measure and record the volume of each sample.

4.1.2. Add 200 μl TE (pH 7.4) to enough wells for all samples and repeats for failures (i.e. one column).

4.1.3. Blank the plate on the spectrophotometer.

4.1.4. Add 2 μl of each sample to the corresponding well on the plate.

4.1.5. Using a multichannel pipettor, pipette up and down in the well several times to mix the samples. Return the plate to the microplate drawer of the spectrophotometer and read the plate.

4.1.6. The A₂₆₀/A₂₈₀ ratio for each sample should be between 1.8 and 2.3, and the A₂₆₀ value should be greater than or equal to 0.09. Repeat steps 2.1.4-2.1.6 for any sample that doesn't fall within this range or wait to see if sample fails on the gel image before repeating.

4.1.7. Concentrations higher than 3500 μg/μl (A₂₆₀˜0.900) repeat steps 2.1.4-2.1.6 or calculate yields for samples: (concentration×volume)/1000. If the calculated yield is greater than 175 μg repeat steps 2.1.4-2.1.6.

4.1.8. Record the measured volume.

4.2. Agarose gel electrophoresis of samples.

4.2.1. Use precast, 20 well, 1.25% MOPS gels and 1×MOPS buffer.

4.2.2. Add 0.5 μl of sample and 0.5 μl of RNA ladder to 5 μl of loading dye in separate tubes and heat at 70° C. for five minutes.

4.2.3. Load the samples and ladder in the gel.

4.2.4. Electrophorese for 55 minutes at 140 volts. If an 8 well gel is used, run at 110 volts for 55 minutes.

4.2.5. Stain gels in 1X MOPS for 20 minutes with 20 μl of GelStar diluted in approximately 200 ml.

4.2.6. Capture the gel either electronically using a Gel Imaging System or photometrically using a Polaroid Camera.

4.3. Fragmentation

4.3.1. Remove 24 μg of each sample to a fresh PCR tube (see C in above note).

4.3.2. If the sample has less than 24 μg transfer at least 10 μg to the fresh tube.

4.3.3. If the yield is less than 10 μg, the sample is a failure.

4.3.4. Add 1/4 volume of fragmentation buffer to each sample.

4.3.5. Mix sample by pipetting or invert and centrifuge.

4.3.6. Heat samples on a thermal cycler (94° C. for 35 minutes, 4° C. hold).

4.3.7. Remove Fragmented cRNA samples (FCR) from thermal cycler and place on ice.

4.3.8. Quick spin samples in centrifuge to collect sample at the bottom of the tube.

4.3.9. Record results.

4.3.10. Run 1 μl of each sample on an Agilent RNA 6000 Nano Assay chip.

4.3.1 1. Using the Agilent Bioanalyzer analyze the electropherogram of each FCR.

4.4. Preparation of Post Hybridisation Mixture

4.4.1. Prepare hybridisation mixture according to the recipe in Table 1

TABLE 1

| Reagent | Per 10 μg of FCR |
|---|---|
| 2X Hybridisation Buffer | 100 μl |
| Oligo B2 Control | 3.3 μl |
| 20X Spike-In Control | 10 μl |
| Herring Sperm DNA | 2 μl |
| BSA | 2 μl |

4.4.2. Add the specified volumes of DEPC treated water, Hybridization Mix (HM), and FCR to the labelled Pre Hybridisation (PH) tube according to Table 2

TABLE 2

| | | DEPC treated |
|---|---|---|
| | | water total volume − (Hyb Mix(HM) volume + |
| cRNA | Hyb Mix | FCR volume) = DEPC treated water volume |
| 9.0 μg | 105.6 μl | 180 − (105.6 μl HM + 9.0 vg FCR) = μl DEPC |
| | | treated water |

4.4.3. Record results of the Hybridisation Mix and Agilent results.

### Step 3

Arrays

One feature is an array comprising nucleic acids representing expressed genes from cells found in blood of a performance animal, for example, a horse, human, camel or dog. The nucleic acids may be of any length, for example, a polynucleotide or oligonucleotide as defined herein.

Each nucleic acid occupies a known location on an array. A nucleic acid target sample probe is hybridised with the array of nucleic acids and an amount or relative abundance of target nucleic acid hybridised to each probe in the array is determined.

High-density arrays are useful for monitoring gene expression and presence of allelic markers which may be associated with disease. Fabrication and use of high density arrays in monitoring gene expression have been previously described, for example, in WO 97/10365, WO 92/10588 and U.S. Pat. No. 5,677,195, all incorporated herein by reference. In some embodiments, high-density oligonucleotide arrays are synthesised using methods such as the Very Large Scale Immobilised Polymer Synthesis (VLSIPS) described in U.S. Pat. No. 5,445,934, incorporated herein by reference.

Arrays for humans are commercially available from companies such as Incyte, Research Genetics, and Affymetrix. Canine expression arrays have been developed by Lion Bioscience, Pfizer and GeneLogic. These arrays typically comprise between 2,000 and 60,000 transcripts and are species specific (none are available for the horse or camel). Some of these genes are in multiple copies on the array and have not been fully annotated or given a true gene identity. Additionally, it is not known whether DNA on the array when hybridised to a test sample, specifically binds to a single gene. This latter instance results from splice variants of RNA transcripts in tissues such that one gene may encode multiple transcripts.

Human and dog arrays (when available) can be used in methods described herein. However, these arrays are currently non-specific and include genes that are not expressed in blood cells of animals, and/or do not contain genes important in controlling the function of blood cells, and/or contain regions of genes that are not specific to blood cells.

Clones containing specific genes are available and can be purchased for human (mouse and dog) for use on arrays (for example, from the IMAGE consortium or Lion Bioscience). However, it is not possible to obtain specific clones for use on a blood-specific array without prior knowledge of what genes are expressed in blood cells. The IMAGE consortium also does not guarantee that the gene of interest is contained in the clone purchased.

Array Construction

Because of difficulties, problems and a likelihood of wasting financial resources to obtain a blood-specific DNA array, a method is provided herein which provides rapid and cost effective generation of species and tissue-specific DNA arrays for assessing nucleic acid expression in a sample. FIG. 14 shows steps for constructing an array in one embodiment.

Target Nucleic Acid Preparation

Biological samples are collected as described above. Samples comprising cells expressing as many genes of interest in relation to condition(s) of a performance animal are collected. For example, a sample comprising a mixture of nucleated blood cells from performance animals with conditions such as, osteochondrosis, laminitis, tendon soreness, bursitis, abcesses, inflammation, allergy, viral infection, parasite infection, asthma, etc.

Approximately 5 μg of mRNA is isolated from the biological sample (typically 1 gm wet weight) using mRNA isolation kits or the protocol described above. Concurrently, 5 μg of mRNA is isolated from umbilical cord blood, and/or early stage foetus. Cells and tissues contained within these sources would express genes that may not be expressed in the cells extracted from blood in the above example. Isolation of cytoplasmic mRNA from cells is preferred. This step involves rupturing the cells with a solution comprising detergent and/or chaotropic agent and salt such that cell nuclei and the nuclear membrane remain intact. The cell nuclei are pelleted by centrifugation and the supernatant is used for mRNA extraction. Protocols for this procedure are available as part of mRNA isolation kits (for example, available by Qiagen). These mRNAs may be used to construct cDNA libraries. Kits for the construction of cDNA libraries are available from companies including Stratagene and Invitrogen (for example, Uni-ZAP XR cDNA synthesis library construction kit #200450). The library preferably should be constructed such that the orientation of the cDNA in the vector is known, that the mRNA is primed using oligo dT, the vector is capable of receiving a nucleic acid insert up to 10 kb and that purification of DNA suitable for DNA sequencing is possible and easy. By following the manufacturer's instructions and paying particular attention to the quality of mRNA used and the size fractionation of cDNA (greater than 0.7 kb), a quality library containing enough viruses (>1×106) with insert sizes >0.7 kb can be generated.

Plasmids generated from such a library can be DNA sequenced using protocols that are well established in the art and are available, for example, from Applied Biosystems. Briefly, a mix of 0.5 μg of plasmid DNA, 3.2 pmol of a primer that hybridises to the vector DNA (for example, M13 −21, or M13 reverse primer), thermostable DNA polymerase, dNTP and labelled dNTP is subjected to a routine PCR procedure to generate fragments of DNA that can be separated by gel electrophoresis and using machinery such as that available from Applied Biosystems (for example, a 3700 DNA sequencer). Generated DNA sequence data (chromatogram) is assessed and quality scores and binning of similar sequences is done using a computer program package such as Phred/Phrap/Consed. The raw DNA sequence data can then be loaded into a database where comments (annotation) on the sequence can be made, such as quality score, bin, length of poly A sequence (should there be one), BLAST search results, highest homology in GenBank, clone identity, other entries in GenBank.

Subjective factors influencing whether a nucleic acid should be used on an array include quality and confidence of the DNA sequence, a GenBank homology score with identified nucleic acids, evidence of a poly-A tail (indicative of a translated transcript), uniqueness of the 3′ sequence data (compared to both GenBank and an in-house database of clone sequences).

Nucleic acid primers can be selected using a program such as Primer 3 available via the Internet (www-genome.wi.mit.edu/cgi-bin/primer/primer3). The selected primers may be used for amplifying a nucleic acid, for example, by PCR, or directly applied to an array. Uniqueness of a nucleic acid can be tested by performing additional BLAST searches on GenBank and an in-house database. Primers are preferably designed such that melting temperatures are similar, and amplification products are of a similar nucleic acid length. Primers for PCR are generally between 18 and 25 nucleotide bases long. Primers for direct use on a microarray or device are preferably between 50 and 80 nucleotide bases long. Both the amplification product and the single primer should hybridise to DNA that uniquely identifies a gene transcript. Specific programs using various formulas are available for calculating the melting temperature of various lengths of DNA (for example, Primer 3). Alternatively, selected DNA sequences can be provided to Affymetrix for production of a proprietary and custom array. The sequences generated in-house are provided to Affymetrix in Fasta format along with details of which parts of the sequence to be used for the generation of a probe set (11 probes, each 25 nucleotide bases long) for each gene represented on the array.

Nucleotide sequences may be compared with an existing database, for example, GenBank, to determine a previously provided name, tissue expression, timing of expression, biochemical pathway, cluster membership, and possible function or cellular role of an expressed nucleic acid. In addition, a nucleic acid fragment may be used as a probe to isolate a full-length nucleic acid which may encode a gene which is associated with a particular disease or condition. Further, identified nucleic acids may be used to isolate homologues thereof, inclusive of orthologues from other species. An identified nucleic acid may also be cloned into a suitable expression vector to produce an expressed polypeptide in vitro, which may be used, for example, as an antigen in generating antibodies and for use on protein arrays. The antibodies may be used for developing specific diagnostic assays or therapies, for three-dimensional protein structure such as X-ray crystallographic studies, or for therapeutic development.

An array may comprise any number of different nucleic acids, but typically comprises greater than about 100, preferably greater than about 1,000, more preferably greater than about 5,000 different nucleic acids. An array may comprise more than 1,000,000 different nucleic acids. Each nucleic acid is preferably represented more than once for scanning internal comparison and control. Preferably, the nucleic acids are provided in small quantities and are gene-specific and/or species-specific usually between 50 and 600 nucleotides long, arranged on a solid support.

The Affymetrix system uses 11 probes per gene, each of 25 nucleotides, that are built onto the array using a photolithographic method (U.S. Pat. Nos. 6,309,831; 6,168,948; 5,856,174; 5,599,695; 5,831,070; 6,153,743; 6,239,273; 6,271,957; 6,329,143; 6,310,189 and 6,346,413). The nucleic acids may be dotted onto the solid support or bound to microspheres, or in solution. A typical array may have a surface area of less than 1 cm2, for example, a microarray.

A nucleic acid can be attached to a solid support via chemical bonding. Furthermore, the nucleic acid does not have to be directly bound to the solid support, but rather can be bound to the solid support through a linker group. The linker groups may be of sufficient length to provide exposure to the attached nucleic acid. Linker groups may include ethylene glycol oligomers, diamines, diacids and the like. Reactive groups on the solid support surface may react with one of the terminal portions of the linker to bind the linker to the solid support. Another terminal portion of the linker is then functionalised for binding the nucleic acid. A solid support may be any suitable rigid or semi-rigid support, including charged nylon or nitrocellulose, chemically treated glass slides available from companies such as NEN, Corning, S&S, arrays available through Affymetrix, membranes, filters, chips, slides, wafers, fibers, magnetic or nonmagnetic beads, gels, tubing, plates, polymers, microparticles and capillaries. The solid support can have a variety of surface forms, such as wells, trenches, pins, channels and pores, to which the nucleic acids are bound. Preferably, the solid support is optically transparent.

The array may be constructed using an “arraying machine” manufactured by companies for example, Molecular Dynamics, Genetic Microsystems, Hitachi, Biorobotics, Amersham, Corning. Alternatively, the array may be manufactured according to specific instructions provided by the user to Affymetrix. Source materials for this machine include microtitre plates comprising nucleic acids representative of unique genes, or sequence information. An array element may comprise, for example, plasmid DNA comprising nucleic acids specific for a gene sequence, an amplified product using gene-specific or nonspecific primers and template DNA or RNA, or a synthesised specific oligonucleotide or polynucleotide. Array elements may be purified, for example, using Sephacryl-400 (Amersham Pharmacia Biotech, Piscataway, N.J.), Qiagen PCR cleanup columns, or high performance liquid chromatography (for oligonucleotides).

Purified array elements may be applied to a coated glass substrate using a procedure described in U.S. Pat. No. 5,807,522, incorporated herein by reference. By other example, DNA for use on Corning amino-silane coated slides (CMT-GAPSTM) is re-suspended in 3×SSC to a concentration of 0.15-0.5 μg/μl and then used directly in an arraying machine in 96 or 384-well plates.

An example for preparing an array element is provided by the manganese superoxide dismutase gene. A clone comprising a nucleic acid insert is prepared and isolated as described above. The clone is sequenced to identify the nucleotide sequence. A BLAST search using the identified nucleotide sequence is performed to determine homology of the cloned nucleic acid with nucleic acids in a database, for example, GenBank. Identification of nucleotide sequence homology with superoxide dismutase genes stored in the database provides a level of confidence that the clone comprises at least in part a gene for superoxide dismutase for the horse. Unique primers can be designed to amplify a nucleic acid using PCR and the clone DNA, or genomic DNA from the same species as a template. Purified amplification product can be directly attached to an array and thereby act as a target for a complementary labelled nucleic acid probe in the test and reference samples. Alternatively, a unique sequence can be determined and an oliognucleotide manufactured and purified for direct use on an array, or the sequence information supplied directly to Affymetrix for the construction of a custom array.

The array may comprise negative and positive control samples (preferably as duplicates or triplicates) such as nucleic acids from species different from a sample being tested (negative controls) and various nucleic acids (representative of RNAs and both ends of RNA molecules) that are found in all tissues as a constant and known quantity (positive controls). These controls are identified and used by the array reader to provide data on true signal (i.e., Specific hybridisation between probe and target) and noise (i.e., Nonspecific hybridisation between probe and target) and average intensity from multiple reads of overall different locations for each nucleic acid attached to the array.

A test sample and a reference sample may be simultaneously assayed on the array. The reference sample may comprise mRNA from multiple sources, such that most, preferably all of the nucleic acids on the array are represented in the test sample, and can be used by the array reader as a non zero standard and for comparison with an average of the read- outs from the test sample. A relative intensity for each gene on the array can be calculated.

The relative abundance of expression of each gene in a sample can also be calculated using controls within the array, such as certain genes expressed in a tissue at a constant level under all conditions.

Alternatively, using the Affymetrix system, an absolute level of expression is calculated based on the difference between the perfect match and mismatch hybridisation for each of the 11 probes for each gene. Using such a process a gene is scored as present or absent and an absolute measure of intensity is given along with a p value.

The interpreted array may highlight only a few genes that are substantially different in expression between a test and reference sample. Alternatively, the overall pattern of expression may provide a “fingerprint” to characterise the way in which the original cells have responded to a particular condition of a performance animal. For example, the gene for superoxide dismutase may be the only gene up-regulated in a particular condition, especially in conditions of inflammation, or a large number of genes may be up- and down- regulated in various conditions. It is this fingerprint, rather than specific knowledge of gene sequence or function that can be used as a marker for various conditions. It would be expected that fingerprints be useful across species barriers to include performance animals such as humans, horse, dog and camel.

The arrangement of nucleic acids on the array may be periodically changed and these arrays are then assigned a particular batch code that corresponds to a specific array comprising a specific nucleic acid arrangement. The ability to change the arrangement of nucleic acids on the array and knowledge of the exact arrangement may prevent other people from generating a database using the arrays described above. Using a batch code also enables tracking of manufacturers of the arrays in regards to the number of arrays produced. The batch code further enables validation of a user of the communication network or “internet” diagnostic method and system. Batch code can also identify a particular type of array used, should more disease-specific arrays be designed and manufactured.

An example of how an array may be prepared and analysed is described in Eisen and Brown (Methods in Enzymology, 1999, 303 179) and in U.S. Pat. No. 6,114,114, herein incorporated by reference. Chapter 22 of Ausubel et al. supra also describes methods and apparatus for use with arrays and is herein incorporated by reference.

Control samples may be respectively labelled in parallel with a test and reference sample. Quantitation controls within a sample may be used to assure that amplification and labelling procedures do not change a true distribution of nucleic acid probes in a sample. For this purpose, a sample may include or be “spiked” with a known amount of a control nucleic acid which specifically hybridises with a control target nucleic acid. After hybridisation and processing, a hybridisation signal obtained should reflect accurately amounts of control nucleic acid added to the sample. For such purposes, a microarray may have internal controls, for example, a nucleic acid encoding a common gene expressed by the performance animal with known expression levels and a nucleic acid encoding a gene from another species that is known not to hybridise to the test or reference sample. To improve sensitivity and specificity of the assay, blocking agents such as Cot DNA from the tested species may also be used.

In an illustrative example of the above methods, the inventors constructed equine cDNA gene libraries from white blood cells (WBC) drawn from five horses, and a 60-day-old foetus. Briefly, about 10,000 bacterial clones containing equine genes from these libraries were picked at random and the cloned genes were analysed by high throughput directional sequencing to obtain ˜600 bp of 3′ sequence for each clone.

These sequences then underwent a series of selection steps for preparation of the inventors' equine-specific array (also referred to herein as the “Genetraks GeneChip®”):

Quality filtering

Internal comparison and comparison to GenBank

Comparison to Genetraks DNA sequence database

Gene selection based on uniqueness and quality

Partitioning of the sequences into separate files for Affymetrix design

Design proposal

Generation of the library file.

Briefly, the quality of each DNA sequence was determined using both automated algorithms such as PHRED, and visual inspection of each DNA chromatogram. High quality sequences with a PHRED score greater than 20 (99.5% chance of each base being called correctly) and length greater than 600 bp were selected. The uniqueness of each gene was determined using the freely available computer program PHRAP and by comparison to GenBank using BLAST (Basic Local Alignment Search Tool). Sequences less than 600 bp and of low quality were discarded. Sequences were binned based on similarity to each other using PHRAP program. One representative sequence was chosen for each bin as “Affy worthy.”

The BLAST algorithm matches a query sequence to detect relationships among sequences that share regions of similarity while giving a statistical score to eliminate the probability for background hits. Annotations for each sequence were derived from using the highest BLAST score values aligned to the query sequence. Additionally, all genes available in the inventors' equine-specific database (also referred to herein as the “Genetraks database”) were compared to themselves using the BLAST algorithm, and any homologous sequences were removed.

In this manner, 3100 unique genes were identified with no similarity to any other gene sequence. Equine genes from GenBank, including repeat elements and intronic sequences, were added to the Genetraks database for sequence comparisons and probe design. Gene sequences were also obtained from GenBank by searching the Expressed Sequence Tag (EST) subset of the public database. Most of the sequences were from equine monocytes-and lymphocyte libraries from Georgia State University (available at www.ncbi.nlm.nih.gov).

As part of the Affymetrix design proposal for a custom GeneChip® expression array, a series of files were generated by Genetraks that were then transferred to Affymetrix for use in the design of the GeneChip®. The sequence file listed all genes in FASTA format. The instruction file correlated all gene annotations with a description identifier in order of priority.

A control sequence file contained DNA sequence that allowed for the design of:

1. probes to bacterial genes (negative and spike-in controls)

2. probes to genes known to be consistently expressed in the tissue of interest (positive and scaling controls)

3. probes to introns of horse genes (to detect contaminating DNA), and

4. probes up to 2,000 bases upstream of the 3′ end of the gene (to measure 5′/3′ ratio or efficiency of reverse transcription).

Pruning files were also generated. As is known in the art, pruning is a sequence comparison method. The standard practice for probe selection is to prune against specific bacterial and species-specific controls, in addition to any custom sequences provided for the design. Pruning increases the quality of the unique probe sets selected for the design and reduces the risk of cross-hybridization with other sequences. There were two types of pruning sequence files created for probe selection—hard pruning and soft pruning:

A hard pruning sequence file contained sequences that were not to be included on the GeneChip®. The hard pruning file contained repetitive elements and ribosomal RNA sequences that are abundantly expressed in equine WBC. Probes that cross-hybridise to hard pruning sequences are not included in a probe set.

A soft pruning sequence file contained sequences to be included on the GeneChip® but acting as controls, so that any primers on the chip would preferably not cross hybridise with these sequences. These sequences included the standard bacterial and species-specific Affymetrix controls (e.g., intronic sequence, ribosomal sequences, housekeeping genes).

Affymetrix then used this information to design six to 11 unique probe pairs per gene.

### Step 4

Hybridising Sample Nucleic Acid Probes with an Array

Nucleic acid probes may be prepared as described above from a biological sample from a performance animal that has been assessed concurrently by physical inspection and/or blood tests or other method. Nucleic acid targets from a statistically relevant number of normal animals previously hybridised to arrays, and a reference range for each of the genes on the array is calculated and used as a normal reference range (for example, a 95% population median). Results from a test sample from a test animal can be compared with the same genes as the normal reference to determine if the test sample falls within the normal reference range. Further, nucleic acid targets may also be prepared from biological samples from apparently normal animals, animals with overt disease, various progressive stages of disease, hitherto undiagnosed or unclassified conditions or stages of such conditions, animals treated with known amounts of drugs (legal or otherwise), animals suspected of being treated with drugs (legal or otherwise), animals under specific exercise regimes for the sake of performance, animals subjected to (intentional or not) various nutritional states and/or environmental conditions. Databases of information from the use of such samples and arrays are created such that test samples can be compared. The database will then contain specific patterns of gene expression for particular conditions.

Prior to hybridisation, a nucleic acid probe may be fragmented. Fragmentation may improve hybridisation by minimising secondary structure and/or cross-hybridisation with another nucleic acid probe in a sample or a nucleic acid comprising non-complementary sequence. Fragmentation can be performed by mechanical or chemical means common in the art.

A labelled nucleic acid target may hybridise with a complementary nucleic acid probe located on an array. Incubation conditions may be adjusted, for example, incubation time, temperature and ionic strength of buffer, so that hybridisation occurs with precise complementary matches (high stringency conditions) or with various degrees of less complementarity (low or medium stringency conditions). High stringency conditions may be used to reduce background or nonspecific binding. Specific hybridisation solutions and hybridisation apparatus are available commercially by, for example, Stratagene, Clontech, Geneworks.

Affymetrix have detailed a standard procedure for the hybridisation of probes with an array (as describe at their website, affymetrix.com, incorporated herein by reference), however, a typical method entails the following:

Adjust probe volume (prepared as above) to a value indicated in the “Probe & TE” column below according to the size of the cover slip to be used and then add the appropriate volume of 20×SSC and 10% SDS.

| Cover Slip | Total Hyb | Probe & TE | | |
|---|---|---|---|---|
| Size (mm) | Volume (μl) | (μl) | 20x SSC (μl) | 10% SDS (μl) |
| 22 × 22 | 15 | 12 | 2.55 | 0.45 |
| 22 × 40 | 25 | 20 | 4.25 | 0.75 |
| 22 × 60 | 35 | 28 | 5.95 | 1.05 |

20×SSC is 3.0 M NaCl, 300 mM NaCitrate (pH 7.0).

Denature the probe by heating it for 2 min at 100° C., and centrifuge at 14,000 RPM for 15-20 min. Place the entire probe volume on the array under the appropriately sized glass cover slip. Hybridize at 65° C. (temperatures may vary when using different hybridisation solutions) for 14 to 18 hours in a custom slide chamber (for example, a Corning CMT hybridisation chamber #2551).

Washing the Array

After hybridisation, the array is washed to remove nonspecific probe and dye hybridisation. Wash solutions generally comprise salt and detergent in water and are commercially available. The wash solutions are applied to the array at a predetermined temperature and can be performed in a commercially available apparatus. Stringency conditions of the wash solution may vary, for example, from low to high stringency as herein described. Washing at higher stringency may reduce background or nonspecific hybridisation. It is understood that standardisation of this step is required to produce maximum signal to noise ratio by varying the concentration of salt used, whether detergent is present (SDS), the temperature of the wash solution and the time spent in the wash solution.

A typical wash protocol consists of removing the slide from a slide chamber, removing the cover slip and placing the slide into 0.1% SSC (recipe provided above) and 0.1% SDS at room temperature for 5 minutes. Transfer the slide to 0.1% SSC for 5 minutes and repeat. Dry the slide using centrifugation or a stream of air. Equipment is available to enable the handling of more than one slide at a time (for example, slide racks).

An illustrative protocol for hybridisation of sample cRNA to probes is provided in the Demonstration Study below.

### Step 5

Reading the Array

After removal of nor-hybridised probe, a scanner or “array reader” is used to determine the levels and patterns of fluorescence from hybridised probes. The scanned images are examined to determine degree of hybridisation and the relative abundance of each nucleic acid on the array. A test sample signal corresponds with relative abundance of an RNA transcript, or gene expression, in a biological sample. Alternatively, an Affymetrix array is read and computer algorithms calculate the difference between hybridisation on perfect match and mismatch probes for each of the 11 probes sets for each gene. It then calculates a presence or absence, an absolute value for each gene and a p value for the absolute call.

Array readers are available commercially from companies such as Axon and Molecular Dynamics and Affymetrix. These machines typically use lasers, and may use lasers at different frequencies to scan the array and to differentiate, for example, between a test sample (labelled with one dye) and the control or reference sample (labelled with a different dye). For example, an array reader may generate spectral lines at 532 nm for excitation of Cy3, and 635 nm for excitation of Cy5.

A relative quantity of RNA may be calculated by the array reader and computer for respective nucleic acids on the array for respective samples based on an amount of dye detected, average of duplicate samples for respective genes and subtraction of background noise using controls. The reader is pre-programmed to perform such calculations (using proprietary software supplied with the array reader, such as MAS 5.0 for the Affymetrix system and Genepix for the Axon Instruments reader) and with information on the location of each nucleic acid on the array such that each nucleic acid is given a readout value. Controls or reference samples providing a readout for particular nucleic acids that falls within standard ranges ensures correct integrity of the array and hybridisation procedures. Programs typically generate digital data and format it for transmission

### Step 6

Querying and Transfer of Digital Data to a Central Database

Generated data is transmitted via a communications network to a remote central database. A user having access to the gene expression data enters information in relation to a test sample into a standard diagnostic form such that it can be digitalised. The information will include clinical appraisal and blood profile results. The format of such information is standard globally such that details on clinical conditions may be based on numerical input and each field of entry can be digitalised. For example, body temperature field could be number 0001, a recorded temperature within normal range would receive the number 0, 0.5° C. above what is considered to be the normal range for that species would receive a number 5, 1° C. above normal range would receive 10. Some examples of conditions that may be scored or rated in such a fashion are provided below.

a) Body temperature.

b) Integument: eyes, sores, abscesses, wounds, insects/parasites, allergy, infection.

c) Cardio/Respiratory: eyes, nasal discharge, rales, viral/bacterial infection, allergy, chronic obstructive pulmonary disease, cough/wheeze, crepitous sounds in the thorax, epistaxis, auscultation sounds, heart sounds, capillary refills mucous membrane colour.

d) Gastrointestinal: diarrhea, colic/stasis, parasites, appetite level, drenching time and dose.

e) Reproductive: stage of pregnancy, abortion, inflammation, discharges.

f) Musculoskeletal: lameness, laminitis, bone or shin soreness, muscle soreness or tying up, tendon or ligament affected, level of pain, X-ray data, scintigraphy data, CAT scan data, bursitis, bruising, cramping or “tying up”.

g) Blood test results: biochemistry, immunology, serology (viral, bacteriological, hormone levels), cell counts, cell morphology, pathologist interpretation.

h) Other diagnostic test results: X-ray, biopsy, histopathology, CAT scan, MRI, bacteriology, virology.

i) Other data: Season (date), location, male or female, vaccination history, body score (fitness and fat), fitness level.

Alternatively, the entire system could be based on the aforementioned SNOMED system with appropriate modifications to encompass descriptions of exercise physiology and the normal animal. Alternatively, the entire system could rely on text or categorical data that can be appraised and scored by software such as Omniviz. Whatever system is used, if would be appreciated that the aim is to adequately, systematically and in a standard manner describe the current condition of the animal to the best of currently available technologies and could include results from machinery such as X-ray, ultrasound, scintigraphy and blood analysis.

The user also ensures that array results (that may for example, be automatically collected from a reader), array specifications, data mining specifications, level of interpretation required and the clinical information are entered and correspond to the same animal and the same sample. The form is transmitted electronically to a central database and recognised as an individual accession or request by the database. The central database recognises the user (using for example, digital certificates), the user recognises the central database, the array batch code and gene array order are verified, and the user is allowed access (which may be automatic) and automatic processing of the request is performed if security and billing information are adequate. The processing involves specific mining of central data and specific user requested information is retrieved and resent automatically.

The above steps may be automated so that a user need not be present to perform the tasks. In an automated specific example, gene expression data from an array reader may be transmitted via a communications network directly to a server which is connected to a central database. Additional information could be input by the user at a processor which is also linked to the array reader.

Automated Data Mining Using Sent Data (Heuristic Methods)

A central database interprets the array specifications (for example, nucleic acid order on a microarray), decodes the information transmitted, determines nucleic acid expression level in a biological sample and compares the expression level and patterns of expression with known standards or reference range. Various levels of database interpretation may be applied to the data transmitted, depending on the user requirements. Clusters of genes may be up-regulated or down-regulated in certain conditions and the database makes automated correlations to specific conditions by accessing various levels of database information.

Mining software such as Metamine (Silicon Genetics), ArraySCOUT (Lion Bioscience) can be used in this instance, and more advanced data mining technologies could be used to identify patterns and nearest neighbour information in data (such as products from AnVil Informatics Inc and OmniViz Inc). Further, software capable of taking rule-based instructions (such as that described by Pacific Knowledge Systems Sydney Australia in their “ripple down” technology) and having the ability to self learn (heuristics and neural network systems) such as that described in Khan et al. Nature Medicine 7 (6) 673, incorporated herein by reference, could be used at this stage to limit the level of human interaction in determining a diagnosis. In this latter example, an artificial neural network is used, and samples are divided into training and validation sets to create trained calibrated models. The calibrated models are then used to rank genes in diagnostic importance.

Levels of database may include:

Unique gene sequences (for example, 3′ and 5′ EST sequence of genes)

Gene identity, homologous genes, tissue expression, keywords, function, cellular role, gene clusters, biochemical pathway, PubMed references

Primer sequences used to generate amplification products (for example, two primer sequences used to uniquely amplify the gene for gamma interferon in a particular species)

Microarray construction and format (for example, coded, information on array manufacture batch and identification of genes and position on the array)

Blood profile and clinical data associated with particular conditions (for example, standard clinical information and IDEXX-machine generated blood profile data)

Array data for normal and apparently normal status (for example, 95% median range for normal animals)

Array data for inducible disease and disease models

Array data for various overt diseases (for example, joint inflammation)

Array data for stages of various overt diseases (for example, pre-clinical, clinical and recovery stages)

Array data for the influence of various classes of drugs, legal or otherwise, of known administration and dose, or unknown administration or dose (for example, various steroids)

Array data for the response to known and various levels of drugs used as a therapy (for example, various anti inflammatory medication at specific doses for a specific condition)

Array data for the response to exercise and various training regimes

Array data for the response to nutrition and various feeding regimes

Array data for the response to the environment so as to possibly determine influence of during various seasons, or allergens or feed types.

Each successive level relies on at least one previous level of database to allow for interpretation. The database may be built over time and more intensive searching of the database may incur a greater cost. As the database grows, changes may be made to the above methodology to increase the sensitivity of the detection of variation in expression of condition-specific genes—this could include the use of condition-specific arrays or condition-specific primers. Condition-specific arrays can be manufactured by a company such as Affymetrix (under instructions) that would allow for increased sensitivity and specificity, much reduced size of arrays, decreased cost of production, and the ability to process multiple samples at once. The process of building the database is iterative, such that specific genes are correlated to specific conditions, and the detection of variations in these genes becomes more sensitive and specific through the use of various modifying processes through the procedure (for example, the use of gene-specific primers for the amplification and labelling of cDNA from RNA, and the selection of limited numbers of genes on a disease- or condition-specific array, detection of splice variants and single nucleotide polymorphisms).

### Step 7

Standardised Electronic Reporting

The database reports back electronically to a remote user, either automatically or with a level of human intervention. The electronic report may be converted to a printed document. The report provides details of an animal's condition that is determined by correlation of gene expression data with information stored in a remote database, and optionally expert analysis.

Information sent might include:

Individual genes up-regulated or down-regulated (for example, with laminitis or joint capsule inflammation or bursitis, a report on the up-regulation of genes such as interleukin-3, manganese superoxide dismutase, Groα, metalloproteinase matix-metalloelastase, ferritin light chain may have some correlation to tissue inflammation, and down-regulation of genes such as insulin-like growth factor and its receptor may be correlated to recovery from such a condition). The identity of these genes cannot be predicted to be associated to any condition unless the above described methodology is used and databases on relative expression of genes for particular conditions have been compiled. Therefore a screening test covering all genes may need to be performed first and a second, more specific test then applied.

The overall pattern of gene expression and any correlation to particular conditions. For example, animals in heavy training may have a gene “fingerprint” that is different to animals being spelled from training.

Individual pattern of gene expression (i.e., the shape of the gene expression pattern over a time course or multiple samples taken over a period may change as an animal recovers from a condition)

Changes to a pattern of gene expression, gene expression profile or level for a single animal over a time period or for successive tests.

Clusters of genes up-regulated or down-regulated in a particular condition

Pathways of genes up-regulated or down-regulated in a particular condition

Correlations between genes up-regulated or down-regulated and known conditions, or stage of condition, or influence

Known therapies to ameliorate the condition or enhance desired effects

Specialist pathologist written interpretation

Relevant information of use to veterinarians, medical practitioners, owners, trainers and athletes

Collections of data on groups of animals under specific management regimes

### DEMONSTRATION STUDY

Objective

The demonstration study involved 108 blood samples. Twenty were from horses with induced osteoarthritis, 11 from horses with Equine Herpes Virus (EHV), 14 from horses with gastric ulcer syndrome and 63 from normal healthy horses.

Blood samples were collected in Paxgene tubes and mRNA extracted from each sample, using methods described above.

Quality Control

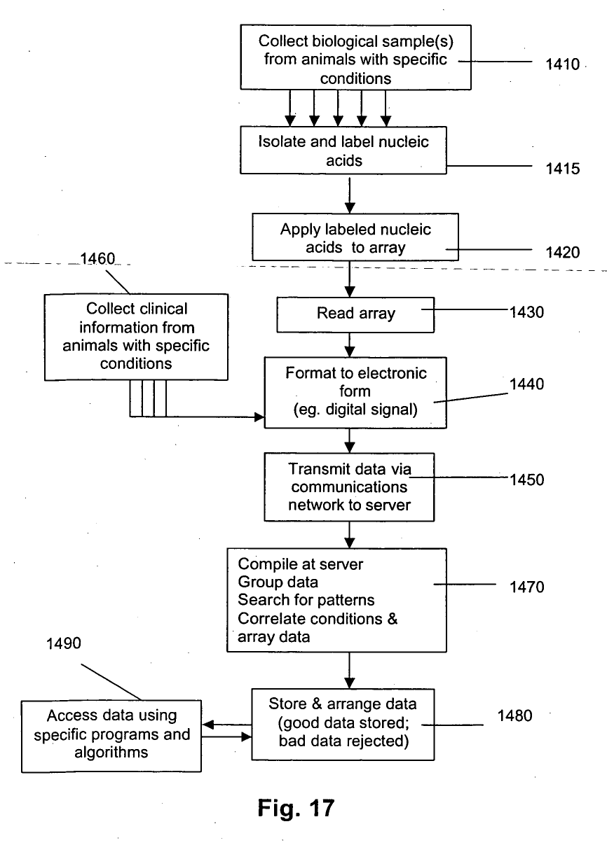

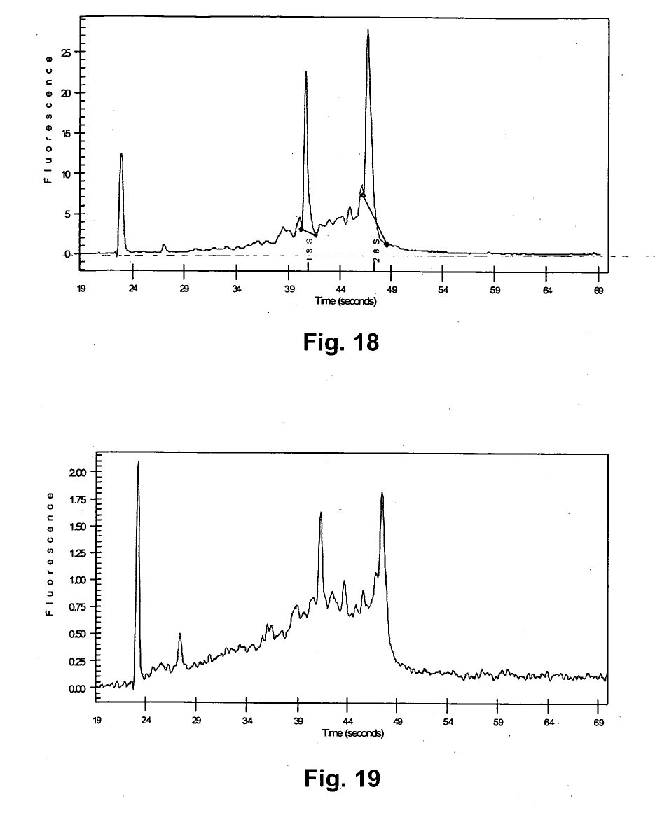

Total RNA extracted from each sample was checked for quality and quantity prior to running on a GeneChip® using an Agilent “Lab-on-a-Chip” system. Examples of the results from such a chip confirming the quality of sample RNA are shown in FIG. 18, including a description of the metrics used to determine the quality and quantity of total RNA. By contrast, the trace shown in FIG. 19 represents poor quality RNA that was failed by quality control.

cDNA and cRNA generation

The method used for cDNA and cRNA generation was adapted from the protocol provided and recommended by Affymetrix (www.affymetrix.com).

In brief, the steps were:

1. 3 μg of total RNA was used as a template to generate double stranded cDNA.

2. cRNA was generated and labeled using biotinylated Uracil (dUTP).

3. biotin-labeled cRNA was cleaned and the quantity determined using a spectrophotometer and MOPS gel analysis.

4. labelled cRNA was fragmented to −300 bp in size.

5. quantity determined on an Agilent “Lab-on-a-Chip”.

Hybridization, Washing & Staining

The steps were:

1. A hybridisation cocktail is prepared containing 0.05 μg/μl of labelled and fragmented cRNA, spike-in positive hybridisation controls, and the Affymetrix oligonucleotides B2, bioB, bioC, bioD and cre.

2. The final volume (80 μl) of the hybridisation cocktail is added to a GeneChip® cartridge.

3. The cartridge is placed in a hybridisation oven at constant rotation for 16 hours.

4. The fluid is removed from the GeneChip® and stored.

5. The GeneChip® is placed in an Affymetrix fluidics station.

6. The experimental conditions for each GeneChip® are recorded as an .EXP file

7. All washing and staining procedures are carried out by the Affymetrix fluidics station with an attendant providing the appropriate solutions.

8. The GeneChip® is washed, stained with steptavidin-phycoerythin dye and then washed again using low salt solutions.

9. After the wash protocols are completed, the dye on the probe array is ‘excited’ by laser and the image captured by a CCD camera using an Affymetrix Scanner (manufactured by Agilent), as explained in more detail in Step 5 above.

Scanning & Data File Generation

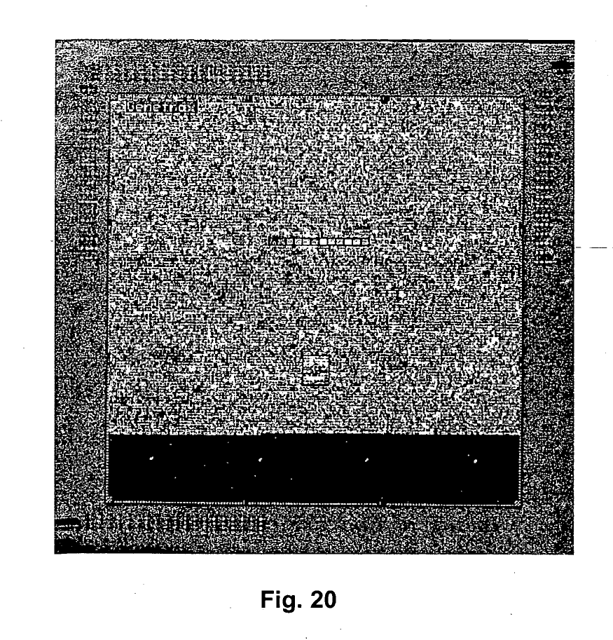

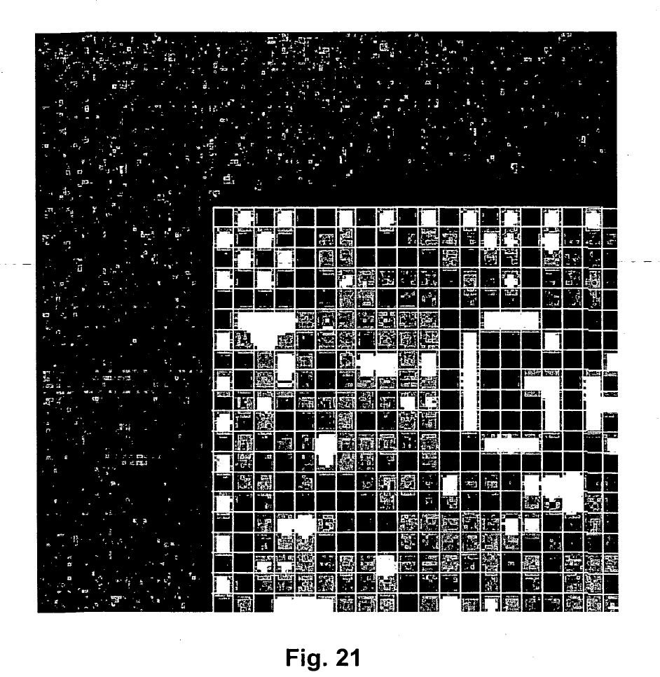

The scanner and MAS 5 software generated an image file from a single GeneChip® called a .DAT file (see FIGS. 20 and 21). The .DAT file was then pre-processed prior to any statistical analysis.

Data Pre-Processing

Data pre-processing steps (prior to any statistical analysis) included:

.DAT File Quality Control (QC).

.CEL File Generation.

Scaling and Normalisation.

DAT File QC

The .DAT file is an image (see FIGS. 20 and 21). The image was inspected manually for artefacts (e.g. high/low intensity spots, scratches, high regional or overall background). (The B2 oligonucleotide hybridisation performance is easily identified by an alternating pattern of intensities creating a border and array name. The MAS 5 software used the B2 oligonucleotide border to align a grid over the image so that each square of oligonucleotide was centred and identified.

The other spiked hybridisation controls (bioB, bioC, bioD and cre) were used to evaluate sample hybridisation efficiency by reading “present” gene detection calls with increasing signal values, reflecting their relative concentrations. (If the .DAT file is of suitable quality it is converted to an intensity data file (.CEL file) by Affymetrix MAS 5 software.)

CEL File Generation

The CEL files generated by the MAS 5 software from .DAT files contain calculated raw intensities for the probe sets. Gene expression data was obtained by subtracting a calculated background from each cell value. To eliminate negative intensity values, a noise correction fraction based from a local noise value from the standard deviation of the lowest 2% of the background was applied.

All .CEL files generated from the GeneChips® were subjected to specific quality metrics developed by Gene Logic. GeneChips® that failed these metrics were not included in the study.

Some metrics are routinely recommended by Affymetrix and can be determined from Affymetrix internal controls provided as part of the GeneChip®. These quality metrics are used to ensure that data are not unduly influenced by failures in hybridisation, inadequate plate washing or contamination or flaws in the Affymetrix chips.

Data Generation

Scaling & Normalisation

Data were normalised using the Robust Multi-chip Analysis (RMA) algorithm of Irizarry et al., (2002 Exploration, normalisation and summaries of high density oligonucleotide array probe level data. Biostatistics in print). The RMA algorithm uses a mixture model to implicitly subtract the background values, and then combines probes using a robust averaging procedure, to generate values for each gene.

Since background correction is achieved implicitly, rather than by subtracting a “mis-match” probe result, the RMA algorithm does not use mis-match probes. In the RMA algorithm, normalisation occurs at the level of the probe pair. It is based on quantile-quantile normalisation, in which all chips are constrained to have the same quantiles of probe intensity.

After generation of the RMA gene expression indices, kernel density plots were used to display the distribution of gene expression values for each chip. These kernel density estimates were plotted on the same axes—to identify any chips or genes with atypical responses.

Data Analysis

The objective of this analysis was to develop classifiers which will allow the prediction of disease status for an animal with unknown disease severity.

The biggest issue in mining for diagnostic signatures is the curse of “dimensionality”. Given the large number of genes measured, it is possible to find signatures that perfectly correlate with any clinical condition. Such apparently perfect correlates, however, have low generalisability—although they fit the training data perfectly, they break down with new samples and cannot be used as operational diagnostics.

The problems posed for diagnostic signature evaluation are therefore:

1. Derivation of robust and generalisable signatures which will not break down when applied to new data; and

2. Honest unbiased estimation of the performance of a diagnostic signature.

Many different approaches have been proposed for identifying diagnostic signatures. These include (but are not limited to):

Support Vector Machines

Shrinkage Discriminant Analysis, and

Stochastic variable elimination.

All of these methods have their strengths and weaknesses. None is universally better than any other. Most of these methods will succeed in identifying strong diagnostic signatures, but they will differ in the selectivity and sensitivity that they permit. For the purposes of this illustration, signatures were derived using a form of regularised linear discriminant analysis. The stages in the analysis were:

1. Generation of a training data matrix of k samples by p genes. The element in row i column j of the matrix represents the RMA expression value for the jth gene in the ith sample.

2. Each observation of the training data set is dropped in turn—giving a test observation.

3. For a given test observation, the mean expression over all remaining samples is generated for each gene. This mean is then subtracted from each sample's value for the gene. That is, the centred gene expression values are defined as: Yᵢⱼ-Xᵢⱼ-\overline{x}ᵢ where Yᵢⱼ is the centred jth gene expression value of the ith sample, and Xᵢⱼ is the uncentred gene expression value for the jth gene in the ith sample, and \overline{x}ⱼ is the mean expression for the jth gene over all samples.

4. The mean of each gene is subtracted from the respective gene value of the test sample.

5. Multivariate summaries of gene expression are generated using principal components analysis. The components are calculated using the left singular vectors from a singular value decomposition of the centred data matrix Y.

6. Linear combinations of the summary principal components are generated to maximise between group separation, using Fisher's linear discriminant analysis. This is achieved by solution of the following generalised eigenvalue problem: W⁻¹Bx-λx where x is an eigenvector defining the coefficients of the linear combination of the principal components which maximise the quadratic form.

$$\begin{matrix}{x}^{′} Bx \\ {x}^{′} Wx\end{matrix}$$

Here B is the between groups covariance matrix of the principal component scores, and W is the within groups covariance matrix of the principal component scores.

7. The eigenvectors x are then used as the coefficients of linear functions of the principal component scores, to define new linear combinations—the discriminant functions.

8. Mean values of the discriminant function scores are calculated for each disease group.

9. The Euclidean Distances are calculated between the test observation and each disease mean, in the space of the linear discriminant functions. The test observation is then allocated to the disease group for which it has the smallest distance. This gives a predicted value for the test observation.

10. Steps from 4 to 7 are repeated with a varying number of principal components.

11. The test observation is re-instated, and the next observation dropped and regarded as a test observation. Steps 2 to 10 are repeated until each observation has been used as a test observation.

12. The predicted disease groups for each observation are tabulated against the true disease groups. The number of principal components is chosen to maximise the accumulated prediction success.

This process of dropping each observation in turn and predicting from the data is known as leave one out cross validation (Stone, 1974 Journal Royal Statistical Society 36:111-147).

This procedure could be regarded as an approximation to the technique of Kiiveri (1992 Technometrics 34:321-331) or MacCarthy et al., (1995 Applied Statistics 44:101-115) which both use a low dimensional representation of the within groups covariance matrix, but allow between-group differences to lie in the full space of the between-groups matrix. This distinction is important, because it is possible that discriminatory information will lie in the space of the smaller principal components, and be discarded. It should also be noted that the principal components were selected in order of their eigenvalue, rather than in order of their contribution to the between groups separation. Better classifications may sometimes be obtained when the components are selected on their contribution to classification—but experience suggests that the results are less stable with such a selection. Kiiveri's or McCarthy et al's techniques would be preferable, and are likely to result in marginally improved selectivity and sensitivity, but the algorithms required to render them computationally feasible are proprietary. From that perspective, the results presented in this document should be considered conservative.

Results

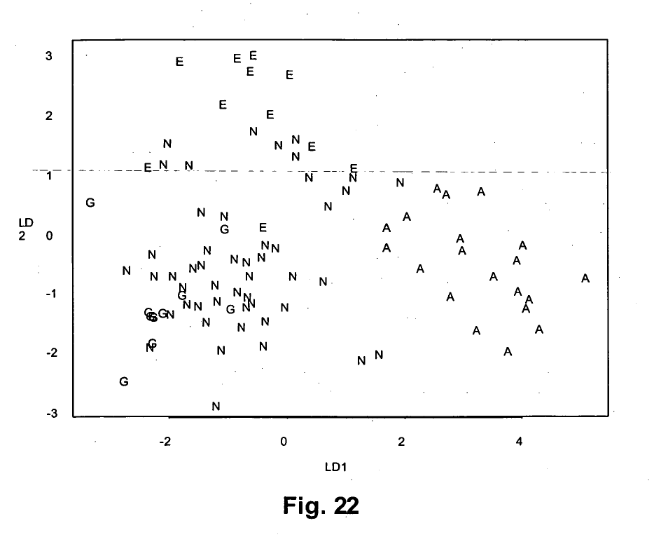

FIG. 22 shows a scatter plot of the four conditions (osteoarthritis, EHV, gastric ulcer syndrome and normal) with respect to the first two linear discriminant functions in the demonstration study. There are clear separations between each of the groups—masked to some extent by the restrictions of plotting in two dimensions.

Accordingly, this study has demonstrated the feasibility of diagnosis of different diseases based on gene expression measurements of equine blood samples.

Persons skilled in the art will appreciate that numerous variations and modifications will become apparent. All such variations and modifications which become apparent to persons skilled in the art, should be considered to fall within the spirit and scope that the invention broadly appearing before described.

Thus, for example, the above description has focussed on the testing of a general subject. It will be appreciated that this is most advantageously used for performance animals to identify conditions that may lead to a decrease in performance. This allows trainers to identify problems with horses or other animals before they would be noticeable using existing techniques. This is of particular benefit in the horse racing industry as it allows problems to be identified in advance, which can in turn allow the conditions to be corrected before they effect the horses performance, which in turn can result in a vast loss of earnings for the trainers and owners of the horse. However, the technique may also be applied to any subjects, including humans.

It will be appreciated that different predetermined data will be required for each type of subject being assessed.

Throughout the specification the aim has been to describe the preferred embodiments of the invention without limiting the invention to any one embodiment or specific collection of features. It would therefore be appreciated by those of skill in the art that, in light of the instant disclosure, various modifications and changes can be made in the particular embodiments exemplified without departing from the scope of the present invention. For example, the examples described herein may be used with performance animals other than horse, for example, human, dog and camel.

All references, inclusive of patents, patent applications, scientific documents and computer programs, referred to in this specification are herein incorporated by reference in its entirety.

The contents of U.S. Provisional Application No. 60/485,448, filed Jul. 9, 2003, and Australian Provisional Patent Application No. 2002952696, filed Nov. 14, 2002., including the entire specification, claims, and drawings, are hereby incorporated by reference in their entirety.

We claim:

1) A method comprising:
for each of a plurality of animals having a known status, measuring a number of biological factors potentially indicative of said status;
analysing said biological factors to obtain at least one model providing a statistical correlation between said biological factors and said status;
storing at least one said model; and
responsive to a request for status determination of a particular animal, the request including, for the particular animal, measures of at least some of the number of biological factors potentially indicative of said status, applying at least one stored model to the information in the request in order to attempt to determine the status of the particular animal.

2) A method comprising:
for each of a plurality of animals having a known condition, measuring a number of biological factors potentially indicative of said condition;
determining at least one model that provides a statistical correlation between said biological factors and said condition;
storing said at least one model; and
responsive to a request for status determination of a particular animal, the request including, for the particular animal, measures of at least some of the number of biological factors potentially indicative of said status, applying at least one stored model to the information in the request in order to attempt to determine the status of the particular animal.

3) A method comprising:
providing a system including a database of (a) statistical models that correlate biological factors to known conditions, and (b) statistical models that correlate known conditions or biological factors to known statuses;
responsive to a user request for a status determination for a particular animal, said request including measures of at least some biological factors, applying at least one statistical model from the database to at least some of the biological factors in the request in order to determine whether the animal has a known condition or a known status; and
providing the user with the status determination.

4) A method as in claim 3 wherein the user is at a remote location from the database and is only provided with the status determination if the user is authorised to access the system.

5) A method as in claim 3 wherein the request includes a unique identity for the animal and wherein the system stores information relating to the animal based on its identity.

6) A method as in claim 3 further comprising determining the status of the animal based at least in part on previously stored information about the animal.

7) A method as in claim 3 further comprising providing the user with a list of additional information that might be useful in making a status determination.

8) A method comprising:
providing a system including a database of (a) statistical models that correlate biological factors of horses to known conditions in horses, and (b) statistical models that correlate known conditions in horses or biological factors of horses to known statuses of horses;
responsive to a user request for a status determination for a particular horse, said request including measures of at least some biological factors of the particular horse, applying at least one statistical model from the database to at least some of the biological factors in the request in order to determine whether the horse has a known condition or a known status; and
providing the user with the status determination of the horse.

9) A method as in claim 8 wherein the user is at a remote location from the database and is only provided with the status determination if the user is authorised to access the system.

10) A method as in claim 8 wherein a request includes a unique identity for the horse and wherein the system stores information relating to the horse based on its identity.

11) A method as in claim 8 further comprising determining the status of the horse based at least in part on previously stored information about the horse.

12) A method as in claim 8 further comprising providing the user with a list of additional information about the horse that was not provided with the request and that might be useful in making a status determination about the horse.

13) A method of determining the status of a subject, the method including:
Obtaining subject data, the subject data including respective values for each of a number of parameters, the parameter values being indicative of the current biological status of the subject;
Comparing the subject data to predetermined data, the predetermined data including for each of a number of conditions:
Values for at least some of the parameters; and,
An indication of the condition; and,
Determining the status of the subject in accordance with the results of the comparison, the status indicating at least one of the presence, the absence and the degree of at least one of the conditions.

14) A method according to claim 13, the indication of the condition including at least one of:
An indication of the stage of a condition;
An indication of the degree of a condition; and
An indication of the degree of health of a subject.

15) A method according to claim 13, the number of parameters being sufficiently statistically significant to allow a number of conditions to be distinguished.

16) A method according to claim 13, the number of parameters being greater than 100.

17) A method according to claim 13, the number of parameters being greater than 100.

18) A method according to claim 13, the number of parameters being less than 6000.

19) A method according to claim 13, the method including generating a report representing the status of the subject.

20) A method according to claim 13, the method including determining the ability of the subject to perform in a sporting and/or racing event in accordance with at least one of the presence, absence and degree of any conditions.

21) A method according to claim 13, the parameters being representative of the level or abundance of a molecule selected from one or more of:
A nucleic acid molecule;
A proteinaceous molecule;
A carbohydrate;
A lipid;
A drug;
A chemical;
A gas;
A cell;
A pathogenic organism; and,
A non pathogenic organism.

22) A method according to claim 13, the parameters being determined from:
Blood samples;
Samples containing cells of the immune system.

23) A method according to claim 13, the predetermined data including phenotypic information of the individuals, and the subject data including phenotypic information regarding the subject, the phenotypic information including details of one or more phenotypic traits.

24) A method according to claim 23, the method including comparing the subject data to predetermined data for individuals having one or more phenotypic traits in common with the subject.

25) A method according to claim 13, the predetermined data being diagnostic signatures, the method including determining a diagnostic signature for a respective condition by data mining subject data relating to a number of individuals having known conditions, or degrees of conditions, each diagnostic signature including a range of values for at least some of the parameters.

26) A method according to claim 25, the subject data being determined by at east one of:
Clinical trials; and,
Diagnosis of conditions within subjects.

27) A method according to claim 26, the diagnosis confirmed by a medical practitioner or veterinarian.

28) A method according to claim 13, the predetermined data being diagnostic signatures, the method including determining a diagnostic signature for a respective condition by:
Obtaining data relating to a number of individuals, the data including:
An indication of the status of the individual;
Respective values for each of the number of parameters;
Selecting one or more groups of individuals in accordance with the status of the individuals and the condition; and,
Determining a range of parameter values for each group in accordance with the parameter values of the individuals, the range of parameter values representing a diagnostic signature for a respective group.

29) A method according to claim 28, the method including:
Comparing the data for each of the individuals to predetermined criteria; and,
Selectively excluding one or more individuals from a respective group in accordance with the results of the comparison.

30) A method according to claim 29, the method including:
Receiving confirmation of the determined status;
Comparing the data for each of the individuals to predetermined criteria; and,
Updating the predetermined data in accordance with the confirmed status and the subject data in response to a successful comparison.

31) A method according to claim 29, the predetermined criteria representing quality control criteria.

32) A method according to claim 28, the method including:
Comparing the data for each of the individuals to each other; and,
Selectively excluding one or more individuals from a respective group in accordance with the results of the comparison.

33) A method according to claim 28, the method including, for each selected group:
Determining parameters that allow the group to be distinguished from each other group; and,
Determining a range of parameter values for the selected parameters in accordance with the parameter values of the individuals in the respective group.

34) A method according to claim 28, the method including for each condition:
Determining parameters that allow the degree of the condition to be determined; and,
Determining a range of parameter values for the selected parameters taking account of the relationship between these parameter values and the degree of the condition.

35) A method according to claim 28, the method including for each diagnostic signatures:
Obtaining data for an individual having the respective condition;
Comparing the parameter values for the individual to the respective diagnostic signature; and,
Revising the diagnostic signature in accordance with an unsuccessful comparison.

36) A method according to claim 13, the method being performed using a system including at least one end station coupled to a base station via a communications network, the method including causing the base station to:
Receive the subject data from the end station via the communications network;
Determine the status of the subject;
Transfer an indication of the subject status to the end station via the communications network.

37) A method according to claim 13, the subjects and individuals being at least one of:
Horses;
Camels;
Greyhounds;
Human Athletes; and,
Other Performance animals.

38) Apparatus for determining the status of a subject, the apparatus including a processing system adapted to:
Obtain subject data, the subject data including respective values for each of a number of parameters, the parameter values being indicative of the current biological status of the subject;
Compare the subject data to predetermined data, the predetermined data including for each of a number of conditions:
A range of values for at least some of the parameters; and,
An indication of the condition; and,
Determining the status of the subject in accordance with the results of the comparison, the status indicating at least one of the presence, absence and degree of one or more of the conditions.

39) Apparatus according to claim 38, the apparatus being adapted to perform the method of claim 13.

40) A method of determining diagnostic signatures for use in the status determination of a subject, the method including:
Obtaining data relating to a number of individuals, the data including:
An indication of the status of the individual, including an indication of at least one definitively diagnosed condition;
Respective values for each of the number of parameters;
Selecting one or more groups of individuals in accordance with the status of the individuals and the condition; and,
Determining a range of parameter values for each group in accordance with the parameter values of the individuals, the range of parameter values representing a diagnostic signature for a respective group.

41) A method according to claim 40, the method including, for each selected group:
Determining parameters that allow the group to be distinguished from each other group; and,
Determining a range of parameter values for the selected parameters in accordance with the parameter values of the individuals in the respective group.

42) A method according to claim 40, the method including for each diagnostic signatures:
Obtaining data for an individual having the respective condition;
Comparing the parameter values for the individual to the respective diagnostic signature; and,
Revising the diagnostic signature in accordance with an unsuccessful comparison.

43) A method according to claim 42, the data for each of the individuals being determined by at least one of:
Clinical trials; and,
Diagnosis of conditions within subjects.

44) A method according to claim 40, the method including:
Receiving confirmation of the determined status;
Comparing the data for each of the individuals to predetermined criteria; and,
Updating the predetermined data in accordance with the confirmed status and the subject data in response to a successful comparison.

45) A method according to claim 40, the method including:
Comparing the data for each of the individuals to predetermined criteria; and,
Selectively excluding one or more individuals from a respective group in accordance with the results of the comparison.

46) A method according to claim 45, the predetermined criteria representing quality control criteria.

47) A method according to claim 40, the method including:
Comparing the data for each of the individuals to each other; and,
Selectively excluding one or more individuals from a respective group in accordance with the results of the comparison.

48) A method according to claim 40, the conditions including at least one of:
A disease; and,
An assessment that the individual is healthy.

49) A method of allowing a user to determine the status of a subject using a base station, the method including causing the base station to:
Receive subject data from the user via a communications network, the subject data including respective values for each of a number of parameters, the parameter values being indicative of the current biological status of the subject;
Compare the subject data to predetermined data, the predetermined data including for each of a number of conditions:
Values for at least some of the parameters; and,
An indication of the condition; and,
Determine the status of the subject in accordance with the results of the comparison, the status indicating the presence and/or absence of the one or more conditions; and,
Transfer an indication of the status of the subject to the user via the communications network.

50) A method according to claim 49, the method including:
Having the user determine the subject data using a remote end station; and,
Transferring the subject data from the end station to the base station via the communications network.

51) A method according to claim 49, the base station including first and second processing systems, the method including:
Transferring the subject data to the first processing system;
Transferring the subject data to the second processing system upon request of the second processing system; and,
Causing the second processing system to perform the comparison.

52) A method according to claim 51, the method including:
Transferring the results of the comparison to the first processing system; and,
Causing the first processing system to determine the status of the subject.

53) A method according to claim 51, the method including at least one of:
Transferring the subject data between the communications network and the first processing system through a first firewall; and,
Transferring the subject data between the first and the second processing systems through a second firewall.

54) A method according to claim 51, the second processing system being coupled to a database adapted to store the predetermined data, the method including:
Querying the database to obtain at least selected predetermined data from the database; and,
Compare the selected predetermined data to the subject data.

55) A method according to claim 51, the second processing system being coupled to a subject database, the method including storing the subject data in the subject database.

56) A method according to claim 49, the method including having the user determine the subject data using a secure array of elements capable of determining the quantity of a biological molecule, the secure array having a number of features each located at respective position on the array, and a respective code, the method including causing the base station to:
Determine the code from the subject data;
Determine a layout indicating the position of each feature on the array;
Determining the parameter values in accordance with the determined layout, and the subject data.

57) A method according to claim 49, the method including having the user determine the subject data using a secure array of elements capable of determining the quantity of a biological molecule, the secure array having a number of features each tagged with an identifier determining the type of biological molecule to which they bind; and a respective code, the method including causing the base station to:
Determine the code from the subject data;
Determine a layout indicating the position of each feature on the array;
Determining the parameter values in accordance with the determined layout, and the subject data.

58) A method according to claim 49, the method including causing the base station to:
Determine payment information, the payment information representing the provision of payment by the user; and,
Perform the comparison in response to the determination of the payment information.

59) A base station for determining the status of a subject, the base station including:
A store method for storing predetermined data, the predetermined data including for each of a number of conditions:
Values for at least some of the parameters; and,
An indication of the condition; and,
A processing system, the processing system being adapted to:
Receive subject data from the user via a communications network, the the subject data including respective values for each of a number of parameters, the parameter values being indicative of the current biological status of the subject;
Compare the subject data to the predetermined data;
Determine the status of the subject in accordance with the results of the comparison; and,
Output an indication of the status of the subject to the user via the communications network.

60) A base station according to claim 59, the processing system being adapted to receive subject data from a remote end station adapted to determine the subject data.

61) A base station according to claim 59, the processing system including:
A first processing system adapted to:
Receive the subject data; and
Determine the status of the subject in accordance with the results of the comparison; and,
A second processing system adapted to:
Receive the subject data from the processing system; and,
Perform the comparison; and,
Transfer the results to the first processing system.

62) A base station according to claim 59, the base station including:
A first firewall for coupling the first processing system to the communications network; and,
A second firewall for coupling the first and the second processing systems.

63) A base station according to claim 59, the processing system being coupled a subject database, the processing system adapted to store the subject data in the subject database.

64) A base station according to claim 59, the method of performing the comparison including causing the second processing system to:
Obtain the predetermined data in the form of a set of signatures; and,
Use the signatures to classify the subject data into a respective one of the groups.

65) A base station according to claim 59, the subject data being determined using a secure array, the secure array having a number of features each located at respective position on the array, and a respective code, the processing system being adapted to:
Determine the code from the subject data;
Determine a layout indicating the position of each feature on the array;
Determining the parameter values in accordance with the determined layout, and the subject data.

66) An end station adapted to determine the status of a subject, the end station including a processor adapted to:
Determine subject data from the user, the subject data including the subject data including respective values for each of a number of parameters, the parameter values being indicative of the current biological status of the subject;
Transfer the subject data to a base station via a communications network, the base station being adapted to:
Compare the subject data to predetermined data for one or more individuals, the predetermined data including:
(1) One or more parameter values for the respective individual; and,
(2) An indication of the status of each individual; and,
Determine the status of the subject in accordance with the results of the comparison; and,
Receive an indication of the status of the subject via the communications network.

67) A method of providing secure arrays for use, each array including a number of predetermined features, the method including:
Determining a number of respective feature layouts, each layout representing the positioning of each feature on a respective array;
Determining a number of codes, each code corresponding to a respective layout;
Generating a number of arrays, each array being generated in accordance with a respective layout, and including the corresponding code thereon, the code being used in processing used the array.

68) A method according to claim 67, the method being performed to provide the arrays on behalf of an entity, the method including providing an indication of the layouts and corresponding codes to the entity, to thereby allow the entity to process the arrays.

69) A method according to claim 67, the method of determining the layouts including:
Determining a preferred layout; and,
Moving the position of one or more of the features from the position in the preferred layout to alternative position.

70) A method according to claim 67, the method including:
Determining the type of each feature; and,
Exchanging the position of one or more features having different feature types.
